(19) United States
(12) Patent Application Publication
(10) Pub. No.: US 2023/0255206 A1
(43) Pub. Date: Aug. 17, 2023

(54) HERBICIDAL COMPOSITION AND METHOD FOR CONTROLLING WEEDS

(71) Applicant: SUMITOMO CHEMICAL COMPANY, LIMITED, Chuo-ku (JP)

(72) Inventors: Yoshinobu JIN, Kasai-shi (JP); Yoshinao SADA, Kasai-shi (JP)

(73) Assignee: SUMITOMO CHEMICAL COMPANY, LIMITED, Chuo-ku (JP)

(21) Appl. No.: 18/005,494

(22) PCT Filed: Apr. 28, 2021
(86) PCT No.: PCT/JP2021/016909

§ 371 Date: Jan. 13, 2023

(30) Foreign Application Priority Data
Jul. 31, 2020 (JP) 2020-129991

(51) Int. Cl. A01N 43/80; A01N 43/54; A01N 43/40; A01N 33/04; A01P 13/00

(52) U.S. Cl. CPC A01N 43/80; A01N 43/54; A01N 43/40; A01N 33/04; A01P 13/00

(57) ABSTRACT

Provided herein is a herbicidal composition which exerts excellent control effect on weeds, and a method for controlling weeds.

A herbicidal composition comprising epyrifenacil and one or more compounds selected from the following compound group Y:

Compound group Y: group consisting of 4-amino-3-chloro-5-fluoro-6-(7-fluoro-1H-indol-6-yl)pyridine-2-carboxylic acid cyanomethyl ester, phenylisoxazoline compound represented by the following formula (1):

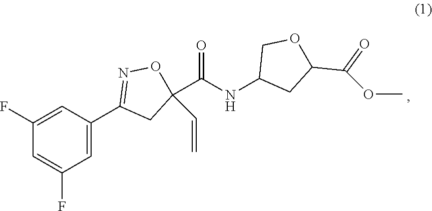 [SMILES: C=CC1(C(=O)NC2COC(C(=O)OC)C2)CC(c2cc(F)cc(F)c2)=NO1]

(1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester, rimisoxafen and 2,4-D DMAPA salt.

### TECHNICAL FIELD

The present invention relates to a herbicidal composition and a method for controlling weeds.

### BACKGROUND ART

Herbicides have hitherto been used for the purpose of controlling weeds, and many compounds have been known as an active ingredient for herbicides. For example, uracil compounds having herbicidal activity have been known as such compounds (see Patent Document 1).

### CITATION LIST

### Patent Document

Patent Document 1: U.S. Pat. No. 6,537,948

### SUMMARY OF THE INVENTION

### Problems to be Solved by Invention

An object of the present invention is to provide a herbicidal composition which exerts excellent control effect on weeds, and a method for controlling weeds.

### Means to Solve Problems

The present inventors have found that excellent control effect on weeds is exerted by using epyrifenacil in combination with one or more compounds selected from 4-amino-3-chloro-5-fluoro-6-(7-fluoro-1H-indol-6-yl)pyridine-2-carboxylic acid cyanomethyl ester, phenylisoxazoline compound represented by the following formula (1), (1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester, rimisoxafen and 2,4-D DMAPA (3-(dimethylamino)-1-propylamine) salt.

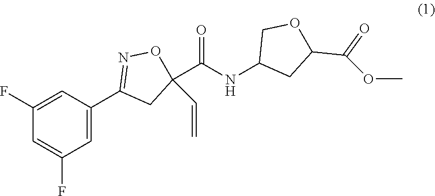 [SMILES: C=CC1(C(=O)NC2COC(C(=O)OC)C2)CC(c2cc(F)cc(F)c2)=NO1]

The present invention includes the following [1] to [20].

[1] A herbicidal composition comprising epyrifenacil and one or more compounds selected from the following compound group Y:
Compound group Y: group consisting of 4-amino-3-chloro-5-fluoro-6-(7-fluoro-1H-indol-6-yl)pyridine-2-carboxylic acid cyanomethyl ester, phenylisoxazoline compound represented by the following formula (1):

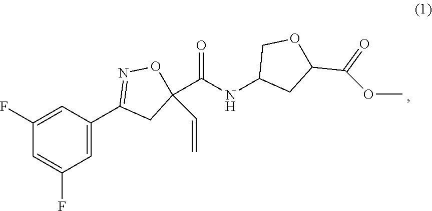 [SMILES: C=CC1(C(=O)NC2COC(C(=O)OC)C2)CC(c2cc(F)cc(F)c2)=NO1]

(1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester, rimisoxafen and 2,4-D DMAPA salt.
[2] The herbicidal composition according to [1], wherein one or more compounds selected from the compound group Y are 4-amino-3-chloro-5-fluoro-6-(7-fluoro-1H-indol-6-yl)pyridine-2-carboxylic acid cyanomethyl ester.
[3] The herbicidal composition according to [1], wherein one or more compounds selected from the compound group Y are (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester.
[4] The herbicidal composition according to [1], wherein one or more compounds selected from the compound group Y are (2S,4S)-4-({[(5R)-3-(3,5-difluorophenyl)-5-vinyl-4,5-dihydroisoxazol-5-yl]carbonyl}amino)tetrahydrofuran-2-carboxylic acid methyl ester.
[5] The herbicidal composition according to [1], wherein one or more compounds selected from the compound group Y are (1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester.
[6] The herbicidal composition according to [1], wherein one or more compounds selected from the compound group Y are rimisoxafen.
[7] The herbicidal composition according to [1], wherein one or more compounds selected from the compound group Y are 2,4-D DMAPA salt.
[8] The herbicidal composition according to any one of [1] to [7], wherein a weight ratio of epyrifenacil to one or more compounds selected from the compound group Y is 1:0.5 to 1:20.
[9] The herbicidal composition according to any one of [1] to [8], comprising a glyphosate salt.
[10] The herbicidal composition according to any one of [1] to [9], comprising a dicamba salt.
[11] A method for controlling weeds, comprising a step of simultaneously or sequentially applying epyrifenacil and one or more compounds selected from the following compound group Y to the place where weeds are growing or will grow: Compound group Y: group consisting of 4-amino-3-chloro-5-fluoro-6-(7-fluoro-1H-indol-6-yl)pyridine-2-carboxylic acid cyanomethyl ester, phenylisoxazoline compound represented by the following formula (1):

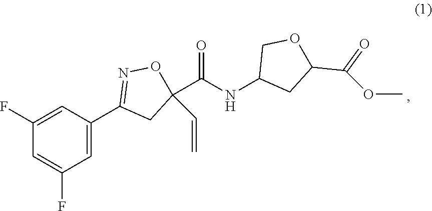 [SMILES: C=CC1(C(=O)NC2COC(C(=O)OC)C2)CC(c2cc(F)cc(F)c2)=NO1]

(1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester, rimisoxafen and 2,4-D DMAPA salt.
[12] The method according to [11], wherein one or more compounds selected from the compound group Y are 4-amino-3-chloro-5-fluoro-6-(7-fluoro-1H-indol-6-yl)pyridine-2-carboxylic acid cyanomethyl ester.
[13] The method according to [11], wherein one or more compounds selected from the compound group Y are (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester.
[14] The method according to [11], wherein one or more compounds selected from the compound group Y are (2S,4S)-4-({[(5R)-3-(3,5-difluorophenyl)-5-vinyl-4,5-dihydroisoxazol-5-yl]carbonyl}amino)tetrahydrofuran-2-carboxylic acid methyl ester.
[15] The method according to [11], wherein one or more compounds selected from the compound group Y are (1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester.
[16] The method according to [11], wherein one or more compounds selected from the compound group Y are rimisoxafen.
[17] The method according to [11], wherein one or more compounds selected from the compound group Y are 2,4-D DMAPA salt.
[18] The method according to any one of [11] to [17], wherein a weight ratio of epyrifenacil to one or more compounds selected from the compound group Y is 1:0.5 to 1:20.
[19] The method according to any one of [11] to [18], wherein the place where weeds are growing or will grow is a crop field.
[20] The method according to [19], wherein the crop field is a field of soybeans, corn or cotton.

### Effects of Invention

According to the present invention, it becomes possible to effectively control weeds.

### MODE FOR CARRYING OUT THE INVENTION

The herbicidal composition of the present invention (hereinafter referred to as present composition) comprises epyrifenacil (hereinafter referred to as compound X) and one or more compounds selected from the compound group Y (hereinafter referred to as compound Y).

The compound X is a compound represented by the following formula (2), which is mentioned in U.S. Pat. No. 6,537,948, and can be produced by a known method.

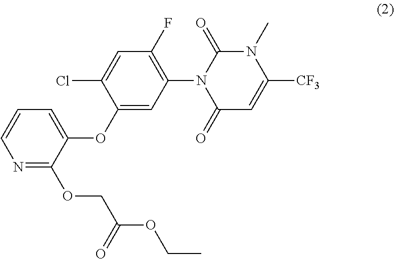 [SMILES: CCOC(=O)COc1ncccc1Oc1cc(-n2c(=O)cc(C(F)(F)F)n(C)c2=O)c(F)cc1Cl]

4-amino-3-chloro-5-fluoro-6-(7-fluoro-1H-indol-6-yl)pyridine-2-carboxylic acid cyanomethyl ester (hereinafter referred to as compound Y1) is a compound represented by the following formula (3), which is mentioned in WO 2018/208582, and can be produced by a known method.

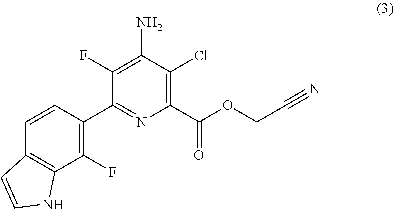 [SMILES: N#CCOC(=O)c1nc(-c2ccc3cc[nH]c3c2F)c(F)c(N)c1Cl]

Phenylisoxazoline compound represented by the formula (1) has three asymmetric carbon centers and there exist eight isomers in total. In the present invention, particularly preferred are two isomers mentioned below.

(2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester (hereinafter referred to as compound Y2) is a compound represented by the following formula (4), which is mentioned in WO 2018/228985, and can be produced by a known method.

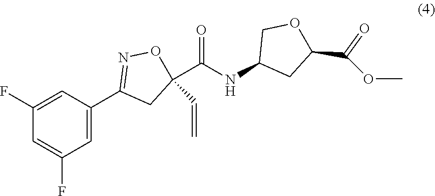 [SMILES: C=C[C@]1(C(=O)N[C@H]2CO[C@@H](C(=O)OC)C2)CC(c2cc(F)cc(F)c2)=NO1]

(2S,4S)-4-({[(5R)-3-(3,5-difluorophenyl)-5-vinyl-4,5-dihydroisoxazol-5-yl]carbonyl}amino)tetrahydrofuran-2-carboxylic acid methyl ester (hereinafter referred to as compound Y3) is a compound represented by the following formula (5), which is mentioned in WO 2018/228985, and can be produced by a known method.

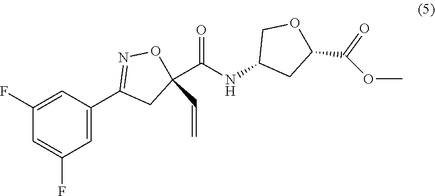 [SMILES: C=C[C@@]1(C(=O)N[C@@H]2CO[C@H](C(=O)OC)C2)CC(c2cc(F)cc(F)c2)=NO1]

Although the compounds Y2 and Y3 have an enantiomeric relationship, in the compound Y included in the present composition, not only a mixture of equal parts of the compounds Y2 and Y3, but also a mixture including them in any ratio are included.

(1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester (hereinafter referred to as compound Y4) is a compound represented by the following formula (6), which is mentioned in WO 2021/001273, and can be produced by a known method.

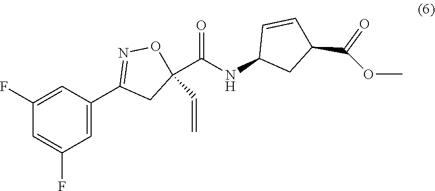 [SMILES: C=C[C@]1(C(=O)N[C@H]2C=C[C@@H](C(=O)OC)C2)CC(c2cc(F)cc(F)c2)=NO1]

Rimisoxafen (hereinafter referred to as compound Y5) is a compound represented by the following formula (7), which is mentioned in WO 2015/108779, and can be produced by a known method.

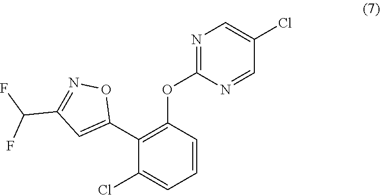 [SMILES: FC(F)c1cc(-c2c(Cl)cccc2Oc2ncc(Cl)cn2)on1]

2,4-D DMAPA (3-(dimethylamino)-1-propylamine) salt (hereinafter referred to as compound Y6) is a compound represented by the following formula (8), which is mentioned in WO 2021/007479, and can be produced by a known method.

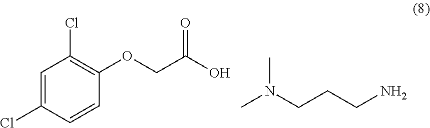

There have been known, as the compound X, at least three or more crystalline polymorphisms with different crystal structures (WO 2018/178039). In the compound X mentioned in the present invention, mixtures composed of all of these crystalline polymorphisms and any two or more crystalline polymorphisms of them are included. In mixtures composed of any two or more crystals of any of crystals selected from crystalline polymorphisms mentioned in WO 2018/178039, mixtures including them in any ratio are also included. When an aqueous liquid suspension concentrate, an oil-based suspension concentrate, a wettable powder, a water dispersible granule, a granule or the like is prepared using one or more crystals selected from the group consisting of crystalline polymorphisms mentioned in WO 2018/178039, a volume median diameter of crystal particles is usually 0.1 to 10 μm, preferably 0.2 to 5 μm, more preferably 1 to 4 μm, and still more preferably 2 to 3 μm. Particularly preferred is an aqueous liquid suspension concentrate in which the volume median diameter of crystal particles is 2 to 3 μm. The particle size distribution of the crystal can also be expressed based on any percentage, in addition to median (50%), and preferable range can be expressed as “volume (40%) diameter of 2.5 μm to volume (60%) diameter of 2.5 μm”. Since the crystal of the compound X having a specified crystal structure has a specific density, it is substantially the same even if the volume median diameter is expressed by the weight median diameter, and it can also be expressed by any percentage.

When an aqueous liquid suspension concentrate, an oil-based suspension concentrate, a wettable powder, a water dispersible granule, a granule or the like is prepared using any crystals of the compound Y, a volume median diameter of crystal particles is usually 0.1 to 10 μm, preferably 0.2 to 5 μm, more preferably 1 to 4 μm, and still more preferably 2 to 3 μm. Particularly preferred is an aqueous liquid suspension concentrate in which the volume median diameter of crystal particles is 2 to 3 μm. The particle size distribution of the crystal can also be expressed based on any percentage, in addition to median (50%), and preferable range can be expressed as “volume (40%) diameter of 2.5 μm to volume (60%) diameter of 2.5 μm”. Since the crystal of the compound Y having a specified crystal structure has a specific density, it is substantially the same even if the volume median diameter is expressed by the weight median diameter, and it can also be expressed by any percentage.

The present composition is usually a formulation prepared by mixing the compound X and the compound Y with a carrier such as a solid carrier and a liquid carrier, and adding adjuvants for formulation such as surfactant as necessary. The formulation type is preferably an aqueous liquid suspension concentrate, an oil-based suspension concentrate, a wettable powder, a water dispersible granule, a granule, a water-based emulsion, an oil-based emulsion or an emulsifiable concentrate, and more preferably an emulsifiable concentrate.

The total content of the compound X and the compound Y in the present composition is usually within a range of 0.01 to 99% by weight, and preferably 1 to 80% by weight.

A weight ratio of the compound X to the compound Y is within a range of 1:0.1 to 1:100, preferably 1:0.12 to 1:80, more preferably 1:0.15 to 1:70, still more preferably 1:0.2 to 1:50, yet more preferably 1:0.3 to 1:30, and further preferably 1:0.5 to 1:20.

Examples of further preferable weight ratio of the compound X to the compound Y in the present composition include 1:0.5, 1:0.6, 1:0.7, 1:0.8, 1:0.9, 1:1, 1:1.2, 1:1.5, 1:1.7, 1:2, 1:2.5, 1:3, 1:4, 1:5, 1:7, 1:10, 1:15 and 1:20.

In the present description, when an active ingredient of herbicides is a salt (e.g., glyphosate potassium salt, 2,4-D DMAPA salt, 2,4-D choline salt or dicamba BAPMA salt), its weight means an acid equivalent unless otherwise specified.

The present composition can exert a synergistic herbicidal effect on a broad range of weeds compared to the effect that is expected from the effects obtained when each one of the compound X and the compound Y is applied alone. Further, the present composition can efficiently control a broad range of weeds in a crop field and a vegetable field, each where a normal tilled or non-tilled cropping is performed, an orchard and a non-crop area, while producing no harmful effect which may be a problem on useful plants.

The present composition may be used in combination with other agrochemical active compounds. The insecticide compounds, nematicide compounds and fungicide compounds which may be used in combination with the present composition include neonicotinoid-based compounds, diamide-based compounds, carbamate-based compounds, organophosphorus-based compounds, biological nematicide compounds, other insecticide compounds and nematicide compounds, as well as azole-based compounds, strobilurin-based compounds, metalaxyl-based compounds, SDHI compounds, other fungicide compounds and plant growth regulators.

The method for controlling weeds of the present invention (hereinafter referred to as present method) comprises a step of applying the compound X and the compound Y to the place where weeds are growing or will grow in a crop field, a vegetable field, an orchard or a non-crop area. In the crop field and the vegetable field, the compound X and the compound Y may be applied before, simultaneously with and/or after seeding crop seeds.

The present method comprises a step of simultaneously or sequentially applying the compound X and the compound Y to the place where weeds are growing or will grow. When sequentially applying, the order of applying the compound X and the compound Y is not particularly limited.

In the present method, a weight ratio of the compound X to the compound Y is within a range of 1:0.1 to 1:100, preferably 1:0.12 to 1:80, more preferably 1:0.15 to 1:70, still more preferably 1:0.2 to 1:50, yet more preferably 1:0.3 to 1:30, and further preferably 1:0.5 to 1:20.

Examples of further preferable weight ratio of the compound X to the compound Y in the present method include 1:0.5, 1:0:6, 1:0.7, 1:0.8, 1:0.9, 1:1, 1:1.2, 1:1.5, 1:1.7, 1:2, 1:2.5, 1:3, 1:4, 1:5, 1:7, 1:10, 1:15 and 1:20.

The compound X and the compound Y may be applied to the agricultural field where crop seeds were seeded or will be seeded before, simultaneously with and/or after seeding the crop seeds treated with one or more compounds selected from the group consisting of insecticide compounds, nematicide compounds and fungicide compounds and the like.

The crop field in the present invention may include a food crop field such as a peanut field, a soybean (indeterminate growth habit, determinate growth habit, semi-determinate growth habit) field, a corn (dent corn, flint corn, flour corn, popcorn, waxy corn, sweet corn) field and a wheat (bread wheat (soft wheat, hard wheat, medium wheat, red wheat, white wheat), durum wheat, spelt wheat, club wheat, and, winter habit and spring habit thereof) field, a barley (two-row barley, six-row barley, hulless barley, hulless waxy barley and, winter habit and spring habit thereof) field, a feed crop field such as a sorghum field and an oat field, an industrial crop field such as a cotton (upland cotton, pima cotton) field and a rapeseed field, a canola (winter habit, spring habit) field and sugar crops such as a sugarcane field and a sugar beet field.

The vegetable field in the present invention may include a field for cultivating solanaceae vegetables (eggplant, tomato, green pepper, chili pepper, potato, etc.), a field for cultivating cucurbitaceae vegetables (cucumber, pumpkin, zucchini, watermelon, melon, etc.), a field for cultivating cruciferous vegetables (radish, turnip, horseradish, kohlrabi, Chinese cabbage, cabbage, mustard, broccoli, cauliflower, etc.), a field for cultivating asteraceae vegetables (burdock, crown daisy, artichoke, lettuce, etc.), a field for cultivating liliaceae vegetables (welsh onion, onion, garlic, asparagus, etc.), a field for cultivating umbelliferae vegetables (carrot, parsley, celery, parsnip, etc.), a field for cultivating chenopodiaceae vegetables (spinach, beet, etc.), a field for cultivating lamiaceae vegetables (perilla, mint, basil, lavender, etc.), a strawberry field, a sweet potato field, a yam field, and an aroid field, etc.

The land under perennial crops in the present invention may include an orchard, a tea field, a mulberry field, a coffee field, a banana field, a palm field, a flowering tree farm, a flowering tree field, a planting stock field, a nursery field, a forest land, or a garden. The orchard tree in the present invention may include pomaceous fruits (apple, pear, Japanese pear, Chinese quince, quince, etc.), stone fruits (peach, plum, nectarine, Japanese apricot, yellow peach, apricot, prune, etc.), citrus fruits (citrus unshiu, orange, lemon, lime, grapefruit, etc.), nut trees (chestnut, walnut, hazelnut, almond, pistachio, cashew nut, macadamia nut, etc.), berry fruits (grape, blueberry, cranberry, blackberry, raspberry, etc.), persimmon, olive, loquat, etc.

The non-crop area in the present invention may include an athletic field, an empty lot, a railroad edge, a park, a parking area, a road edge, a dry riverbed, under power lines, a building land, a factory site, etc.

The crops cultivated in a crop field in the present invention is not particularly limited as long as their varieties are varieties which are usually cultivated.

The plant of the variety mentioned above may be a plant which can be produced by natural hybridization, a plant which can occur as the result of a mutation, an F1 hybrid plant, or a transgenic plant (also referred to as a “genetically-modified plant”). These plants generally have properties such as a property that the tolerance to a herbicide is imparted, a property that a toxic substance against pests is accumulated (also referred to as “pest resistance”), a property that the sensitivity to a plant disease is suppressed (also referred to as “plant disease resistance”), a property that yield potential is increased, a property that the resistance to a biological or non-biological stress factor is improved, and a property that the quality of a product is modified (e.g., increase or decrease in the content of a specific component, change in composition, improvement in a storage property or processability).

The term “F1 hybrid plant” refers to a plant of a first filial generation which is produced by hybridizing two different varieties with each other, and is generally a plant which has a more superior trait to that of either one of parents thereof, i.e., has a hybrid vigor property. The term “transgenic plant” refers to a plant which is produced by introducing a foreign gene from another organism such as a microorganism into a plant and which is imparted with a property that cannot be acquired easily by hybridization breeding, induction of a mutation or a naturally occurring recombination under a natural environment.

Examples of the technique for producing the above-mentioned plants include a conventional breeding technique, a transgenic technique, a genome-based breeding technique, a new breeding technique, and a genome editing technique. The conventional breeding technique is a technique for producing a plant having a desirable property by mutation or hybridization. The transgenic technique is a technique for imparting a new property to a specific organism (e.g., a microorganism) by isolating a gene (DNA) of interest from the organism and then introducing the gene (DNA) into the genome of another target organism, or an antisense technique or an RNA interference technique which is a technique for imparting a new or improved property to a plant by silencing another gene occurring in the plant. The genome-based breeding technique is a technique for increasing the efficiency of breeding using genomic information, and includes a DNA marker (also referred to as “genome marker” or “gene marker”) breeding technique and genomic selection. For example, the DNA marker breeding is a method in which an offspring having a desired useful trait gene is selected from many hybrid offsprings using a DNA marker that is a DNA sequence capable of serving as an indicator of the position of a specific useful trait gene on a genome. The analysis of a hybrid offspring of a plant at a seedling stage thereof using the DNA marker has such a characteristic that it becomes possible to shorten the time required for breeding effectively.

The genomic selection is such a technique that a prediction equation is produced from a phenotype and genomic information both obtained in advance and then a property is predicted from the prediction equation and the genomic information without carrying out the evaluation of the phenotype. The genomic selection can contribute to the increase in efficiency of breeding. A “new breeding technique” is a collective term for combinations of breeding techniques including molecular biological techniques. Examples of the new breeding technique include techniques such as cisgenesis/intragenesis, oligonucleotide-directed mutagenesis, RNA-dependent DNA methylation, genome editing, grafting to a GM rootstock or scion, reverse breeding, agroinfiltration, and seed production technology (SPT). A genome editing technique is a technique for converting genetic information in a sequence-specific manner, and can perform the deletion of a nucleotide sequence, the substitution of an amino acid sequence, the introduction of a foreign gene, and the like. Examples of the tool for the technique include zinc-finger nuclease (ZFN), TALEN, CRISPR/Cas9, CRISPER/Cpf1 and meganuclease which can cleave DNA in a sequence-specific manner, and also include a sequence-specific genome modification technique using CAS9 nickase, Target-AID and the like which is produced by any one of the modification of the above-mentioned tools.

Examples of the above-mentioned plants include plants listed in genetically modified crops registration database (GM APPROVAL DATABASE) in an electric information site in INTERNATIONAL SERVICE for the ACQUISITION of AGRI-BIOTECH APPLICATIONS, ISAAA) (http://www.isaaa.org/). More specific examples of the plans include a herbicide-tolerant plant, a pest-resistant plant, a plant disease-resistant plant, a plant of which the quality (e.g., the increase or decrease in content of a specific component, the change in composition, improvement in a storage property or processability) of a product is modified, a fertility trait modified plant, a non-biological stress-tolerant plant or a plant of which a trait associated with growth or yield is modified.

Examples of the plant imparted with tolerance to herbicides are mentioned below.

Examples of the mechanism of the tolerance to a herbicide include reduction of the affinity of the herbicide for a target; rapid metabolism (e.g., decomposition, modification) of the herbicide as the result of the expression of an enzyme capable of inactivating the herbicide; inhibition of the intake of the herbicide into the body of the plant; and inhibition of the migration of the herbicide in the body of the plant.

The plant imparted with tolerance to a herbicide by a transgenic technique includes plants each imparted with the tolerance to: a protoporphyrinogen oxidase (abbreviated as “PPO”, hereinafter) such as flumioxazin; a 4-hydroxyphenylpyruvate dioxygenase (abbreviated as “HPPD”, hereinafter) inhibitor such as isoxaflutole and mesotrione; an acetolactate synthase (abbreviated as “ALS”, hereinafter) inhibitor such as an imidazolinone-type herbicide such as imazethapyr and a sulfonylurea-type herbicide such as thifensulfuron-methyl; a 5-enolpyruvylshikimate 3-phosphate synthase (abbreviated as “EPSPS”, hereinafter) inhibitor such as glyphosate; a glutamine synthetase inhibitor such as glufosinate; an auxin-type herbicide such as 2,4-D and dicamba; and an oxynil-type herbicide such as bromoxynil. Preferred examples of the herbicide-tolerant transgenic plant include: a cereal such as wheat, barley, rye and oat; canola, sorghum, soybean, corn, cotton, rice, rapeseed, sugar beet, sugar cane, grape, lentil, sunflower, alfalfa, a pome fruit, a stone fruit, coffee, tea, strawberry, wheet grass, and a vegetable such as tomato, potato, cucumber and lettuce; more preferably a cereal such as wheat, barley, rye and oat, soybean, corn, cotton, rice, grape, tomato, potato, and a pome fruit.

Hereinbelow, specific examples of the herbicide-tolerant plant will be mentioned.

Plants tolerant to glyphosate herbicides: produced by introducing at least any one of a glyphosate-tolerant EPSPS gene originated from Agrobacterium tumefaciens strain CP4 (CP4 epsps), a glyphosate N-acetyltransferase gene obtained by modifying a glyphosate N-acetyltransferase gene originated from Bacillus licheniformis (gat4601 or gat4621), a glyphosate oxidase gene originated from Ochrobacterum anthropi strain LBAA (goxv247) or an EPSP gene originated from corn (Zea mays) and having a glyphosate tolerance mutation (mepsps or 2mepsps). Examples of the major plant include alfalfa (Medicago sativa), Argentina canola (Brassica napus), cotton (Gossypium hirsutum L.), creeping bentgrass (Agrostis stolonifera), corn (Zea mays L.), polish canola (Brassica rapa), potato (Solanum tuberosum L.), soybean (Glycine max L.), sugar beet (Beta vulgaris) and wheat (Triticum aestivum). Some of the glyphosate-tolerant plants are commercially available. For example, a genetically-modified plant into which CP4 epsps is introduced is commercially available by trade names including the trademark of “Roundup Ready (registered trademark)”; a genetically-modified plant into which gat4601 or gat4621 is introduced is commercially available by the trade names of “Optimum GAT (trademark)”, “Optimum (registered trademark) Gly canola” and the like; and a genetically-modified plant into which mepsps or 2mepsps is introduced is commercially available by the trademark of “GlyTol (trademark)”. More specific commercially available glyphosate-tolerant plants include, for example, corn by the trade names of “Roundup Ready (trademark) Maize”, “Roundup Ready (trademark) 2 Maize”, “Agrisure (trademark) GT”, “Agrisure (trademark) GT/CB/LL”, “Agrisure (trademark) GT/RW”, “Agrisure (trademark) 3000GT”, “YieldGard (trademark) VT (trademark) Rootworm (trademark) RR2” and “YieldGard (trademark) VT Triple”; soybean by the trade names of “Roundup Ready (trademark) Soybean” and “Optimum GAT (trademark)”; cotton by the trade names of “Roundup Ready (trademark) Cotton”, “Roundup Ready (trademark) Flex Cotton” and “GlyTol (trademark)”; canola by the trade names of “Roundup Ready (trademark) Canola” and “Optimum (registered trademark) Gly canola”; alfalfa by the trademark of “Roundup Ready (trademark) Alfalfa”; rice by the trademark of “Roundup Ready Rice”; sugar cane by the trademark of “Roundup Ready (trademark) sugar beet” and “InVigor (trademark) sugar beet”; and wheat (Triticum aestivum) by the trademark of “Roundup Ready (trademark) wheat”.

Plants tolerant to glufosinate herbicides: produced by introducing at least any one of a gene (bar) for phosphinothricin N-acetyltransferase (hereinafter abbreviated as PAT) originated from Streptomyces hygroscopicus, a gene (pat) originated from Streptomyces viridochromogenes and a synthetic PAT gene (pat syn) originated from Streptomyces viridochromogenes strain Tu494. Examples of the major plant include Argentina canola (Brassica napus), chicory (Cichorium intybus), cotton (Gossypium hirsutum L.), corn (Zea mays L.), polish canola (Brassica rapa), rice (Oryza sativa L.), soybean (Glycine max L.) and sugar beet (Beta vulgaris). Some of the glufosinate-tolerant plants are commercially available. For example, a genetically-modified plant into which bar or pat is introduced is commercially available by the trade names of “LibertyLink (trademark)”, “InVigor (trademark)” and “WideStrike (trademark)”. More specific commercially available glufosinate-tolerant plants include, for example, corn by the trade names of “Roundup Ready (trademark) 2”, “Liberty Link (trademark)”, “Herculex (trademark) I”, “Herculex RW”, “Herculex XTRA (trademark)”, “Agrisure (trademark) GT/CB/LL”, “Agrisure (trademark) CB/LL/RW” and “Bt10”; cotton by the trade names of “FiberMax (trademark) Liberty Link (trademark)”; rice by the trademark of “Liberty Link (trademark) Rice”; canola by the trademark of “inVigor (trademark) Canola”; soybean by the trademark of “Liberty Link (trademark) Soybean”; and sugar cane by the trademark of “Liberty Link (trademark) sugarbeet”.

Plants tolerant to oxynil-type herbicides (e.g., bromoxynil): produced by introducing a nitrilase gene (bxn) originated from Klebsiella pneumoniae subsp. ozaenae. Examples of the major plant include Argentina Canola (Brassica napus), cotton (Gossypium hirsutum L.) and tobacco (Nicotiana tabacum L.). Some plants tolerant to oxynil-type herbicides are commercially available. For example, these plants are commercially available by trade names including “Navigator (trademark)” and “BXN (trademark)”. More specific commercially available plants tolerant to oxynil-type herbicides include, for example, cotton by the trademark of “BXN (trademark) Cotton”; and Argentina canola by the trademark of “Navigator (trademark) Cotton”.

Plants tolerant to ALS herbicides: carnation (Dianthus caryophyllus) having, introduced therein, an ALS herbicide-tolerant ALS gene (surB) originated from tobacco (Nicotiana tabacum) as a selection marker is commercially available by the trade names of, for example, “Moondust (trademark)”, “Moonshadow (trademark)”, “Moonshade (trademark)”, “Moonlite (trademark)”, “Moonaqua (trademark)”, Moonvista (trademark)”, “Moonique (trademark)”, “Moonpearl (trademark)”, “Moonberry (trademark)” and “Moonvelvet (trademark)”. Lineseed (Linum usitatissumum L.) having, introduced therein, an ALS herbicide-tolerant ALS gene (als) originated from mouse-ear cress (Arabidopsis thaliana) is commercially available by the trademark of, for example, “CDC Triffid Flax”. Corn (Zea mays L.) having tolerance to a sulfonylurea-type herbicide and an imidazolinone-type herbicide and having, introduced therein, an ALS herbicide-tolerant ALS gene (zm-hra) originated from corn is commercially available by the trademark of, for example, “Optimum (trademark) GAT (trademark)”. Soybean having tolerance to an imidazolinone-type herbicide and having, introduced therein, an ALS herbicide-tolerant ALS gene (csr1-2) originated from mouse-ear cress is commercially available by the trademark of, for example, “Cultivance”. Soybean having, introduced therein, an ALS herbicide-tolerant ALS gene (gm-hra) originated from soybean (Glycine max) is commercially available by the trade names of, for example, “Treus (trademark)”, “Plenish (trademark)” and “Optimum GAT (trademark)”. Cotton having, introduced therein, an ALS herbicide-tolerant ALS gene (S4-HrA) originated from tobacco (Nicotiana tabacum cv. Xanthi) can also be mentioned.

Plants tolerant to HPPD herbicides: produced by introducing an HPPD gene (avhppd-03) originated from oat (Avena sativa). For example, soybean into which a PAT gene (pat) originated from Streptomyces viridochromogenes is also introduced simultaneously with the above-mentioned gene is commercially available by the trademark of “Herbicide-tolerant Soybean line” as soybean having tolerance to mesotrione and glufosinate.

Plants tolerant to 2,4-D or ACCase: corn having, introduced therein, an aryloxyalkanoate dioxygenase gene (aad-1) originated from Sphingobium herbicidovorans and having tolerance to an ACCase herbicide is commercially available by the trademark of “Enlist (trademark) Maize”. Soybean and cotton having, introduced therein, an aryloxyalkanoate dioxygenase gene (aad-12) originated from Delftia acidovorans and having tolerance to 2,4-D are known, and are commercially available by the trademark of, for example, “Enlist (trademark) Soybean”.

Plants tolerant to dicamba herbicides: produced by introducing a dicamba monooxygenase gene (dmo) originated from Stenotrophomonas maltophilia strain DI-6. Soybean and cotton into which the above-mentioned gene is introduced are known. Soybean (Glycine max L.) into which a glyphosate-tolerant EPSPS gene (CP4 epsps) originated from Agrobacterium tumefaciens strain CP4 is also introduced simultaneously with the above-mentioned gene is commercially available by the trademark of, for example, “Genuity (registered trademark) Roundup Ready (trademark) 2 Xtend (trademark)”.

Other plants which are modified with respect to the tolerance to herbicides are also widely known, such as: alfalfa, apple, barley, eucalyptus, lineseed, grape, lentil, rapeseed, pea, potato, rice, sugar beet, sunflower, tobacco, tomato, turf grass and wheat each having tolerance to glyphosate (see, for example, U.S. Pat. Nos. 5,188,642, 4,940,835, 5,633,435, 5,804,425 and 5,627,061); bean, cotton, soybean, pea, potato, sunflower, tomato, tobacco, corn, sorghum and sugar cane each having tolerance to dicamba (see, for example, WO 2008/051633, U.S. Pat. Nos. 7,105,724 and 5,670,454); soybean, sugar beet, potato, tomato and tobacco each having tolerance to glufosinate (see, for example, U.S. Pat. Nos. 6,376,754, 5,646,024 and 5,561,236); cotton, peppers, apple, tomato, sunflower, tobacco, potato, corn, cucumber, wheat, soybean, sorghum and millets each having tolerance to 2,4-D (see, for example, U.S. Pat. Nos. 6,153,401, 6,100,446, WO 2005/107437, U.S. Pat. Nos. 5,608,147 and 5,670,454); canola, corn, barnyard millet, barley, cotton, brown mustard, lettuce, lentil, melon, foxtail millet, oat, rapeseed, potato, rice, rye, sorghum, soybean, sugar beet, sunflower, tobacco, tomato and wheat each having tolerance to an ALS-inhibiting herbicide (e.g., a sulfonylurea-type herbicide or an imidazolinone-type herbicide) (see, for example, U.S. Pat. No. 5,013,659, WO 2006/060634, U.S. Pat. Nos. 4,761,373, 5,304,732, 6,211,438, 6,211,439 and 6,222,100) (particularly, rice having tolerance to an imidazolinone-type herbicide; rice having a specific mutation (e.g., S653N, S654K, A122T, 5653(At)N, 5654(At)K, A122(At)T) in an acetolactate synthase gene (acetohydroxyacid synthase gene) (see, for example, US 2003/0217381, WO 2005/20673)); barley, sugar cane, rice, corn, tobacco, soybean, cotton, rapeseed, sugar beet, wheat and potato each having tolerance to an HPPD-inhibiting herbicide (e.g., an isoxazole-type herbicide such as isoxaflutole; a triketone-type herbicide such as sulcotrione and mesotrione; a pyrazole-type herbicide such as pyrazolynate) or diketonitrile that is a decomposition product of isoxaflutole (see, for example, WO 2004/055191, WO 1996/38567, WO 1997/049816 and U.S. Pat. No. 6,791,014); and wheat, soybean, cotton, sugar beet, rapeseed, rice, corn, sorghum, sugar cane and sugar beet each having tolerance to a PPO-inhibiting herbicide (see, for example, US 2002/0073443, US 2008/0052798, Pest Management Science, 61, 2005, 277-285).

Examples of a plant that is imparted with tolerance to a herbicide by a conventional breeding technique or genome-based breeding technique include: rice “Clearfield (registered trademark) Rice”, wheat “Clearfield (registered trademark) Wheat”, sunflower “Clearfield (registered trademark) Sunflower”, lentil “Clearfield (registered trademark) lentils” and canola “Clearfield (registered trademark) canola” (a product by manufactured by BASF) each having tolerance to an imidazolinone-type ALS-inhibition-type herbicide such as imazethapyr and imazamox; soybean “STS soybean” having tolerance to a sulfonylurea-type ALS-inhibition-type herbicide such as thifensulfuron-methyl; corn “SR corn” (also known as “Poast Protected (registered trademark) corn”) having tolerance to an acetyl CoA carboxylase inhibitor such as a trione oxime-type herbicide and an aryloxyphenoxypropionate-type herbicide; sunflower “ExpressSun (registered trademark)” having tolerance to a sulfonylurea-type herbicide such as tribenuron; rice “Provisia (trademark)” having tolerance to an acetyl CoA carboxylase inhibitor such as quizalofop; canola “Triazine Tolerant Canola” having tolerance to a photosystem II inhibitor; and sorghum “Igrowth (trademark)” having tolerance to an imidazolinone-type herbicide.

An example of a plant that is imparted with tolerance to a herbicide by a genome editing technique is canola “SU Canola (registered trademark)” having tolerance to a sulfonylurea-type herbicide and produced by Rapid Trait Development System (RTDS (registered trademark)). RTDS (registered trademark) corresponds to an oligonucleotide-directed mutagenesis employed in a genome editing technique, and is a technique whereby it becomes possible to introduce a mutation into a plant through Gene Repair Oligonucleotide (GRON), i.e., a DNA-RNA chimeric oligonucleotide, without needing to cleave DNA in the plant. Other examples of the plant also include: corn which is reduced in herbicide tolerance and a phytic acid content as the result of the deletion of endogenous gene IPK1 using a zinc finger nuclease (see, for example, Nature 459, 437-441 2009); and rice which is imparted with herbicide tolerance using CRISPR/Cas9 (see, for example, Rice, 7, 5 2014).

Examples of a plant imparted with tolerance to a herbicide by a new breeding technique include soybean in which a trait of a GM rootstock is imparted to a scion using the breeding technique employing grafting. Specifically, soybean in which tolerance to glyphosate is imparted to a non-transgenic soybean scion using Roundup Ready (registered trademark) soybean having tolerance to glyphosate as a rootstock (see Weed Technology 2013, 27, 412) can be mentioned as an example.

Hereinbelow, examples of a plant imparted with pest resistance will be mentioned.

Examples of a plant imparted with resistance to a lepidopteran pest by a transgenic technique include corn (Zea mays L.), soybean (Glycine max L.), cotton (Gossypium hirsutum L.), rice (Oryza sativa L.), poplar (Populus sp.), tomato (Lycopersicon esculentum), eggplant (Solanum melongena) and sugar cane (Saccharum sp.) each having, introduced therein, a gene encoding 5-endotoxin which is an insecticidal protein originated from Bacillus thuringiensis (abbreviated as “Bt bacterium”, hereinafter), which is a soil bacterium. Examples of a δ-endotoxin imparting resistance to a lepidopteran pest include Cry1A, Cry1Ab, modified Cry1Ab (partly defective Cry1Ab), Cry1Ac, Cry1Ab-Ac (hybrid protein in which Cry1Ab and Cry1Ac are fused), Cry1C, Cry1F, Cry1Fa2 (modified cry1F), moCry1F (modified Cry1F), Cry1A.105 (hybrid protein in which Cry1Ab, Cry1Ac and Cry1F are fused), Cry2Ab2, Cry2Ae, Cry9C, Vip3A and Vip3Aa20.

Examples of a plant imparted with resistance to a coleopteran pest by a transgenic technique include corn and potato having, introduced therein, a gene encoding a 5-endotoxin which is an insecticidal protein originated from a Bt bacterium, which is a soil bacterium. Examples of a 6-endotoxin imparting resistance to a coleopteran pest include Cry3A, mCry3A (modified Cry3A), Cry3Bb1, Cry34Ab1, Cry35Ab1, Cry6A, Cry6Aa and mCry6Aa (modified Cry6Aa).

Examples of a plant imparted with resistance to a dipterous pest by a transgenic technique include corn (Zea mays L.) having, introduced therein, a synthesized gene encoding a hybrid protein eCry3.1Ab in which Cry3A and Cry1Ab are fused originated from a Bt bacterium, which is a soil bacterium, and cotton (Gossypium hirsutum L.) having, introduced therein, a gene encoding a trypsin inhibitor CpTI originated from black-eyed pea (Vigna unguiculata). Examples thereof further include poplar having, introduced therein, a gene encoding API which is a protease inhibitor protein A originated from arrowhead (Sagittaria sagittifolia) and the like, which shows resistance to a wide range of pests.

Examples of an insecticidal protein imparting pest resistance to a plant also include a hybrid protein, a partially defective protein and a modified protein of the above-mentioned insecticidal protein. The hybrid protein is produced by a combination of different domains of a plurality of insecticidal proteins using a transgenic technique, and Cry1Ab-Ac and Cry1A.105 and the like are known. As the partially defective protein, Cry1Ab in which an amino acid sequence is partially defective and the like is known. As the modified protein, a protein in which one or a plurality of amino acid(s) of a natural 5-endotoxin is/are substituted, i.e., Cry1Fa2, moCry1F and mCry3A and the like are known. The modified protein also includes a case where a non-naturally occurring protease recognition sequence is inserted into a toxin, and examples thereof include Cry3A055 in which a cathepsin G-recognition sequence is inserted into a Cry3A toxin (see WO 2003/018810).

Cotton (event MON88702) having, introduced therein, a BT protein Cry51Aa2 (Cry51Aa2.834_16) modified by a transgenic technique has been developed by Monsanto Company, and it shows resistance to the genus Lygus such as Lygus lineolaris, Hemiptera such as aphid and Thysanoptera such as the genus Frankliniella.

Examples of other insecticidal proteins imparting pest resistance to a plant by a transgenic technique include: an insecticidal protein originated from Bacillus cereus or Bacillus popilliae; plant insecticidal proteins Vip1, Vip2, Vip3 (as a subclass, Vip3Aa to Vip3Aj, Vip3Ba, Vip3B and Vip3Ca are known, and specifically, for example, Vip3Aa20 and Vip3Aa61 are known) and Vip4; an insecticidal protein originated from bacteria symbiosing with nematode (making a colony in nematode) including Photorhabdus spp. such as Photorhabdus luminescens or Xenorhabdus spp. such as Xenorhabdus nematophilus; a toxin produced by an animal containing an insect-specific neurotoxin such as a scorpion toxin, a spider toxin and a bee toxin; a toxin produced by filamentous fungi such as a Streptomycetes toxin; plant lectin such as pea lectin, barley lectin and snow drop lectin; agglutinin; a protease inhibitor such as a trypsin inhibitor, a serine protease inhibitor, patatin, cystatin and a papain inhibitor; a ribosome-inactivating protein (RIP) such as ricin, corn-RIP, abrin, luffin, saporin and bryodin; a steroid-metabolizing enzyme such as 3-hydroxysteroid oxidase, ecdysteroid-UDP-glucosyltransferase and cholesterol oxidase; an ecdysone inhibitor; HMG-CoA-reductase; an ion channel inhibitor such as a sodium channel inhibitor and a calcium channel inhibitor; juvenile hormone esterase; a diuretic hormone receptor; stilbene synthase; bibenzyl synthase; chitinase; and glucanase.

A plant imparted with pest resistance by introducing one or two or more insecticidal protein gene(s) has been already known, and some plants are commercially available.

Examples of cotton imparted with pest resistance include: “Bollgard (trademark) cotton”, “BXN (trademark) Plus Bollgard (trademark) Cotton”, “BXN (trademark) Plus Bollgard (trademark) Cotton”, “JK 1”, “Roundup Ready (trademark) Bollgard (trademark) Cotton” and “Ingard (trademark)” each of which expresses an insecticidal protein Cry1Ac originated from a Bt bacterium; “Herculex (trademark) I” and “Herculex (trademark) CB” each of which expresses an insecticidal protein modified Cry1F (Cry1Fa2) originated from a Bt bacterium; “VIPCOT (trademark) Cotton” which expresses an insecticidal protein Vip3A originated from a Bt bacterium; “Bollgard II (trademark) cotton”, “Roundup Ready (trademark) Bollgard II (trademark) Cotton”, “Roundup Ready (trademark) Flex (trademark) Bollgard II (trademark) Cotton” and “Fivermax (trademark) Liberty Link (trademark) Bollgard II (trademark)” each of which expresses insecticidal proteins Cry1Ac and Cry2Ab originated from a Bt bacterium; “Bollgard III (registered trademark)” and “Bollgard (registered trademark) III×Roundup Ready (trademark) Flex (trademark)” each of which expresses insecticidal proteins Cry1Ac, Cry2Ab and Vip3A originated from a Bt bacterium; “VIPCOT (trademark) Roundup Ready Flex (trademark) Cotton” which expresses insecticidal proteins Vip3A and Cry1Ab originated from a Bt bacterium; “VIPCOT (registered trademark) Cotton” which expresses insecticidal proteins Vip3A and Cry1Ac originated from a Bt bacterium; “WideStrike (trademark) Cotton”, “WideStrike (trademark) Roundup Ready (trademark) Cotton” and “Widestrike (trademark) Roundup Ready Flex (trademark) Cotton” each of which expresses insecticidal proteins Cry1Ac and Cry1F originated from a Bt bacterium; “TwinLink (trademark) Cotton” and “Glytol (trademark)×Twinlink (trademark)” each of which expresses insecticidal proteins Cry1Ab and Cry2Ae originated from a Bt bacterium; “Widestrike (registered trademark) 3” and “Widestrike (trademark)×Roundup Ready Flex (trademark)×VIPCOT (trademark) Cotton” each of which expresses insecticidal proteins Cry1Ac, Cry1F and Vip3A originated from a Bt bacterium; and “Glytol (trademark)×Twinlink (trademark)×VIPCOT (trademark) Cotton” which expresses insecticidal proteins Cry1Ab, Cry2Ae and Vip3A originated from a Bt bacterium, all of which are commercially available.

Examples of corn imparted with pest resistance include: “YieldGard (registered trademark) Rootworm RW”, “YieldGard (trademark) RW+RR”, “YieldGard (trademark) VT (trademark) Rootworm (trademark) RR2” and “MaxGard (trademark)” each of which expresses an insecticidal protein Cry3Bb1 originated from a Bt bacterium; “YieldGard (registered trademark) VT Triple” and “YieldGard (trademark) Plus with RR” each of which expresses insecticidal proteins Cry3Bb1 and Cry1Ab originated from a Bt bacterium; “Bt Xtra (trademark) Maize” which expresses an insecticidal protein Cry1Ac originated from a Bt bacterium; “YieldGard Plus (registered trademark)” which expresses insecticidal proteins Cry1Ab and Cry3Bb1 originated from a Bt bacterium; “Bt10”, “Liberty Link (trademark) Yieldgard (trademark) Maize”, “Agrisure (trademark) GT/CB/LL” and “YieldGard (trademark) CB+RR” each of which expresses an insecticidal protein Cry1Ab originated from a Bt bacterium; “YieldGard (trademark) VT Pro (trademark)” and “Genuity (registered trademark) VT Double Pro (trademark)” each of which expresses insecticidal proteins Cry1A.105 and Cry2Ab2 originated from a Bt bacterium; “Agrisure (registered trademark) RW” and “Agrisure (trademark) GT/RW” each of which expresses an insecticidal protein mCry3A originated from a Bt bacterium; “Starlink (trademark) Maize” which expresses an insecticidal protein Cry9C originated from a Bt bacterium; “YieldGard (trademark)”, “MaizeGard (trademark)”, “NaturGard KnockOut (trademark)”, “Maximizer (trademark)”, “Roundup Ready (trademark) YieldGard (trademark) maize”, “Agrisure (trademark) CB/LL” and “Mavera (trademark) YieldGard (trademark) Maize” each of which expresses an insecticidal protein Cry1Ab originated from a Bt bacterium; “Agrisure (registered trademark) 3122” which expresses insecticidal proteins Cry1Ab, Cry1F, modified Cry3A, Cyr34Ab1 and Cyr35Ab1 originated from a Bt bacterium; “Agrisure (registered trademark) Viptera” which expresses an insecticidal protein Vip3Aa20 originated from a Bt bacterium; “Agrisure (registered trademark) Viptera (trademark) 2100” and “Agrisure (registered trademark) Viptera (trademark) 3110” each of which expresses insecticidal proteins Vip3Aa20 and Cry1Ab originated from a Bt bacterium; “Agrisure (registered trademark) Viptera (trademark) 3100”, “Agrisure (registered trademark) Viptera (trademark) 3111) and “Agrisure (registered trademark) Viptera (trademark) 4” each of which expresses insecticidal proteins Vip3Aa20, Cry1Ab and modified Cry3A originated from a Bt bacterium; “Agrisure (registered trademark) Viptera (trademark) 3220” which expresses insecticidal proteins Vip3Aa20, Cry1Ab and modified Cry1F originated from a Bt bacterium; “Agrisure (registered trademark) Duracade (trademark)” which expresses an insecticidal protein eCry3.1Ab (chimeric protein of Cry3A-Cry1Ab) originated from a Bt bacterium; “Agrisure (registered trademark) Duracade (trademark) 5122” which expresses insecticidal proteins eCry3.1Ab (chimeric protein of Cry3A-Cry1Ab), modified Cry3A, Cry1Ab and modified Cry1F originated from a Bt bacterium; “Agrisure (registered trademark) Duracade (trademark) 5222” which expresses insecticidal proteins eCry3.1Ab (chimeric protein of Cry3A-Cry1Ab), modified Cry3A, modified Cry1Ab and Vip3A variant originated from a Bt bacterium; “Herculex (trademark) RW” which expresses insecticidal proteins Cyr34Ab1 and Cyr35Ab1 originated from a Bt bacterium; “Herculex XTRA (trademark)” which expresses insecticidal proteins Cyr34Ab1, Cyr35Ab1 and Cry1F originated from a Bt bacterium; “Genuity (registered trademark) VT Triple Pro (trademark)” which expresses insecticidal proteins Cry1A.105, Cry2Ab2 and Cry3Bb1 originated from a Bt bacterium; “Genuity (registered trademark) SmartStax (trademark)” which expresses insecticidal proteins Cry1F, Cry2Ab, Cyr34Ab1, Cyr35Ab1, Cry3Bb1 and Cry1A.105 originated from a Bt bacterium; “Power Core (trademark)” which expresses insecticidal proteins modified Cry1F, Cry2Ab and Cry1A.105 originated from a Bt bacterium; “Herculex XTRA (trademark) RR” which expresses insecticidal proteins modified Cry1F, Cyr34Ab1 and Cyr35Ab1 originated from a Bt bacterium; “Optimum (registered trademark) Intrasect Xtreme” which expresses insecticidal proteins modified Cry1F, Cyr34Ab1, Cyr35Ab1, Cry1Ab and modified Cry3A originated from a Bt bacterium; “Optimum (registered trademark) Intrasect XTRA” which expresses insecticidal proteins modified Cry1F, Cyr34Ab1, Cyr35Ab1 and Cry1Ab originated from a Bt bacterium; and “Optimum (registered trademark) TRIsect” which expresses insecticidal proteins modified Cry1F and modified Cyr3A originated from a Bt bacterium, all of which are commercially available.

Examples of other plants imparted with pest resistance include: potato “Atlantic NewLeaf (trademark) potato”, “NewLeaf (trademark) Russet Burbank potato”, “Lugovskoi plus”, “Elizaveta plus”, “Hi-Lite NewLeaf (trademark) Y potato, Superior NewLeaf (trademark) potato” and “Shepody NewLeaf (trademark) Y potato” each of which expresses an insecticidal protein Cry3A originated from a Bt bacterium; rice “hanyou 63” and “Huahui-1” each of which expresses insecticidal proteins Cry1Ab and Cry1Ac originated from a Bt bacterium; soybean “Intacta (trademark) Roundup Ready (trademark) 2 Pro” which expresses an insecticidal protein Cry1Ac originated from a Bt bacterium; and eggplant “BARI Bt Begun-1, -2, -3 and -4” which expresses an insecticidal protein Cry1Ac originated from a Bt bacterium, all of which are commercially available.

The following plants are also known: corn “YieldGard corn rootworm”, “YieldGard VT”, “Herculex RW”, “Herculex Rootworm” and “Agrisure CRW” each having resistance to corn rootworm; corn “YieldGard corn borer”, “YieldGard plus”, “YieldGard VT Pro”, “Agrisure CB/LL”, “Agrisure 3000GT”, “Hercules I”, “Hercules II”, “KnockOut”, “NatureGard” and “StarLink” each having resistance to corn borer; corn “Herculex I”, “Herculex Xtra”, “NewLeaf”, “NewLeaf Y” and “NewLeaf Plus” each having resistance to western bean cutworm, corn borer, black cutworm and fall armyworm; corn “YieldGard Plus” having resistance to corn borer and corn rootworm; cotton “Bollgard I” and “Bollgard II” each having resistance to tobacco budworm; cotton “Bollgard II”, “WideStrike (trademark)” and “VipCot” each having resistance to tobacco budworm, cotton bollworm, fall armyworm, beet armyworm, cabbage looper, soybean looper and pink bollworm; potato “NewLeaf”, “NewLeaf Y” and “NewLeaf Plus” each having resistance to tobacco hornworm; and eggplant “Bt brinjal”, “Dumaguete Long Purple” and “Mara” each having resistance to eggplant fruit and shoot borer, fruit borer and cotton bollworm (see, for example, U.S. Pat. No. 5,128,130).

A further plant having pest resistance is generally known, and examples thereof include rice having resistance to yellow stem borer (see, for example, Molecular Breeding, vol. 18 (2006), No. 1), lettuce having resistance to Lepidoptera (see, for example, U.S. Pat. No. 5,349,124) and rice having resistance to Lepidoptera (e.g., Asiatic rice borer, straight swift, Asiatic pink stem borer, rice leafroller, rice caseworm and rice armyworm) (see, for example, WO 2001/021821). A method for producing such plant is generally known by a person skilled in the art, and, for example, is mentioned in the above-mentioned publication.

As a plant imparted with pest resistance by an RNA interference technique, corn having resistance to a lepidopteran pest (e.g., corn borers, corn earworm, cutworms such as black cutworm, and fall armyworm) and a coleopteran pest (corn rootworms) is commercially available or developed by the trademark of “SmartStax (registered trademark)”, “SmartStax (registered trademark) Pro” or “Genuity (registered trademark) SmartStax Pro”.

Examples of a plant imparted with pest resistance by a conventional breeding technique or genome-based breeding technique include: soybean having resistance to soybean aphid (Aphis glycines) having a “Rag1 (Resistance to Aphis glycines 1)” gene or a “Rag2 (Resistance to Aphis glycines 2)” gene, which is a gene having resistance to aphid (see J. Econ. Entomol., 2015, 108, 326.); soybean having resistance to soybean cyst nematode (Heterodera glycines) (see Phytopathology, 2016, 106, 1444.); cotton having resistance to root-knot nematode (Meloidogyne incognita) (J. Nematol., 2009, 41, 140); rice “KANTO BPH1” having resistance to brown planthopper; and soybean “FUKUMINORI” having resistance to Oriental leafworm moth.

These plants imparted with pest resistance are imparted with resistance to any harmful insect (particularly, a lepidopteran insect, a coleopteran insect, a dipterous insect, a coleopteran insect), harmful spiders and harmful nematodes. The plant imparted with pest resistance is preferably selected from grains (e.g., wheat, barley, rye, oat), corn, canola, sorghum, soybean, rice, rapeseed, sugar beet, sugar cane, grape, lentil, sunflower, alfalfa, pome fruits, stone fruits, peanuts, coffee, tea, strawberries, lawn and vegetables (e.g., tomato, potato, Cucurbitaceae plants and lettuce), more preferably selected from soybean, tomatoes, and still more preferably selected from soybean, corn, tomatoes, rice and grains (e.g., wheat, barley, rye and oat), and most preferably selected from soybean, rice, corn and grains (e.g., wheat, barley, rye and oat).

Hereinbelow, examples of a plant imparted with plant disease resistance will be mentioned.

A plant imparted with plant disease resistance by a transgenic technique is, for example, a plant which expresses so-called “pathogenesis-related protein” (PRP, see, for example, EP 0392225) or so-called “antifungal protein” (AFP, see, for example, U.S. Pat. No. 6,864,068). Various antifungal proteins having activity on a phytopathogenic fungus are isolated from a specific plant species, which is common sense. Examples of such antipathogenic substance and a plant capable of synthesizing such antipathogenic substance are known from, for example, EP 0392225, WO 1993/05153, WO 1995/33818 and EP 0353191. A plant having resistance to a fungicidal pathogen, a viral pathogen and a bacterial pathogen is produced by introducing a pathogen-resistant gene. Many resistant genes were identified and isolated for use to improve pathogen resistance. Examples of such resistant gene include an N gene introduced into a tobacco line sensitive to TMV in order to produce a tobacco plant having resistance to a tobacco mosaic virus (TMV) (see, for example, U.S. Pat. No. 5,571,706), a Prf gene introduced into a plant in order to acquire enhanced pathogen resistance (see, for example, WO 1998/02545) and an Rps2 gene originated from mouse-ear cress (Arabidopsis thaliana) used in order to produce resistance to a bacterial pathogen such as Pseudomonas syringae (see, for example, WO 1995/028423). A plant which exhibits systemic acquired resistance response was obtained by introducing a nucleic acid molecule encoding a TIR domain of an N gene (see, for example, U.S. Pat. No. 6,630,618). Further examples of a known resistant gene include: an Xa21 gene introduced into many rice varieties (see, for example, U.S. Pat. Nos. 5,952,485, 5,977,434, WO 1999/009151, WO 1996/022375); an Rcg1 gene for resistance to Colletotrichum (see, for example, US 2006/225152); a prp1 gene (see, for example, U.S. Pat. No. 5,859,332, WO 2008/017706); a ppv-cp gene for introducing resistance to Plum pox virus (see, for example, US PP15,154Ps); a P1 gene (see, for example, U.S. Pat. No. 5,968,828); genes such as Blb1, Blb2, Blb3, RB2 and Rpi-vnt1 for introducing resistance to Potato late blight fungus in potato (see, for example, U.S. Pat. No. 7,148,397); an LRPKml gene (see, for example, WO 1999/064600); a P1 gene for resistance to potato virus Y (see, for example, U.S. Pat. No. 5,968,828); an HA5-1 gene (see, for example, U.S. Pat. Nos. 5,877,403 and 6,046,384); a PIP gene for introducing broad resistance to potato virus X (PVX), potato virus Y (PVY), potato leafroll virus (PLRV) and the like (see, for example, EP 0707069); and genes such as an NI16 gene, a ScaM4 gene and a ScaM5 gene of mouse-ear cress (Arabidopsis) for acquiring fungus resistance (see, for example, U.S. Pat. No. 6,706,952 and EP1018553). Kidney bean having resistance to Bean golden mosaic virus (hereinafter referred to as “BGMV”) is a plant imparted with resistance by an RNA interference technique, and a double-stranded RNA gene (sense and antisense ac1 gene) of a replication protein is introduced therein to inhibit synthesis of a replication protein of BGMV, thereby exhibiting resistance to BGMV. A method for producing such plant is generally known by a person skilled in the art, and, for example, is mentioned in the above-mentioned publication.

Examples of an antipathogenic substance which can be expressed by such plant include: an ion channel blocker (sodium channel blocker, calcium channel blocker, etc.); viral KP1, KP4 and KP6 toxins; stilbene synthase; bibenzyl synthase; chitinase; glucanase; so-called “pathogenesis-related protein” (PRP; see, for example, EP 0392225); and an antipathogenic substance produced by a microorganism (e.g., peptide antibiotic, heterocyclic antibiotic (see, for example, WO 1995/033818) and a protein factor or polypeptide factor involved in phytopathogen protection (so-called “plant disease-resistant gene” mentioned in WO 2003/000906)).

An antipathogenic substance produced by a plant is capable of protecting the plant from various pathogenic microorganisms such as fungi, viruses and bacteria. A useful plant which draws increasing attention in association with the present invention includes grains (e.g., wheat, barley, rye and oat), soybean, corn, rice, rapeseed, pome fruits, stone fruits, peanut, coffee, tea, strawberry, lawn; liana and vegetables (e.g., tomato, potato), Cucurbitaceae plants, papaya, melon, lenses and lettuce, and is more preferably selected from soybean, tomato, rice and grains (e.g., wheat, barley, rye and oat), and most preferably selected from soybean, rice and grains (e.g., wheat, barley, rye and oat).

Examples of a plant having resistance to a fungal pathogen include: soybean having resistance to soybean rust fungi (Phakopsora pachyrhizi and Phakopsora meibomiae) (see, for example, WO 2008/017706); a Solanaceae plant such as cotton, tomato and potato having resistance to a potato late blight fungus (Phytophthora infestans) (see, for example, U.S. Pat. Nos. 5,859,332, 7,148,397, EP1334979); corn having resistance to the genus Coiletotrichum such as Colietotrichum graminicola (see, for example, US 2006/225152); apple having resistance to an apple scab fungus (Venturia inaequalis) (see, for example, WO 1999/064600); a plant having resistance to Fusarium fungi (e.g., Fusarium graminearum, Fusarium sporotrichioides, Fusarium lateritium, Fusarium pseudograminearum, Fusarium sambucinum, Fusarium culmorum, Fusarium poae, Fusarium acuminatum, Fusarium equiseti) (e.g., rice, wheat, barley, rye, corn, oat, potato, melon, soybean and sorghum) (see, for example, U.S. Pat. No. 6,646,184, EP 1477557); a plant such as corn, soybean, grains (particularly, wheat, barley, rye and oat), rice, tobacco, sorghum, sugar cane and potato having broad fungicidal resistance (see, for example, U.S. Pat. Nos. 5,859,332, 5,689,046, 6,706,952, EP 1018553 and U.S. Pat. No. 6,020,129).

Examples of a plant having resistance to a bacterial pathogen include: rice having resistance to Xylella fastidiosa (see, for example, U.S. Pat. No. 6,232,528); a plant such as rice, cotton, soybean, potato, sorghum, corn, wheat, barley, sugar cane, tomato and pepper having resistance to a bacterial blight fungus (see, for example, WO 2006/42145, U.S. Pat. Nos. 5,952,485, 5,977,434, WO 1999/09151, WO 1996/22375); and tomato having resistance to Pseudomonas syringae (see, for example, Can. J. Plant Path., 1983, 5:251-255).

Examples of a plant having resistance to a viral pathogen include: stone fruits (e.g., plum, almond, apricot, cherry, peach, nectarine) having resistance to Plum pox virus (see, for example, US PP15154Ps, EP 0626449; potato having resistance to potato virus Y (see, for example, U.S. Pat. No. 5,968,828); a plant such as potato, tomato, cucumber and a Fabaceae plant having resistance to tomato spotted wilt virus (see, for example, EP 0626449, U.S. Pat. No. 5,973,135); corn having resistance to maize streak virus (see, for example, U.S. Pat. No. 6,040,496; papaya having resistance to papaya ring spot virus (see, for example, 55877403, U.S. Pat. No. 6,046,384); a Cucurbitaceae plant (e.g., cucumber, melon, watermelon and pumpkin) and a Solanaceae plant (e.g. potato, tobacco, tomato, eggplant, paprika, hot pepper and pepper) having resistance to cucumber mosaic virus (see, for example, U.S. Pat. No. 6,849,780); a Cucurbitaceae plant (e.g. cucumber, melon, watermelon and pumpkin) having resistance to watermelon mosaic virus 2 and zucchini yellow mosaic virus (see, for example, U.S. Pat. No. 6,015,942); potato having resistance to potato leafroll virus (see, for example, U.S. Pat. No. 5,576,202); potato having broad resistance to viruses such as potato virus X, potato virus Y and potato leafroll virus (see, for example, EP 0707069); and kidney bean having resistance to Bean golden mosaic virus (see, for example, Mol Plant Microbe Interact. 2007 June; 20(6):717-26.).

There are plants having resistance to antibiotics (e.g., kanamycin, neomycin and ampicillin). A naturally occurring bacterial nptII gene expresses an enzyme which blocks the actions of antibiotics kanamycin and neomycin. ampR (also known as blaTEM1), which is an ampicillin-resistant gene, is originated from a bacterium Salmonella paratyphi, and used as a marker gene in the transformation of microorganisms and plants. ampR is involved in the synthesis of β-lactamase, which is an enzyme that neutralizes antibiotics in the penicillin group including ampicillin. Examples of the plant having resistance to antibiotics include potato, tomato, lineseed, canola, rapeseed, Cruciferae seed and corn (see, for example, Plant Cell Reports, 20, 2001, 610-615, Trends in Plant Science, 11, 2006, 317-319, Plant Molecular Biology, 37, 1998, 287-296, Mol Gen Genet., 257, 1998, 606-13. Plant Cell Reports, 6, 1987, 333-336, Federal Register (USA), vol. 60, No. 113, 1995, p. 31139. Federal Register (USA), vol. 67, No. 226, 2002, p. 70392, Federal Register (USA), vol. 63, No. 88, 1998, p. 25194, Federal Register (USA), vol. 60, No. 141, 1995, p. 3787 0, Canadian Food Inspection Agency, FD/OFB-095-264-A, October 1999, FD/OFB-099-127-A, October 1999). The above-mentioned plant is preferably selected from soybean, tomatoes and grains (e.g., wheat, barley, rye and oat), and most preferably selected from soybean and grains (e.g., wheat, barley, rye and oat).

Examples of an available plant imparted with resistance to plant virus disease include: papaya “Rainbow”, “SunUp” and “Huanong No. 1” each imparted with resistance to Papaya ringspot virus; potato “Innate (registered trademark) Hibernate”, “Innate (registered trademark) Glaciate” and “Innate (registered trademark) Acclimate” having resistance to potato late blight fungus (Phytophthora infestans); and potato “Newleaf (trademark)” having resistance to potato virus Y and/or potato leafroll virus (PLRV).

Examples of a plant imparted with plant disease resistance by a conventional breeding technique or genome-based breeding technique include: rice imparted with resistance to a blast fungus (Magnaporthe oryzae); rice imparted with resistance to a sheath blight fungus (Rhizoctonia solani); wheat imparted with resistance to leaf rust (Puccinia triticina); wheat imparted with resistance to a stripe rust fungi (Puccinia striiformis f. sp. tritici); wheat imparted with resistance to a stem rust fungi (Puccinia graminis f. sp. tritici); wheat imparted with resistance to a powdery mildew fungus (Blumeria graminis f. sp. tritici); wheat imparted with resistance to a leaf blight fungus (Zymoseptoria tritici); wheat imparted with resistance to a glume blotch fungus (Stagonospora nodorum); wheat imparted with resistance to a yellow spot fungus (Pyrenophora tritic-repentis); barley imparted with resistance to a powdery mildew fungus (Blumeria graminis f. sp. hordei); barley imparted with resistance to a dwarf leaf rust fungus (Puccnia hordei); barley imparted with resistance to a net blotch fungus (Pyrenophora teres); barley imparted with resistance to a scald fungus (Rhynchosporium commune); barley imparted with resistance to a Ramularia disease fungus (Ramularia collo-cygni); corn imparted with resistance to anthracnose (Anthracnose stalk rot); corn imparted with resistance to gray leaf spot; corn imparted with resistance to Goss's wilt; corn imparted with resistance to Fusarium stalk rot; soybean imparted with resistance to Asian soybean rust; soybean imparted with resistance to soybean Phytophthora rot; soybean imparted with resistance to soybean sudden death syndrome; pepper imparted with resistance to Phytophthora; lettuce imparted with resistance to powdery mildew; tomato imparted with resistance to bacterial wilt; tomato imparted with resistance to geminivirus; lettuce imparted with resistance to downy mildew; Cruciferae plants such as rapeseed, cabbage, Brussels sprouts, cauliflower, collard green (borekale) and broccoli imparted with resistance to clubroot; Cruciferae plants such as rapeseed, cabbage, Brussels sprouts, cauliflower, collard green (borekale) and broccoli imparted with resistance to black leg; and melon imparted with resistance to melon fusarium wilt caused by Fusarium oxysporum f. sp. melonis (see, for example, WO 2009/000736).

Examples of a plant imparted with plant disease resistance by a genome editing technique include: bread wheat which exhibits resistance to powdery mildew by deleting a powdery mildew tolerance gene (MILDEW RESISTANCE LOCUS O, abbreviated as “MLO”, hereinafter) using TALEN and CRISPR/Cas9 (see, for example, Nat. Biotech., 32, 947-951 2014); slmlo1 tomato (Tomelo) which exhibits tolerance to powdery mildew by deleting a SlMLO1 gene, which is one of MLO, using CRISPR/Cas9 (see, for example, Scientific Reports 7, Article number: 482 2017); rice which exhibits tolerance to Xanthomonas oryzae pv. Oryzae causing rice bacterial leaf blight by editing an OsSWEET14 gene in the rice using TALEN (see, for example, Nat. Biotechnol. 30, 390-392 2012); rice which exhibits tolerance to Magnaporthe oryzae causing rice blast by modifying an OsERF922 gene in the rice using CRISPR/Cas9 (see PLoS ONE 11:e0154027. doi: 10.1371/journal.pone.0154027 2016); cucumber which exhibits tolerance to cucumber vein yellow ingvirus (CVYV), zucchini yellow mosaic virus (ZYMV) and papaya ringspot virus-type W (PRSV-W) by disrupting a recessive eIF4E (eukaryotic translation initiation factor 4E) gene using CRISPR/Cas9 (see Mol. Plant Pathol. 17, 7 1140-1153 2016); and soybean which exhibits tolerance to soybean Phytophthora rot caused by Phytophthora sojae by disrupting an RXLR effector gene (Avr4/6) using CRISPR/Cas9 (see Mol Plant Pathol 17(1)127-139 2016).

Examples of a plant imparted with plant disease resistance by a new breeding techniques include: apple which exhibits tolerance to apple scab into which an Rvi6 (formerly called “HcrVf2”) gene having tolerance to apple scab caused by Venturia inaequalis is introduced using cisgenesis (see, for example, Plant Biotech. J., 12, 2-9, 2014); and, as an example of imparting a trait of a GM rootstock to a scion, which is a breeding technique utilizing grafting, sweet cherry in which the trait is transferred into a non-transgenic scion from a transgenic rootstock having tolerance to infection with Prunus necrotic ringspot virus (see Plant Biotech. J., 12, 1319-1328 2014).

Hereinbelow, a plant in which the quality of a product is modified will be mentioned.

Quality modification of a product means synthesis of a modified component or increase or decrease in the amount of a component synthesized, compared with a corresponding wild-type plant. Examples of the plant in which the quality of a product is modified include vitamin, amino acid, protein and starch, a modified plant in which the contents of various oils are increased or decreased, and a modified plant in which the content of nicotine is decreased.

Examples of a plant in which the quality of a product is modified by a transgenic technique include: alfalfa in which the content of lignin is decreased by an RNA interference action by introducing a gene producing double-stranded RNA of an S-adenosyl-L-methionine:trans-caffeoyl-CoA 3-methyltransferase (ccomt) gene originated from alfalfa involved in production of lignin; canola “Laurical (trademark) Canola” in which the content of triacylglyceride including lauric acid is increased by introducing a 12:0 ACP thioesterase gene originated from bay leaf (Umbellularia californica) involved in synthesis of fatty acid; soybean “Plenish (trademark)” and “Treus (trademark)” in which the content of oleic acid is increased by introducing a partial gene (gm-fad2-1) of ω-6 desaturase originated from soybean, which is an unsaturated enzyme of fatty acid, thus inhibiting the expression of the gene; soybean “Vistive Gold (trademark)” in which the content of saturated fatty acid is decreased by introducing a gene producing double-stranded RNA of an acyl-acyl carrier protein thioesterase gene (fatb1-A) originated from soybean and a gene producing double-stranded RNA of a δ-12 desaturase gene (fad2-1A) originated from soybean; genetically modified soybean in which stearidonic acid, which is one of ω3 fatty acids, is produced by introducing a 5-6 desaturase gene (Pj.D6D) originated from primrose and a 6-12 desaturase gene (Nc.Fad3) originated from neurospora; corn “Enogen (registered trademark)” in which production of bioethanol is enhanced by introducing a heat-resistant α-amylase gene (amy797E) of Thermococcales sp. involved in amylolysis; corn “Mavera (trademark) Maize” and “Mavera (trademark) YieldGard (trademark) Maize” in which production of lysine is increased by introducing a dihydrodipicolinate synthase gene (cordapA) originated from Corynebacterium glutamicum involved in production of lysine, which is amino acid; potato “Amflora (trademark)” and “Starch Potato” in which the content of amylose is decreased and the content of amylopectin is increased in starch grains by introducing an antisense gene gbss of a starch synthase (granule-bound starch synthase enzyme, GBSS) originated from potato; potato “Innate (registered trademark) Cultivate”, “Innate (registered trademark) Generate”, “Innate (registered trademark) Accelerate”, “Innate (registered trademark) Invigorate”, “Innate (registered trademark) Glaciate”, “Innate (registered trademark) Acclimate” and “Innate (registered trademark) Hibernate” in which decomposition of starch is suppressed by introducing genes pPhL and pR1 producing double-stranded RNA of transcription factor genes PhL and R1 that promote amylolysis originated from potato, in which synthesis of asparagine is suppressed by introducing a gene asn1 producing double-stranded RNA of a gene Asn1 involved in production of asparagine (in order to suppress accumulation of asparagine and reducing sugar involved in production of acrylamide, which is a carcinogen by heating), and in which formation of black spot is suppressed by introducing a gene ppo5 producing double-stranded RNA of a polyphenol oxidase gene Ppo5 originated from potato; tobacco in which the content of nicotine is decreased by introducing an antisense gene (NtQPT1) of a quinolinic acid phosphoribosyltransferase gene QpTase originated from tobacco (Nicotiana tabacum); and golden rice which is rice in which, by introducing a phytoene synthase gene (psy) originated from daffodil (Narcissus pseudonarcissus) and a carotene desaturase gene (crt1) originated from a soil bacterium (Erwinia uredovora) synthesizing carotenoid to make endosperm-specific expression, leading to production of β-carotene in the endosperm tissue, thus making it possible to harvest a rice containing vitamin A. Other examples include: potato and corn in which the content of amylopectin is modified (see, for example, U.S. Pat. No. 6,784,338, US 2007/0261136, WO 1997/04471); canola, corn, cotton, grape, cattail, black-eyed pea (catalpa), rice, soybean, rapeseed, wheat, sunflower, bitter balsam apple, safflower and Vernonia plants in which the content of oil is modified (see, for example, U.S. Pat. Nos. 7,294,759, 7,157,621, 5,850,026, 6,441,278, 5,723,761, 6,380,462, 6,365,802, 6,974,898, WO 2001/079499, US 2006/0075515 and U.S. Pat. No. 7,294,759); sunflower in which the content of fatty acid is increased (see, for example, U.S. Pat. No. 6,084,164); soybean in which the content of allergen is decreased (see, for example, U.S. Pat. No. 6,864,362); tobacco in which the content of nicotine is decreased (see, for example, US 2006/0185684, WO 2005/000352 and WO 2007/064636); canola and soybean in which the content of lysine is increased (see, for example, Bio/Technology 13, 1995, 577-582); corn and soybean in which the composition of methionine, leucine, isoleucine and/or valine is modified (see, for example, U.S. Pat. Nos. 6,946,589, 6,905,877); soybean in which the content of sulfur amino acid is increased (see, for example, EP 0929685, WO 1997/041239); corn in which the content of methionine is increased by foliage-specifically expressing a 3′-phosphoadenosine-5′-phosphosulfate reductase originated from Escherichia coli (see PNAS, 2017, 114(43), 11386.); tomato in which the content of free amino acid (e.g. asparagine, aspartic acid, serine, threonine, alanine, histidine and glutamic acid) is increased (see, for example, U.S. Pat. No. 6,727,411); corn in which the content of amino acid is increased (see, for example, WO 05/077117); potato, corn and rice in which the content of starch is modified (see, for example, WO 1997/044471 and U.S. Pat. No. 7,317,146); tomato, corn, grape, alfalfa, apple, beans and pea in which the content of flavonoid is modified (see, for example, WO 00/04175); corn, rice, sorghum, cotton and soybean in which the content of a phenolic compound is modified (see, for example, US 2008/0235829); tomato and canola in which the content of vitamin A is increased (see, for example, U.S. Pat. Nos. 6,797,498, 7,348,167); tomato, canola, soybean, wheat, sunflower, rice, corn, barley and rye in which the content of vitamin E is increased (see, for example, U.S. Pat. No. 7,348,167, WO 2004/058934); and alfalfa, apple, bean, corn, grape, tomato and pea in which the content of flavonoid is modified (see, for example, WO 00/04175). A method for producing such plant is generally known by a person skilled in the art, and, for example, is mentioned in the above-mentioned publication. The plant is preferably selected from soybean, canola, tomatoes, rice and grains (e.g. wheat, barley, rye and oat), and most preferably selected from soybean, canola, rice, wheat and barley.

As a plant in which the quality of a product is modified by a conventional breeding technique or genome-based breeding technique, rapeseed “Nexera (registered trademark) Canola” which produces unsaturated ω-9 fatty acid; soybean “YUMEMINORI” in which the content of allergen is decreased; rice intended to make modification to good taste, e.g., rice “YUMEPIRIKA” in which the content of amylose is decreased, and the like are commercially available. Citrus in which properties of the fruit (e.g., weight of the fruit, amount of flavor, succulence and sugar content) are modified by genomic selection is known (see Scientific Reports 7, 4721 2017).

Examples of a plant in which the nutrient utilization of the plant is modified include a plant in which the assimilation or metabolism of nitrogen or phosphorus is enhanced. Examples of a plant having nitrogen assimilation capacity and nitrogen utilization capacity enhanced by a transgenic technique include canola, corn, wheat, sunflower, rice, tobacco, soybean, cotton, alfalfa, tomato, wheat, potato, sugar beet, sugar cane and rapeseed (see, for example, WO 1995/009911, WO 1997/030163, U.S. Pat. Nos. 6,084,153, 5,955,651 and 6,864,405). Examples of a plant in which the intake of phosphorus is improved by a transgenic technique include alfalfa, barley, canola, corn, cotton, tomato, rapeseed, rice, soybean, sugar beet, sugar cane, sunflower, wheat and potato (see, for example, U.S. Pat. No. 7,417,181, US 2005/0137386). A method for producing such plant is generally known by a person skilled in the art, and, for example, is mentioned in the above-mentioned publication. The plant is preferably selected from soybean, tomato and grains (e.g., wheat, barley, rye and oat), and most preferably selected from soybean, rice, corn and wheat.

Examples of a plant in which fertility trait, etc., is modified by a transgenic technique include a plant imparted with male sterility and fertility restoration trait. Examples thereof include: corn and chicory imparted with male sterility trait by expressing a ribonuclease gene (barnase) originated from a Bacillus bacterium (Bacillus amyloliquefaciens) in a tapetum cell of the anther; corn imparted with male sterility trait by introducing a DNA adenine methyltransferase gene (dam) originated from Escherichia coli; corn in which fertility trait is controlled by introducing an α-amylase gene (zm-aa1) originated from corn which imparts male sterility trait and an ms45 protein gene (ms45) originated from corn which imparts fertility restoration trait; canola imparted with fertility restoration function by expressing a ribonuclease-inhibiting protein gene (barstar) originated from a Bacillus bacterium in a tapetum cell of the anther; and canola in which fertility trait is controlled by expressing a ribonuclease gene (barnase) originated from a Bacillus bacterium which imparts male sterility trait and a ribonuclease-inhibiting protein gene (barstar) originated from a Bacillus bacterium which imparts fertility restoration trait. Examples of other plants imparted with fertility trait by a transgenic technique include tomato, rice, brown mustard, wheat, soybean and sunflower (see, for example, U.S. Pat. Nos. 6,720,481, 6,281,348, 5,659,124, 6,399,856, 7,345,222, 7,230,168, 6,072,102, EP1135982, WO 2001/092544 and WO 1996/040949). A method for producing such plant is generally known by a person skilled in the art, and, for example, is mentioned in the above-mentioned publication. The plant is preferably selected from corn, canola, soybean, tomatoes and grains (e.g. wheat), and most preferably selected from corn, canola, soybean, rice and wheat.

A plant imparted with non-biological stress tolerance is a plant which exhibits increased tolerance to a non-biological stress state such as drought, high salinity, high light intensity, high UV irradiation, chemical pollution (e.g., high heavy metal concentration), low temperature or high temperature, limited supply of nutrients (i.e., nitrogen, phosphorus) and population stress (see, for example, WO 2000/004173, WO 2007/131699, CA 2521729 and US 2008/0229448).

Examples of a plant imparted with non-biological stress tolerance by a transgenic technique include: rice, corn, soybean, sugar cane, alfalfa, wheat, tomato, potato, barley, rapeseed, bean, wild oat, sorghum and cotton having tolerance to drought (see, for example, WO 2005/048693, WO 2008/002480 and WO 2007/030001); corn, soybean, wheat, cotton, rice, rapeseed and alfalfa having tolerance to low temperature (see, for example, U.S. Pat. No. 4,731,499 and WO 2007/112122); and rice, cotton, potato, soybean, wheat, barley, rye, sorghum, alfalfa, grape, tomato, sunflower and tobacco having tolerance to high salinity (see, for example, U.S. Pat. Nos. 7,256,326, 7,034,139, WO 2001/030990). Corn “DroughtGard (registered trademark) “(a product manufactured by Monsanto Company) into which a cold shock protein gene cspB of Bacillus subtilis is introduced can also be mentioned.

As a plant imparted with non-biological stress tolerance by a conventional breeding technique or genome-based breeding technique, for example, corn having drought tolerance is developed by product names of “Agrisure Artesian (registered trademark)” and “Optimum (registered trademark) AQUAmax (registered trademark)”.

A plant imparted with other properties includes a plant in which a maturation property is modified. Examples of modification of a maturation property include delay of ripening, delay of softening and premature maturation. Examples of a plant in which a maturation property is modified by a transgenic technique include: melon and tomato in which the shelf life is improved by introducing an S-adenosylmethionine hydrolase gene (sam-K) originated from Escherichia coli bacteriophage T3 involved in production of ethylene of a plant hormone; tomato in which the shelf life is improved by introducing at least any one of a partially defective gene of an ACC synthase gene originated from tomato involved in production of ethylene of a plant hormone, an ACC deaminase gene originated from a Pseudomonas bacterium (Pseudomonas chlororaphis) that decomposes ACC, which is an ethylene precursor, a gene which produces double-stranded RNA of a polygalacturonase gene originated from tomato that decomposes pectin of cell wall, or an ACC oxidase gene originated from tomato involved in production of ethylene; and tomato “FLAVR SAVR (trademark)” in which the shelf life is improved by introducing a gene pg which produces double-stranded RNA of a polygalacturonase gene originated from tomato. Examples of other plants in which a maturation property is modified by a transgenic technique include tomato, melon, raspberry, strawberry, muskmelon, pepper and papaya in which ripening is delayed (see, for example, U.S. Pat. Nos. 5,767,376, 7,084,321, 6,107,548, 5,981,831, WO 1995/035387, U.S. Pat. Nos. 5,952,546, 5,512,466, WO 1997/001952, WO 1992/008798 and Plant Cell. 1989, 53-63. Plant Molecular Biology, 50, 2002). A method for producing such plant is generally known by a person skilled in the art, and, for example, is mentioned in the above-mentioned publication. The plant is preferably selected from fruits (e.g., tomato, liana, melon, papaya, banana, pepper, raspberry and strawberry); stone fruits (e.g., cherry, apricot and peach); pome fruits (e.g., apple and common pear); and citrus fruits (e.g., citron, lime, orange, shaddock, grapefruits and mandarin), more preferably selected from tomato, melon, papaya, liana, apple, banana, orange and strawberry, and most preferably tomato, melon and papaya.

Examples of a plant imparted with other quality modifications by a transgenic technique include: canola “Phytaseed (registered trademark) Canola” in which decomposition of endogenous phytic acid is enhanced by introducing a 3-phytase gene (phyA) originated from black mold (Aspergillus niger), which is a decomposition enzyme of phytic acid of a plant; carnation “Moondust (trademark)”, “Moonshadow (trademark)”, “Moonshade (trademark)”, “Moonlite (trademark)”, “Moonaqua (trademark)”, “Moonvista (trademark)”, “Moonique (trademark)”, “Moonpearl (trademark)”, “Moonberry (trademark)” and “Moonvelvet (trademark)” in which the flower color is controlled to blue by introducing a dihydroflavonol-4-reductase gene originated from petunia (Petunia hybrida), which is an enzyme producing delphinidin of a blue dye and a derivative thereof, and a flavonoid-3′,5′-hydroxylase gene originated from petunia, pansy (Viola wittrockiana), salvia (Salvia splendens) or carnation; rose in which the flower color is controlled to blue by introducing an anthocyanin-5-acyltransferase gene originated from torenia (Torenia sp.), which is an enzyme producing delphinidin of a blue dye and a derivative thereof, and a flavonoid-3,5′-hydroxylase gene originated from pansy; rice having an effect to alleviate pollinosis by an immune tolerance action by introducing an antigenic protein gene (7crp) of a modified Japanese cedar pollen; corn in which decomposition of endogenous phytic acid is enhanced by introducing a 3-phytase gene (phyA) originated from black mold; and cotton which produces a high-quality fiber in which micronaire of the fiber, increased intensity of the fiber, uniformity of length and color and the like are improved (see, for example, WO 1996/26639, U.S. Pat. Nos. 7,329,802, 6,472,588 and WO 2001/17333).

Examples of a plant in which a trait relating to the growth or yield of the plant is modified include a plant in which growth capacity is enhanced and the like. As a plant in which a trait relating to the growth or yield is modified by a transgenic technique, for example, the following plants are developed: soybean in which the growth of the plant is enhanced by introducing a gene (bbx32) encoding a transcription factor which controls daily periodicity originated from mouse-ear cress, resulting in probable high yield; and corn in which the ear weight is increased by introducing a transcription factor gene (athb17) belonging to class II (HD-Zip II) of the homeodomain-leucine 14 zipper (HD-Zip) family originated from mouse-ear cress, resulting in probable high yield.

Examples of a plant in which the quality is modified by a genome editing technique include: corn “ZFN-12 maize” in which the content of phytic acid is reduced by deleting an IPK1 gene encoding an inositol-1,3,4,5,6-pentakisphosphate 2-kinase, which is an enzyme for biosynthesis of phytic acid, using zinc finger nuclease; and mushroom imparted with tolerance to browning by deleting a gene encoding polyphenol oxidase using CRISPR/Cas9 (see, for example, Nature., Vol 532, 21 Apr. 2016).

Examples of a plant in which the quality is modified by a new breeding techniques include: apple “Arctic (registered trademark)” in which the expression level of polyphenol oxidase is reduced and browning does not occur by introducing a low polyphenole oxidase-(an enzyme causing browning) producing gene sequence GEN-03 isolated from apple into a new apple variety, using cisgenesis; and, as an example of imparting a trait of a GM rootstock to a scion, which is a breeding technique utilizing grafting, tomato in which salt tolerance is imparted to tomato of a non-transgenic scion using a tomato rootstock having salt tolerance (see Physiol Plantarum, 124, 465-475 2005).

With respect to rice, many genes having resistance to plant disease, pest and non-biological stress are known, and resistant varieties into which they are introduced are actively produced. As a gene having resistance to plant disease and non-biological stress in rice, for example, the following genes are known: brown planthopper-resistant genes such as BPH1, BPH2, BPH3, BPH4, BPH5, BPH6, BPH7, BPH8, BPH9, BPH10, BPH11, BPH12, BPH13, BPH14, BPH15, BPH17, BPH18, BPH19, BPH20, BPH21, BPH22, BPH23, BPH24, BPH25, BPH26, BPH27, BPH28, BPH29, BPH32, gBPH-12, qBPHR-1, gBPHR-3, qBPHR-8, gBPHR-5-1gBPHR-5-2gBPHR-11-1 and gBPHR-11-2; white-backed planthopper-resistant genes such as WBPH1, WBPH2, WBPH3, WBPH4, WBPH5, WBPH6, OVC, qOVA-5-2, gOVA1-3 and gOVA5-1; small brown planthopper-resistant genes such as Qsbph2b, Qsbph3, Qsbph3b, Qsbph3c, Qsbph3d, Qsbph4, Qsbph8, Qsbph11, Qsbph11d, Qsbph11e, Qsbph11f, Qsbph11g and Qsbph12a; leafhopper-resistant genes such as GLH, GLH1, GLH3, GLH4, GLH5, GLH6, GLH7, GLH8, GLH9, GLH10, GLH11, GLH12, GLH13, GRH1, GRH2, GRH3, GRH4, GRH5, Zlh1, Zlh2, Zlh3, gGRH-4, qGRH-2, qGRH-5, qGRH-6, qGRH-11 and qGRH-3; an Asiatic rice borer-resistant gene such as SB; blast-resistant genes such as Pii, PI65, PIZT, PI24, PI29, PI25, Pi-jnw1, PB1, PIQ6, PID3, PI67, PITQ5, PITP, PITQ6, PLM2, PISE3, IPI, PISE1, PI157, PIQ4, PI21, PIA, PIB, PIK, PIKUR1, PIKUR2, PI3, PIF, PIZH, PIR4, PIR7, PI30, PI, PIGD2, PIG, PIGD3, PIGD1, PIZ, PI, PI18, PIM, PI17, PI20, PI1, PI19, PI5, PISH, PI10, PI9, PI21, PI22, PI44, PI22, PI13, PII, PIB1, PIQ1, PIQ2, PIQ3, PIIS1, PII2, PI62, PI12, IPI3, PI14, PI15, PI16, PIT, PI11, PI6, PI23, PI14, PI11, PIIS2, PIB2, PI12, PI39, PI40, PITA, PIR2-3, PIR9-2, PIR12-2, PIRF2-1, qRBR-2, qRBR-3, PI27, PI28, PI26, PIGM, PI47, PI48, PI7, PI56, PI49, PI34, PIKG, PI38, PI32, PI31, PI46, PIX, PIXY, Pita3, PI41, PI42, PI2, PI36, PI37, PIKH, PIKM, PIKP, PI35, PIZ5, PIB2, PI43, PI50, PI51, PID1, PIY1, PIY2, PI55-2, PICO39, PI55-1, PIBH8, PIR7A, PIR7B, PID2, PI33, qBFR4-1, qBFR4-2, qRBR-2, qRBR-3, qRBR-8, qRBR-1-1, qRBR-1-3, qRBR-7-1, qRBR-7-2, qRBR-9-1, qRBR-9-2, qRBR-9-3, qRBR-1-2 and qRBR-1-4; stripe-resistant genes such as STVA, STVB and Stvb-i; bacterial leaf blight-resistant genes such as XA21D, XA, XA40, XA NM, XA8, XA33, XA34, XA35, XA36, XA37, XA7, XA3, XA25, XA28, XA29, XA30, XA31, XA32, XA38, XA39, XA11, XA16, XA17, XA18, XA19, XA20, XA14, XA2, XA12, XA1, XA K, XA A, XA H, XA10, XA23, XA22, XA24, XA21, SERRT13, XA4, XA5 and XA13; sheath blight-resistant genes such as qSB-2, qSB-3, qSB-7, qSB-11 and qSB-9-1; a sesame leaf blight-resistant gene such as CE; a yellow dwarf-resistant gene such as YDV; a black-streaked dwarf-resistant gene such as BSV; a high-temperature ripening-tolerant genes such as Amy1A, Amy1C, Amy3A and Amy3B; low-amylose genes such as dul3, gAC9.3, rsr1, Wx and Wx1-1; lodging-resistant genes such as AP01, SCM2 and Sd1; a sprouting-tolerant gene such as Sdr4; low-temperature-tolerant genes such as CTB1, CTB2 and qLTG3-1; a drought-tolerant gene such as Dro1; genes involved in paddy numbers or seed shape such as DEP1, Cn1a, GPS, SPIKE, PTB1, TAWAWA1, WFP, IPA1, GS3, GS5, GS6, GL3.1, GW2, GW8, qGL3, qSS7 and qSW5; genes which regulate day-length response such as Hd1, Ghd8 and DTH8; floury endosperm genes such as FLO4 and PDIL1; a lipoxygenase deletion (reducing old rice smell) gene such as LOX3; a gene involved in amylopectin chain length such as Alk, and the like. Rice varieties into which one or a plurality of these genes is/are simultaneously incorporated are developed or commercially available.

The plants of the varieties mentioned above also include a line imparted with two or more of tolerance to non-biological stress, plant disease resistance, tolerance to herbicides, pest resistance, growth or yield trait, modification of nutrient utilization, quality modification of a product, fertility trait and the like as previously mentioned, using a transgenic technique, a conventional breeding technique, a genome-based breeding technique, a new breeding technique or genome editing technique or the like, and a plant imparted with two or more properties of a parental line by crossing plants of the same kind or having different properties.

Examples of a commercially available plant imparted with tolerance to two or more herbicides include: cotton “GlyTol (trademark) LibertyLink (trademark)” and “GlyTol (trademark) LibertyLink (trademark)” each having tolerance to glyphosate and glufosinate; corn “Roundup Ready (trademark) LibertyLink (trademark) Maize” having tolerance to glyphosate and tolerance to glufosinate; soybean “Enlist (trademark) Soybean” having tolerance to glufosinate and tolerance to 2,4-D; soybean “Genuity (registered trademark) Roundup Ready (trademark) 2 Xtend (trademark)” having tolerance to glyphosate and tolerance to dicamba; corn and soybean “Optimum GAT (trademark)” having tolerance to glyphosate and tolerance to an ALS inhibitor; genetically modified soybean “Enlist E3 (trademark)” and “Enlist (trademark) Roundup Ready 2 Yield (registered trademark)” each having tolerance to three herbicides of glyphosate, glufosinate and 2,4-D; corn “Enlist (trademark) Roundup Ready (registered trademark) Corn 2” having tolerance to glyphosate, 2,4-D and aryloxyphenoxypropionate-type (FOPs) herbicides; corn “Enlist (trademark) Roundup Ready (registered trademark) Corn 2” having tolerance to glyphosate, 2,4-D and aryloxyphenoxypropionate-type (FOPs) herbicides; cotton “Bollgard II (registered trademark) XtendFlex (trademark) Cotton” having tolerance to dicamba, glyphosate and glufosinate; cotton “Enlist (trademark) Cotton” having tolerance to three herbicides of glyphosate, glufosinate and 2,4-D; soybean “Liberty Link (registered trademark) GT27 (trademark)” having tolerance to three herbicides of glyphosate, glufosinate and an HPPD herbicide (e.g., isoxaflutole). In addition, the following plants are also developed: cotton having tolerance to both glufosinate and 2,4-D; cotton having tolerance to both glufosinate and dicamba; corn having tolerance to both glyphosate and 2,4-D; soybean having tolerance to both glyphosate and an HPPD herbicide; and corn having tolerance to glyphosate, glufosinate, 2,4-D, aryloxyphenoxypropionate-type (FOPs) herbicides and cyclohexadione-type (DIMs) herbicides.

Examples of a commercially available plant imparted with tolerance to herbicides and pest resistance include: corn “YieldGard Roundup Ready (trademark)” and “YieldGard Roundup Ready 2 (trademark)” each having tolerance to glyphosate and resistance to corn borer; corn “Agrisure CB/LL (trademark)” having tolerance to glufosinate and resistance to corn borer; corn “Yield Gard VT Root worm/RR2 (trademark)” having tolerance to glyphosate and resistance to corn rootworm; corn “Yield Gard VT Triple (trademark)” having tolerance to glyphosate and resistance to corn rootworm and corn borer; corn “Herculex I (trademark)” having tolerance to glufosinate and resistance to a lepidopteran pest (Cry1F) (e.g., resistance to western bean cutworm, corn borer, black cutworm and fall armyworm); corn “YieldGard Corn Rootworm/Roundup Ready 2 (trademark)” having tolerance to glyphosate and resistance to corn rootworm; corn “Agrisure GT/RW (trademark)” having tolerance to glufosinate and resistance to a coleopteran pest for corn (Cry3A) (e.g., resistance to Western corn rootworm, Northern corn rootworm and Mexican corn rootworm); corn “Herculex RW (trademark)” having tolerance to glufosinate and resistance to a coleopteran pest (Cry34/35Ab1) (e.g., resistance to Western corn rootworm, Northern corn rootworm and Mexican corn rootworm); corn “Yield Gard VT Root worm/RR2 (trademark)” having tolerance to glyphosate and resistance to corn rootworm; and cotton “Bollgard (registered trademark) 3 XtendFlex (registered trademark)” having tolerance to dicamba, tolerance to glyphosate, tolerance to glufosinate and resistance to a lepidopteran pest (e.g., resistance to ballworms and tobacco budworm, armyworms and the like).

Examples of a commercially available plant imparted with plant disease resistance and pest resistance include: potato “Hi-Lite NewLeaf (trademark) Y Potato”, “NewLeaf (trademark) Y Russet Burbank Potato” and “Shepody NewLeaf (trademark) Y Potato” each imparted with resistance to potato virus Y and pest resistance; and potato “NewLeaf (trademark) Plus Russet Burbank Potato” imparted with resistance to potato leafroll virus and pest resistance.

Examples of a commercially available plant imparted with tolerance to herbicides and a property of quality modification of a product include: canola “InVigor (trademark) Canola” imparted with tolerance to glufosinate and fertility trait; corn “InVigor (trademark) Maize” imparted with tolerance to glufosinate and fertility trait; and soybean “Vistive Gold (trademark)” imparted with tolerance to glyphosate and in which the content of oil is modified.

Examples of a commercially available plant having three or more properties (traits) include: corn “Herculex I/Roundup Ready 2 (trademark)” having tolerance to glyphosate, tolerance to glufosinate and resistance to a lepidopteran pest (Cry1F) (i.e., resistance to western bean cutworm, corn borer, black cutworm and fall armyworm); corn “YieldGard Plus/Roundup Ready 2 (trademark)” having tolerance to glyphosate, resistance to corn rootworm and resistance to corn borer; corn “Agrisure GT/CB/LL (trademark)” having tolerance to glyphosate, tolerance to glufosinate and resistance to corn borer; corn “Herculex Xtra (trademark)” having tolerance to glufosinate, resistance to a lepidopteran pest (Cry1F) and resistance to a coleopteran pest (Cry34/35Ab1) (i.e., resistance to lepidopteran pests such as western bean cutworm, corn borer, black cutworm and fall armyworm and coleopteran pests such as Western corn rootworm, Northern corn rootworm and Mexican corn rootworm); corn “Agrisure CB/LL/RW (trademark)” having tolerance to glufosinate, resistance to corn borer (Cry1Ab) and resistance to a coleopteran pest (Cry3A) (i.e., resistance to Western corn rootworm, Northern corn rootworm and Mexican corn rootworm); corn “Agrisure (trademark) 3000GT” having tolerance to glyphosate, resistance to corn borer (Cry1Ab) and resistance to a coleopteran pest (Cry3A) (i.e., resistance to Western corn rootworm, Northern corn rootworm and Mexican corn rootworm); corn “Mavera high-value corn (trademark)” having tolerance to glyphosate, resistance to corn rootworm and European corn borer and high lysine trait; corn “Optimum (registered trademark) Leptra (trademark)” having resistance to a pest which harms an above ground part of a plant such as European corn borer, Southwestern corn borer, corn earworm, fall armyworm, black cutworm and/or Western beanworm; soybean “Credenz (registered trademark) soybean” having tolerance to glyphosate, tolerance to glufosinate, resistance to soybean frogeye leaf spot, resistance to soybean sudden death syndrome, resistance to soybean southern stem canker, resistance to soybean Phytophthora root rot, resistance to sweet potato southern root-knot nematode, resistance to soybean Sclerotinia white mold, resistance to soybean brown stem rot and resistance to soybean cyst nematode, and in which iron chlorosis is improved, and chloride sensitivity is modified; and cotton “Stoneville (registered trademark) Cotton” imparted with a plurality of tolerances to herbicides and pest resistances (in order to cope with the state of occurrence of weeds and pests in a field of each region, nine varieties of ST5517GLTP, ST4848GLT, ST4949GLT, ST5020GLT, ST5115GLT, ST6182GLT, ST4747GLB2, ST4946GLB2 and ST6448GLB2 exist).

Plants which are commercially available or developed are listed below (A1 to A550). The words inside the parentheses mean the following: [plant name, event name, event code, tradename]. NA means “no information” or “unavailable information”. Most of these plants are listed in the genetically modified crop registration database (GM APPROVAL DATABASE) in the electronic information site (http://www.isaaa.org/) of the INTERNATIONAL SERVICE for the ACQUISITION of AGRI-BIOTECH APPLICATIONS (ISAAA).

A1: [alfalfa, J101, MON-00101-8, Roundup Ready (trademark) Alfalfa], A2: [alfalfa, J101×J163, MON-00101-8×MON-00163-7, Roundup Ready (trademark) Alfalfa], A3: [alfalfa, J163, MON-00163-7, Roundup Ready (trademark) Alfalfa], A4: [alfalfa, KK179, MON-00179-5, HarvXtra (trademark)], A5: [alfalfa, KK179×J101, MON-00179-5×MON-00101-8], A6: [apple, GD743, OKA-NB001-8, Arctic (trademark) “Golden Delicious” Apple], A7: [apple, GS784, OKA-NB002-9, Arctic (trademark)], A8: [apple, NF872, OKA-NB003-1, Arctic (trademark) Fuji Apple], A9: [Argentina canola, 23-18-17 (Event 18), CGN-89111-8, Laurical (trademark) Canola], A10: [Argentina canola, 23-198 (Event 23), CGN-89465-2, Laurical (trademark) Canola], A11: [Argentina canola, 61061, DP-061061-7], A12: [Argentina canola, 73496, DP-073496-4, Optimum (registered trademark) Gly canola], A13: [Argentina canola, 73496×RF3, DP-073496-4×ACS-BN003-6, NA], A14: [Argentina canola, GT200 (RT200), MON-89249-2, Roundup Ready (trademark) Canola], A15: [Argentina canola, GT73 (RT73), MON-00073-7, Roundup Ready (trademark) Canola], A16: [Argentina canola, HCN10 (Topas 19/2), NA, Liberty Link (trademark) Independence (trademark)], A17: [Argentina canola, HCN28 (T45), ACS-BN008-2, InVigor (trademark) Canola], A18: [Argentina canola, HCN28×MON88302, ACS-BN008-2×MON-88302-9, InVigor (trademark)×TruFle×(trademark) Roundup Ready (trademark) Canola], A19: [Argentina canola, HCN92 (Topas 19/2), ACS-BN007-1, Liberty Link (trademark) Innovator (trademark)], A20: [Argentina canola, HCN92×MON88302, ACS-BN007-1×MON-88302-9, Liberty Link (trademark) Innovator (trademark)×TruFle×(trademark) Roundup Ready (trademark) Canola], A21: [Argentina canola, MON88302, MON-88302-9, TruFle×(trademark) Roundup Ready (trademark) Canola], A22: [Argentina canola, MON88302×MS8×RF3, MON-88302-9×ACS-BN005-8×ACS-BN003-6, InVigor (trademark)×TruFle×(trademark) Roundup Ready (trademark) Canola], A23: [Argentina canola, MON88302×RF3, MON-88302-9×ACS-BN003-6, NA], A24: [Argentina canola, MPS961, NA, Phytaseed (trademark) Canola], A25: [Argentina canola, MPS962, NA, Phytaseed (trademark) Canola], A26: [Argentina canola, MPS963, NA, Phytaseed (trademark) Canola], A27: [Argentina canola, MPS964, NA, Phytaseed (trademark) Canola], A28: [Argentina canola, MPS965, NA, Phytaseed (trademark) Canola], A29: [Argentina canola, MS1 (B91-4), ACS-BN004-7, InVigor (trademark) Canola], A30: [Argentina canola, MS1×MON88302, ACS-BN004-7×MON-88302-9, InVigor (trademark)×TruFle×(trademark) Roundup Ready (trademark) Canola], A31: [Argentina canola, MS1×RF1 (PGS1), ACS-BN004-7×ACS-BN001-4, InVigor (trademark) Canola], A32: [Argentina canola, MS1×RF1 (PGS2), ACS-BN004-7×ACS-BN002-5, InVigor (trademark) Canola], A33: [Argentina canola, MS1×RF3, ACS-BN004-7×ACS-BN003-6, InVigor (trademark) Canola], A34: [Argentina canola, MS8, ACS-BN005-8, InVigor (trademark) Canola], A35: [Argentina canola, MS8×MON88302, ACS-BN005-8×MON-88302-9, InVigor (trademark)×TruFle×(trademark) Roundup Ready (trademark) Canola], A36: [Argentina canola, MS8×RF3, ACS-BN005-8×ACS-BN003-6, InVigor (trademark) Canola], A37: [Argentina canola, MS8×RF3×GT73 (RT73), ACS-BN005-8×ACS-BN003-6×MON-00073-7, NA], A38: [Argentina canola, OXY-235, ACS-BN011-5, Navigator (trademark) Canola], A39: [Argentina canola, PHY14, NA, NA], A40: [Argentina canola, PHY23, NA, NA], A41: [Argentina canola, PHY35, NA, NA], A42: [Argentina canola, PHY36, NA, NA], A43: [Argentina canola, RF1 (B93-101), ACS-BN001-4, InVigor (trademark) Canola], A44: [Argentina canola, RF1×MON88302, CS-BN001-4×MON-88302-9, InVigor (trademark)×TruFle×(trademark) Roundup Ready (trademark) Canola], A45: [Argentina canola, RF2 (B94-2), ACS-BN002-5, InVigor (trademark) Canola], A46: [Argentina canola, RF2×MON88302, ACS-BN002-5×MON-88302-9, InVigor (trademark)×TruFle×(trademark) Roundup Ready (trademark) Canola], A47: [Argentina canola, RF3, ACS-BN003-6, InVigor (trademark) Canola], A48: [bean, EMBRAPA5.1, EMB-PV051-1, NA], A49: [carnation, 11(7442), FLO-07442-4, Moondust (trademark)], A50: [carnation, 11363(1363A), FLO-11363-1, Moonshadow (trademark)], A51: [carnation, 1226A(11226), FLO-11226-8, Moonshade (trademark)], A52: [carnation, 123.2.2(40619), FLO-40619-7, Moonshade (trademark)], A53: [carnation, 123.2.38(40644), FLO-40644-4, Moonlite (trademark)], A54: [carnation, 123.8.12, FLO-40689-6, Moonaqua (trademark)], A55: [carnation, 123.8.8(40685), FLO-40685-1, Moonvista (trademark)], A56: [carnation, 1351A(11351), FLO-11351-7, Moonshade (trademark)], A57: [carnation, 1400A(11400), FLO-11400-2, Moonshade (trademark)], A58: [carnation, 15, FLO-00015-2, Moondust (trademark)], A59: [carnation, 16, FLO-00016-3, Moondust (trademark)], A60: [carnation, 19907, IFD-19907-9, Moonique (trademark)], A61: [carnation, 25947, IFD-25947-1, Moonpearl (trademark)], A62: [carnation, 25958, IFD-25958-3, Moonberry (trademark)], A63: [carnation, 26407, IFD-26407-2, Moonvelvet (trademark)], A64: [carnation, 4, FLO-00004-9, Moondust (trademark)], A65: [carnation, 66, FLO-00066-8, NA]A66: [carnation, 959A(11959), FLO-11959-3, Moonshade (trademark)], A67: [carnation, 988A(11988), FLO-11988-7, Moonshade (trademark)], A68: [chicory, RM3-3, NA, SeedLink (trademark)], A69: [chicory, RM3-4, NA, SeedLink (trademark)], A70: [chicory, RM3-6, NA, SeedLink (trademark)], A71: [cotton, 19-51a, DD-01951A-7, NA], A72: [cotton, 281-24-236, DAS-24236-5, NA], A73: [cotton, 281-24-236×3006-210-23(M×B-13), DAS-24236-5×DAS-21023-5, WideStrike (trademark) Cotton], A74: [cotton, 281-24-236×3006-210-23×COT102×81910, DAS-24236-5×DAS-21023-5×SYN-IR102-7×DAS-81910-7, NA], A75: [cotton, 3006-210-23, DAS-21023-5, NA], A76: [cotton, 3006-210-23×281-24-236×MON1445, DAS-21023-5×DAS-24236-5×MON-01445-2, WideStrike (trademark) Roundup Ready (trademark) Cotton], A77: [cotton, 3006-210-23×281-24-236×MON88913, DAS-21023-5×DAS-24236-5×NAMON-88913-8, Widestrike (trademark) Roundup Ready Flex (trademark) Cotton], A78: [cotton, 3006-210-23×281-24-236×MON88913×COT102, DAS-21023-5×DAS-24236-5×MON-88913-8×SYN-IR102-7, Widestrike (trademark) Roundup Ready Flex (trademark) Cotton], A79: [cotton, 31707, NA, BXN (trademark) PlusBollgard (trademark) Cotton], A80: [cotton, 31803, NA, BXN (trademark) PlusBollgard (trademark) Cotton], A81: [cotton, 31807×31808, NA, NA], A82: [cotton, 31807, NA, BXN (trademark) PlusBollgard (trademark) Cotton], A83: [cotton, 31808, NA, BXN (trademark) PlusBollgard (trademark) Cotton], A84: [cotton, 42317, NA, BXN (trademark) PlusBollgard (trademark) Cotton], A85: [cotton, 81910, DAS-81910-7, NA], A86: [cotton, BNLA-601, NA, NA], A87: [cotton, BXN10211(10211), BXN-10211-9, NA], A88: [cotton, BXN10215(10215), BXN-10215-4NA, BXN (trademark) Cotton], A89: [cotton, BXN102cotton22(10222), BXN-10222-2, BXN (trademark) Cotton], A90: [cotton, BXN10224(10224), BXN-10224-4NA, BXN (trademark) Cotton], A91: [cotton, COT102(IR102), SYN-IR102-7, VIPCOT (trademark) Cotton], A92: [cotton, COT102×COT67B, SYN-IR102-7NA×NASYN-IR67B-1, VIPCOT (trademark) Cotton], A93: [cotton, COT102×COT67B×MON88913, SYN-IR102-7NA×NASYN-IR67B-1NA×NAMON-88913-8, VIPCOT (trademark) Roundup Ready Flex (trademark) Cotton], A94: [cotton, COT102×MON15985, SYN-IR102-7NA×NAMON-15985-7, Bollgard (registered trademark) III], A95: [cotton, COT102×MON15985×MON88913, SYN-IR102-7NA×NAMON-15985-7NA×NAMON-88913-8, Bollgard (registered trademark) III×Roundup Ready (trademark) Fle×(trademark)], A96: [cotton, COT102×MON15985×MON88913×MON88701, SYN-IR102-7NA×NAMON-15985-7NA×NAMON-88913-8NA×NAMONNA88701-3, NA], A97: [cotton, COT67B (IR67B), SYN-IR67B-1, NA], A98: [cotton, Event1, NA, JK1], A99: [cotton, GFMCry1A, GTL-GFM311-7, NA], A100: [cotton, GHB119, BCS-GH005-8, NA], A101: [cotton, GHB614, BCS-GH002-5, GlyTol (trademark)], A102: [cotton, GHB614×LLCotton25, BCS-GH002-5NA×NAACS-GH001-3, GlyTol (trademark) LibertyLink (trademark)], A103: [cotton, GHB614×LLCotton25×MON15985, BCS-GH002-5NA×NAACS-GH001-3NA×NAMON-15985-7, NA], A104: [cotton, GHB614×MON15985, BCS-GH002-5NA×NAMON-15985, NA], A105: [cotton, GHB614×T304-40×GHB119, BCS-GH002-5NA×NABCS-GH004-7NA×NABCS-GH005-8, Glytol (trademark)×Twinlink (trademark)], A106: [cotton, GHB614×T304-40×GHB119×COT102, BCS-GH002-5NA×NABCS-GH004-7NA×NABCS-GH005-8NA×NASYN-IR102-7, Glytol (trademark)×Twinlink (trademark)×VIPCOT (trademark) Cotton], A107: [cotton, GK12, NA, NA], A108: [cotton, LLCotton25, ACS-GH001-3NA, Fiberma×(trademark) LibertyLink (trademark)], A109: [cotton, LLCotton25×MON15985, ACS-GH001-3NA×NAMON-15985-7, Fiberma×(trademark) LibertyLink (trademark) BollgardII (trademark)], A110: [cotton, MLS9124, NA, NA], A111: [cotton, MON1076, MON-89924-2, Bollgard (trademark) Cotton], A112: [cotton, MON1445, MON-01445-2, Roundup Ready (trademark) Cotton], A113: [cotton, MON15985, MON-15985-7, BollgardII (trademark) Cotton], A114: [cotton, MON15985×MON1445, MON-15985-7NA×NAMON-01445-2, Roundup Ready (trademark) BollgardII (trademark) Cotton], A115: [cotton, MON1698, MON-89383-1, Roundup Ready (trademark) Cotton], A116: [cotton, MON531, MON-00531-6, Bollgard (trademark) Cotton, Ingard (trademark)], A117: [cotton, MON531×MON1445, MON-0531-6NA×NAMON-01445-2, Roundup Ready (trademark) Bollgard (trademark) Cotton], A118: [cotton, MON757, MON-00757-7, Bollgard (trademark) Cotton], A119: [cotton, MON88701, MONNA88701-3, NA], A120: [cotton, MON88701×MON88913, MONNA88701-3NA×NAMON-88913-8, NA], A121: [cotton, MON88701×MON88913×MON15985, MONNA88701-3NA×NAMON-88913-8NA×NAMON-15985-7, Bollgard II (registered trademark) XtendFlex (trademark) Cotton], A122: [cotton, MON88913, MON-88913-8, Roundup Ready (trademark) Flex (trademark) Cotton], A123: [cotton, MON88913×MON15985, MON-88913-8NA×NAMON-15985-7, Roundup Ready (trademark) Flex (trademark) BollgardII (trademark) Cotton], A124: [cotton, NgweChi6Bt, NA, NgweChi6Bt], A125: [cotton, SGK321, NA, NA], A126: [cotton, T303-3, BCS-GH003-6, NA], A127: [cotton, T304-40, BCS-GH004-7, NA], A128: [cotton, T304-40×GHB119, BCS-GH004-7NA×NABCS-GH005-8, TwinLink (trademark) Cotton], A129: [creeping bentgrass, ASR368, SMG-36800-2, NA], A130: [eggplant, BtBrinjalEventEE1, BtBrinjalEventEE1, BARIBtBegun-1,-2,-3 and -4], A131: [Eucalyptus, H421, H421, GMEucalyptus], A132: [lineseed, FP967(CDCTriffid), CDC-FL001-2, CDCTriffidFlax], A133: [lentil, RH44, RH44, Clearfield (registered trademark) lentil], A134: [corn, 32138, DP-32138-132138, 2138SPTmaintainer], A135: [corn, 3272, SYN-E3272-5, Enogen (trademark)], A136: [corn, 3272×Bt11, SYN-E3272-5×SYN-BT011-1, NA], A137: [corn, 3272×Bt11×GA21, SYN-E3272-5×SYN-BT011-1×MON-00021-9, NA], A138: [corn, 3272×Bt11×MIR604, SYN-E3272-5×SYN-BT011-1×SYN-IR604-5, NA], A139: [corn, 3272×BT11×MIR604×GA21, SYN-E3272-5×SYN-BT011-1×SYN-IR604-5×MON-00021-9, NA], A140: [corn, 3272×Bt11×MIR604×TC1507×5307×GA21, SYN-E3272-5×SYN-BT011-1×SYN-IR604-5×DAS-01507-1×SYN-05307-1×MON-00021-9, NA], A141: [corn, 3272×GA21, SYN-E3272-5×MON-00021-9, NA], A142: [corn, 3272×MIR604, SYN-E3272-5×SYN-IR604-5, NA], A143: [corn, 3272×MIR604×GA21, SYN-E3272-5×SYN-IR604-5×MON-00021-9, NA], A144: [corn, 33121, DP-033121-3, NA], A145: [corn, 4114, DP-004114-3, NA], A146: [corn, 5307, SYN-05307-1, Agrisure (registered trademark) Duracade (trademark)], A147: [corn, 5307×GA21, SYN-05307-1×MON-00021-9, NA], A148: [corn, 5307×MIR604×Bt11×TC1507×GA21, SYN-05307-1×SYN-IR604-5×SYN-BT011-1×DAS-01507-1×MON-00021-9, Agrisure (registered trademark) Duracade (trademark) 5122], A149: [corn, 5307×MIR604×Bt11×TC1507×GA21×MIR162, SYN-05307-1×SYN-IR604-5×SYN-BT011-1×DAS-01507-1×MON-00021-9×SYN-IR162-4, Agrisure (registered trademark) Duracade (trademark) 5222], A150: [corn, 59122, DAS-59122-7, Hercule×(trademark) RW], A151: [corn, 59122×DAS40278, DAS-59122-7×DAS-40278-9, NA], A152: [corn, 59122×GA21, DAS-59122-7×MON-00021-9, NA], A153: [corn, 59122×MIR604, DAS-59122-7×SYN-IR604-5, NA], A154: [corn, 59122×MIR604×GA21, DAS-59122-7×SYN-IR604-5×MON-00021-9, NA], A155: [corn, 59122×MIR604×TC1507, DAS-59122-7×SYN-IR604-5×DAS-01507-1, NA], A156: [corn, 59122×MIR604×TC1507×GA21, DAS-59122-7×SYN-IR604-5×DAS-01507-1×MON-00021-9, NA], A157: [corn, 59122×MON810, DAS-59122-7×MON-00810-6, NA], A158: [corn, 59122×MON810×MIR604, DAS-59122-7×MON-00810-6×SYN-IR604-5, NA], A159: [corn, 59122×MON810×NK603, DAS-59122-7×MON-00810-6×MON-00603-6, NA], A160: [corn, 59122×MON810×NK603×MIR604, DAS-59122-7×MON-00810-6×MON-00603-6×SYN-IR604-5, NA], A161: [corn, 59122×MON88017, DAS-59122-7×MON-88017-3, NA], A162: [corn, 59122×MON88017×DAS40278, DAS-59122-7×MON-88017-3×DAS-40278-9, NA], A163: [corn, 59122×NK603, DAS-59122-7×MON-00603-6, Herculex (trademark) RWRoundup Ready (trademark) 2], A164: [corn, 59122×NK603×MIR604, DAS-59122-7×MON-00603-6×SYN-IR604-5, NA], A165: [corn, 59122×TC1507×GA21, DAS-59122-7×DAS-01507-1×MON-00021-9, NA], A166: [corn, 676, PH-000676-7, NA], A167: [corn, 678, PH-000678-9, NA], A168: [corn, 680, PH-000680-2, NA], A169: [corn, 98140, DP-098140-6, Optimum GAT (trademark)], A170: [corn, 98140×59122, DP-098140-6×DAS-59122-7, NA], A171: [corn, 98140×TC1507, DP-098140-6×DAS-01507-1, NA], A172: [corn, 98140×TC1507×59122, DP-098140-6×DAS-01507-1×DAS-59122-7, NA], A173: [corn, Bt10, NA, Bt10], A174: [corn, Bt11(×4334CBR, X 4734CBR), SYN-BT011-1, Agrisure (trademark) CB/LL], A175: [corn, Bt11×5307, SYN-BT011-1×SYN-05307-1, NA], A176: [corn, Bt11×5307×GA21, SYN-BT011-1×SYN-05307-1×MON-00021-9, NA], A177: [corn, Bt11×59122, SYN-BT011-1×DAS-59122-7, NA], A178: [corn, Bt11×59122×GA21, SYN-BT011-1×DAS-59122-7×MON-00021-9, NA], A179: [corn, Bt11×59122×MIR604, SYN-BT011-1×DAS-59122-7×SYN-IR604-5, NA], A180: [corn, Bt11×59122×MIR604×GA21, SYN-BT011-1×DAS-59122-7×SYN-IR604-5×MON-00021-9, NA], A181: [corn, Bt11×59122×MIR604×TC1507, SYN-BT011-1×DAS-59122-7×SYN-IR604-5×DAS-01507-1, NA], A182: [corn, BT11×59122×MIR604×TC1507×GA21, SYN-BT011-1×DAS-59122-7×SYN-IR604-5×DAS-01507-1×MON-00021-9, Agrisure (registered trademark) 3122], A183: [corn, Bt11×59122×TC1507, SYN-BT011-1×DAS-59122-7×DAS-01507-1, NA], A184: [corn, Bt11×59122×TC1507×GA21, SYN-BT011-1×DAS-59122-7×DAS-01507-1×MON-00021-9, NA], A185: [corn, Bt11×GA21, SYN-BT011-1×MON-00021-9, Agrisure (trademark) GT/CB/LL], A186: [corn, Bt11×MIR162, SYN-BT011-1×SYN-IR162-4, Agrisure (registered trademark) Viptera (trademark) 2100], A187: [corn, Bt11×MIR162×5307, SYN-BT011-1×SYN-IR162-4×SYN-05307-1, NA], A188: [corn, Bt11×MIR162×5307×GA21, SYN-BT011-1×SYN-IR162-4×SYN-05307-1×MON-00021-9, NA], A189: [corn, Bt11×MIR162×GA21, SYN-BT011-1×SYN-IR162-4×MON-00021-9, Agrisure (registered trademark) Viptera (trademark) 3110], A190: [corn, BT11×MIR162×MIR604, SYN-BT011-1×SYN-IR162-4×SYN-IR604-5, Agrisure (registered trademark) Viptera (trademark) 3100], A191: [corn, BT11×MIR162×MIR604×5307, SYN-BT011-1×SYN-IR162-4×SYN-IR604-5×SYN-05307-1, NA], A192: [corn, Bt11×MIR162×MIR604×5307×GA21, SYN-BT011-1×SYN-IR162-4×SYN-IR604-5×SYN-05307-1×MON-00021-9, NA], A193: [corn, Bt11×MIR162×MIR604×GA21, SYN-BT011-1×SYN-IR162-4×SYN-IR604-5×MON-00021-9, Agrisure (registered trademark) Viptera (trademark) 3111, Agrisure (registered trademark) Viptera (trademark) 4], A194: [corn, Bt11×MIR162×MIR604×MON89034×5307×GA21, SYN-BT011-1×SYN-IR162-4×SYN-IR604-5×MON-89034-3×SYN-05307-1×MON-00021-9, NA], A195: [corn, BT11×MIR162×MIR604×TC1507, SYN-BT011-1×SYN-IR162-4×SYN-IR604-5×DAS-01507-1, NA], A196: [corn, BT11×MIR162×MIR604×TC1507×5307, SYN-BT011-1×SYN-IR162-4×SYN-IR604-5×DAS-01507-1×SYN-05307-1, NA], A197: [corn, Bt11×MIR162×MIR604×TC1507×GA21, SYN-BT011-1×SYN-IR162-4×SYN-IR604-5×DAS-01507-1×MON-00021-9, NA], A198: [corn, Bt11×MIR162×MON89034, SYN-BT011-1×SYN-IR162-4×MON-89034-3, NA], A199: [corn, Bt11×MIR162×MON89034×GA21, SYN-BT011-1×SYN-IR162-4×MON-89034-3×MON-00021-9, NA], A200: [corn, Bt11×MIR162×TC1507, SYN-BT011-1×SYN-IR162-4×DAS-01507-1, NA], A201: [corn, Bt11×MIR162×TC1507×5307, SYN-BT011-1×SYN-IR162-4×DAS-01507-1×SYN-05307-1, NA], A202: [corn, Bt11×MIR162×TC1507×5307×GA21, SYN-BT011-1×SYN-IR162-4×DAS-01507-1×SYN-05307-1×MON-00021-9, NA], A203: [corn, Bt11×MIR162×TC1507×GA21, SYN-BT011-1×SYN-IR162-4×DAS-01507-1×MON-00021-9, Agrisure (trademark) Viptera3220], A204: [corn, Bt11×MIR604, SYN-BT011-1×SYN-IR604-5, Agrisure (trademark) CB/LL/RW], A205: [corn, Bt11×MIR604×5307, SYN-BT011-1×SYN-IR604-5×SYN-05307-1, NA], A206: [corn, Bt11×MIR604×5307×GA21, SYN-BT011-1×SYN-IR604-5×SYN-05307-1×MON-00021-9, NA], A207: [corn, BT11×MIR604×GA21, SYN-BT011-1×SYN-IR604-5×MON-00021-9, Agrisure (trademark) 3000GT], A208: [corn, Bt11×MIR604×TC1507, SYN-BT011-1×SYN-IR604-5×DAS-01507-1, NA], A209: [corn, Bt11×MIR604×TC1507×5307, SYN-BT011-1×SYN-IR604-5×DAS-01507-1×SYN-05307-1, NA], A210: [corn, Bt11×MIR604×TC1507×GA21, SYN-BT011-1×SYN-IR604-5×DAS-01507-1×MON-00021-9, NA], A211: [corn, Bt11×MON89034, SYN-BT011-1×MON-89034-3, NA], A212: [corn, Bt11×MON89034×GA21, SYN-BT011-1×MON-89034-3×MON-00021-9, NA], A213: [corn, Bt11×TC1507, SYN-BT011-1×DAS-01507-1, NA], A214: [corn, Bt11×TC1507×5307, SYN-BT011-1×DAS-01507-1×SYN-05307-1, NA], A215: [corn, Bt11×TC1507×5307×GA21, SYN-BT011-1×DAS-01507-1×SYN-05307-1×MON-00021-9, NA], A216: [corn, Bt11×TC1507×GA21, SYN-BT011-1×DAS-01507-1×MON-00021-9, NA], A217: [corn, Bt176(176), SYN-EV176-9, NaturGardKnockOut (trademark), Maximizer (trademark)], A218: [corn, BVLA430101, NA, NA], A219: [corn, CBH-351, ACS-ZM004-3, Starlink (trademark) Maize], A220: [corn, DAS40278, DAS-40278-9, Enlist (trademark) Maize], A221: [corn, DAS40278×NK603, DAS-40278-9×MON-00603-6, NA], A222: [corn, DBT418, DKB-89614-9, Bt×tra (trademark) Maize], A223: [corn, DLL25(B16), DKB-89790-5, NA], A224: [corn, GA21, MON-00021-9, Roundup Ready (trademark) Maize, Agrisure (trademark) GT], A225: [corn, GA21×MON810, MON-00021-9×MON-00810-6, Roundup Ready (trademark) YieldGard (trademark) maize], A226: [corn, GA21×T25, MON-00021-9×ACS-ZM003-2, NA], A227: [corn, HCEM485, HCEM485, NA], A228: [corn, LY038, REN-00038-3, Mavera (trademark) Maize], A229: [corn, LY038×MON810, REN-00038-3×MON-00810-6, Mavera (trademark) YieldGard (trademark) Maize], A230: [corn, MIR162, SYN-IR162-4, Agrisure (trademark) Viptera], A231: [corn, MIR162×5307, SYN-IR162-4×SYN-05307-1, NA], A232: [corn, MIR162×5307×GA21, SYN-IR162-4×SYN-05307-1×MON-00021-9, NA], A233: [corn, MIR162×GA21, SYN-IR162-4×MON-00021-9, NA], A234: [corn, MIR162×MIR604, SYN-IR162-4×SYN-IR604-5, NA], A235: [corn, MIR162×MIR604×5307, SYN-IR162-4×SYN-IR604-5×SYN-05307-1, NA], A236: [corn, MIR162×MIR604×5307×GA21, SYN-IR162-4×SYN-IR604-5×SYN-05307-1×MON-00021-9, NA], A237: [corn, MIR162×MIR604×GA21, SYN-IR162-4×SYN-IR604-5×MON-00021-9, NA], A238: [corn, MIR162×MIR604×TC1507×5307, SYN-IR162-4×SYN-IR604-5×DAS-01507-1×SYN-05307-1, NA], A239: [corn, MIR162×MIR604×TC1507×5307×GA21, SYN-IR162-4×SYN-IR604-5×DAS-01507-1×SYN-05307-1×MON-00021-9, NA], A240: [corn, MIR162×MIR604×TC1507×GA21, SYN-IR162-4×SYN-IR604-5×DAS-01507-1×MON-00021-9, NA], A241: [corn, MIR162×MON89034, SYN-IR162-4×MON-89034-3, NA], A242: [corn, MIR162×MON89034×GA21, SYN-IR162-4×MON-89034-3×MON-00021-9, NA], A243: [corn, MIR162×NK603, SYN-IR162-4×MON-00603-6, NA], A244: [corn, MIR162×TC1507, SYN-IR162-4×DAS-01507-1, NA], A245: [corn, MIR162×TC1507×5307, SYN-IR162-4×DAS-01507-1×SYN-05307-1, NA], A246: [corn, MIR162×TC1507×5307×GA21, SYN-IR162-4×DAS-01507-1×SYN-05307-1×MON-00021-9, NA], A247: [corn, MIR162×TC1507×GA21, SYN-IR162-4×DAS-01507-1×MON-00021-9, NA], A248: [corn, MIR604, SYN-IR604-5, Agrisure (trademark) RW], A249: [corn, MIR604×5307, SYN-IR604-5×SYN-05307-1, NA], A250: [corn, MIR604×5307×GA21, SYN-IR604-5×SYN-05307-1×MON-00021-9, NA], A251: [corn, MIR604×GA21, SYN-IR604-5×MON-00021-9, Agrisure (trademark) GT/RW], A252: [corn, MIR604×NK603, SYN-IR604-5×MON-00603-6, NA], A253: [corn, MIR604×TC1507, SYN-IR604-5×DAS-01507-1, Optimum (registered trademark) TRIsect (trademark)], A254: [corn, MIR604×TC1507×5307, SYN-IR604-5×DAS-01507-1×SYN-05307-1, NA], A255: [corn, MIR604×TC1507×5307×GA21, SYN-IR604-5×TC1507×SYN-05307-1×MON-00021-9, NA], A256: [corn, MIR604×TC1507×GA21, SYN-IR604-5×TC1507×MON-00021-9, NA], A257: [corn, MON801(MON80100), MON801, NA], A258: [corn, MON802, MON-80200-7, NA], A259: [corn, MON809, PH-MON-809-2, NA], A260: [corn, MON810, MON-00810-6, YieldGard (trademark), MaizeGard (trademark)], A261: [corn, MON810×MIR162, MON-00810-6×SYN-IR162-4, NA], A262: [corn, MON810×MIR162×NK603, MON-00810-6×SYN-IR162-4×MON-00603-6, NA], A263: [corn, MON810×MIR604, MON-00810-6×SYN-IR604-5, NA], A264: [corn, MON810×MON88017, MON-00810-6×MON-88017-3, YieldGard (trademark) VTTriple], A265: [corn, MON810×NK603×MIR604, MON-00810-6×MON-00603-6×SYN-IR604-5, NA], A266: [corn, MON832, NA, Roundup Ready (trademark) Maize], A267: [corn, MON863, MON-00863-5, YieldGard (trademark) Rootworm RW, MaxGard (trademark)], A268: [corn, MON863×MON810, MON-00863-5×MON-00810-6, YieldGard (trademark) Plus], A269: [corn, MON863×MON810×NK603, MON-00603-6×MON-00810-6×MON-00863-5, YieldGard (trademark) PluswithRR], A270: [corn, MON863×NK603, MON-00863-5×MON-00603-6, YieldGard (trademark) RW+RR], A271: [corn, MON87403, MON87403-1, NA], A272: [corn, MON87411, MON-87411-9, NA], A273: [corn, MON87419, MON87419-8, NA], A274: [corn, MON87427, MON-87427-7, Roundup Ready (trademark) Maize], A275: [corn, MON87427×59122, MON-87427-7×DAS-59122-7, NA], A276: [corn, MON87427×MON88017, MON-87427-7×MON-88017-3, NA], A277: [corn, MON87427×MON88017×59122, MON-87427-7×MON-88017-3×DAS-59122-7, NA], A278: [corn, MON87427×MON89034, MON-87427-7×MON-89034-3, NA], A279: [corn, MON87427×MON89034×59122, MON-87427-7×MON-89034-3×DAS-59122-7, NA], A280: [corn, MON87427×MON89034×MON88017, MON-87427-7×MON-89034-3×MON-88017-3, NA], A281: [corn, MON87427×MON89034×MON88017×59122, MON-87427-7×MON-89034-3×MON-88017-3×59122, NA], A282: [corn, MON87427×MON89034×NK603, MON-87427-7×MON-89034-3×MON-00603-6, NA], A283: [corn, MON87427×MON89034×TC1507, MON-87427-7×MON-89034-3×DAS-01507-1, NA], A284: [corn, MON87427×MON89034×TC1507×59122, MON-87427-7×MON-89034-3×DAS-01507-1×DAS-59122-7, NA], A285: [corn, MON87427×MON89034×TC1507×MON87411×59122, MON-87427-7×MON-89034-3×DAS-01507-1×MON-87411-9×DAS-59122-7, NA], A286: [corn, MON87427×MON89034×TC1507×MON88017, MON-87427-7×MON-89034-3×DAS-01507-1×MON-88017-3, NA], A287: [corn, MON87427×MON89034×MIR162×NK603, MON-87427-7×MON-89034-3×SYN-IR162-4×MON-00603-6, NA], A288: [corn, MON87427×MON89034×TC1507×MON88017×59122, MON-87427-7×MON-89034-3×DAS-01507-1×MON-88017-3×DAS-59122-7, NA], A289: [corn, MON87427×NK603, MON-87427-7×MON-00603-6, NA], A290: [corn, MON87427×TC1507, MON-87427-7×DAS-01507-1, NA], A291: [corn, MON87427×TC1507×59122, MON-87427-7×DAS-01507-1×DAS-59122-7, NA], A292: [corn, MON87427×TC1507×MON88017, MON-87427-7×DAS-01507-1×MON-88017-3, NA], A293: [corn, MON87427×TC1507×MON88017×59122, MON-87427-7×DAS-01507-1×MON-88017-3×DAS-59122-7, NA], A294: [corn, MON87460, MON-87460-4, Genuity (registered trademark) DroughtGard (trademark)], A295: [corn, MON87460×MON88017, MON-87460-4×MON-88017-3, NA], A296: [corn, MON87460×MON89034×MON88017, MON-87460-4×MON-89034-3×MON-88017-3, NA], A297: [corn, MON87460×MON89034×NK603, MON-87460-4×MON-89034-3×MON-00603-6, NA], A298: [corn, MON87460×NK603, MON-87460-4×MON-00603-6, NA], A299: [corn, MON88017, MON-88017-3, YieldGard (trademark) VT (trademark) Rootworm (trademark) RR2], A300: [corn, MON88017×DAS40278, MON-88017-3×DAS-40278-9, NA], A301: [corn, MON89034, MON-89034-3, YieldGard (trademark) VTPro (trademark)], A302: [corn, MON89034×59122, MON-89034-3×DAS-59122-7, NA], A303: [corn, MON89034×59122×DAS40278, MON-89034-3×DAS-59122-7×DAS-40278-9, NA], A304: [corn, MON89034×59122×MON88017, MON-89034-3×DAS-59122-7×MON-88017-3, NA], A305: [corn, MON89034×59122×MON88017×DAS40278, MON-89034-3×DAS-59122-7×MON-88017-3×DAS-40278-9, NA], A306: [corn, MON89034×DAS40278, MON-89034-3×DAS-40278-9, NA], A307: [corn, MON89034×MON87460, MON-89034-3×MON-87460-4, NA], A308: [corn, MON89034×MON88017, MON-89034-3×MON-88017-3, Genuity (registered trademark) VTTriplePro (trademark)], A309: [corn, MON89034×MON88017×DAS40278, MON-89034-3×MON-88017-3×DAS-40278-9, NA], A310: [corn, MON89034×NK603, MON-89034-3×MON-00603-6, Genuity (registered trademark) VTDoublePro (trademark)], A311: [corn, MON89034×NK603×DAS40278, MON-89034-3×MON-00603-6×DAS-40278-9, NA], A312: [corn, MON89034×TC1507, MON-89034-3×DAS-01507-1, NA], A313: [corn, MON89034×TC1507×59122, MON-89034-3×DAS-01507-1×DAS-59122-7, NA], A314: [corn, MON89034×TC1507×59122×DAS40278, MON-89034-3×DAS-01507-1×DAS-59122-7×DAS-40278-9, NA], A315: [corn, MON89034×TC1507×DAS40278, MON-89034-3×DAS-01507-1×DAS-40278-9, NA], A316: [corn, MON89034×TC1507×MON88017, MON-89034-3×DAS-01507-1×MON-88017-3, NA], A317: [corn, MON89034×TC1507×MON88017×59122, MON-89034-3×DAS-01507-1×MON-88017-3×DAS-59122-7, Genuity (registered trademark) SmartStax (trademark)], A318: [corn, MON89034×TC1507×MON88017×59122×DAS40278, MON-89034-3×DAS-01507-1×MON-88017-3×DAS-59122-7×DAS-40278-9, NA], A319: [corn, MON89034×TC1507×MON88017×DAS40278, MON-89034-3×DAS-01507-1×MON-88017-3×DAS-59122-7×DAS-40278-9, NA], A320: [corn, MON89034×TC1507×NK603, MON-89034-3×DAS-01507-1×MON-00603-6, PowerCore (trademark)], A321: [corn, MON89034×TC1507×NK603×DAS40278, MON-89034-3×DAS-01507-1×MON-00603-6×DAS-40278-9, NA], A322: [corn, MON89034×TC1507×NK603×MIR162, MON-89034-3×DAS-01507-1×MON-00603-6×SYN-IR162-4, NA], A323: [corn, MON89034×TC1507×NK603×MIR162×DAS40278, MON-89034-3×DAS-01507-1×MON-00603-6×SYN-IR162-4×DAS-40278-9, PowerCore (trademark)×MIR162×Enlist (trademark)], A324: [corn, MON89034×GA21, MON-89034-3×MON-00021-9, NA], A325: [corn, MS3, ACS-ZM001-9, InVigor (trademark) Maize], A326: [corn, MS6, ACS-ZM005-4, InVigor (trademark) Maize], A327: [corn, MZHG0JG, SYN-000JG-2, NA], A328: [corn, MZIR098, SYN-00098-3, NA], A329: [corn, NK603, MON-00603-6, Roundup Ready (trademark) 2Maize], A330: [corn, NK603×MON810×4114×MIR604, MON-00603-6×MON-00810-6×DP004114-3×SYN-IR604-4, NA], A331: [corn, NK603×MON810, MON-00603-6×MON-00810-6, YieldGard (trademark) CB+RR], A332: [corn, NK603×T25, MON-00603-6×ACS-ZM003-2, Roundup Ready (trademark) LibertyLink (trademark) Maize], A333: [corn, T14, ACS-ZM002-1, LibertyLink (trademark) Maize], A334: [corn, T25, ACS-ZM003-2, LibertyLink (trademark) Maize], A335: [corn, T25×MON810, ACS-ZM003-2×MON-00810-6, LibertyLink (trademark) Yieldgard (trademark) Maize], A336: [corn, TC1507, DAS-01507-1, Hercule×(trademark) I, Hercule×(trademark) CB], A337: [corn, TC1507×59122×MON810×MIR604×NK603, DAS-01507-1×DAS-59122-7×MON-00810-6×SYN-IR604-5×MON-00603-6, Optimum (trademark) Intrasect X treme], A338: [corn, TC1507×MON810×MIR604×NK603, DAS-01507-1×MON-00810-6×SYN-IR604-5×MON-00603-6, NA], A339: [corn, TC1507×5307, DAS-01507-1×SYN-05307-1, NA], A340: [corn, TC1507×5307×GA21, DAS-01507-1×SYN-05307-1×MON-00021-9, NA], A341: [corn, TC1507×59122, DAS-01507-1×DAS-59122-7, Hercule×TRA (trademark)], A342: [corn, TC1507×59122×DAS40278, DAS-01507-1×DAS-59122-7×DAS-40278-9, NA], A343: [corn, TC1507×59122×MON810, DAS-01507-1×DAS-59122-7×MON-00810-6, Optimum (registered trademark) AcreMa×(registered trademark)×tra], A344: [corn, TC1507×59122×MON810×MIR604, DAS-01507-1×DAS-59122-7×MON-00810-6×SYN-IR604-5, Optimum (registered trademark) AcreMa×(registered trademark)×Treme], A345: [corn, TC1507×59122×MON810×NK603, DAS-01507-1×DAS-59122-7×MON-00810-6×MON-00603-6, Optimum (trademark) Intrasect X TRA], A346: [corn, TC1507×59122×MON88017, DAS-01507-1×DAS-59122-7×MON-88017-3, NA], A347: [corn, TC1507×59122×MON88017×DAS40278, DAS-01507-1×DAS-59122-7×MON-88017-3×DAS-40278-9, NA], A348: [corn, TC1507×59122×NK603, DAS-01507-1×DAS-59122-7×MON-00603-6, Hercule×TRA (trademark) RR], A349: [corn, TC1507×59122×NK603×MIR604, DAS-01507-1×DAS-59122-7×MON-00603-6×SYN-IR604-5, NA], A350: [corn, TC1507×DAS40278, DAS-01507-1×DAS-40278-9, NA], A351: [corn, TC1507×GA21, DAS-01507-1×MON-00021-9, NA], A352: [corn, TC1507×MIR162×NK603, DAS-01507-1×SYN-IR162-4×MON-00603-6, Optimum (registered trademark) Leptra (trademark)], A353: [corn, TC1507×MIR604×NK603, DAS-01507-1×SYN-IR604-5×MON-00603-6, Optimum (trademark) TRIsect], A354: [corn, TC1507×MON810, DAS-01507-1×MON-00, NA], A355: [corn, TC1507×MON810×MIR162, DAS-01507-1×MON-00810-6×SYN-IR162-4, NA], A356: [corn, TC1507×MON810×MIR162×NK603, DAS-01507-1×MON-00810-6×SYN-IR162-4×MON-00603-6, NA], A357: [corn, TC1507×MON810×MIR604, DAS-01507-1×MON-00810-6×SYN-IR604-5, NA], A358: [corn, TC1507×MON810×NK603, DAS-01507-1×MON-00810-6×MON-00603-6, Optimum (trademark) Intrasect], A359: [corn, TC1507×MON810×NK603×MIR604, DAS-01507-1×MON-00810-6×MON-00603-6×SYN-IR604-5, NA], A360: [corn, TC1507×MON88017, DAS-01507-1×MON-88017-3, NA], A361: [corn, TC1507×MON88017×DAS40278, DAS-01507-1×MON-88017-3×DAS-40278-9, NA], A362: [corn, TC1507×NK603, DAS-01507-1×MON-00603-6, Hercule×(trademark) IRR], A363: [corn, TC1507×NK603×DAS40278, DAS-01507-1×MON-00603-6×DAS-40278-9, NA], A364: [corn, TC6275, DAS-06275-8, NA], A365: [corn, VCO-01981-5, VCO-01981-5, NA], A366: [corn, DK404SR, DK404SR, NA], A367: [corn, EXP1910IT, EXP1910IT, NA], A368: [melon, MelonA, NA, NA], A369: [melon, MelonB, NA, NA], A370: [papaya, 55-1, CUH-CP551-8, Rainbow, SunUp], A371: [papaya, 63-1, CUH-CP631-7, NA], A372: [papaya, Huanong No. 1, NA, Huanong No. 1], A373: [papaya, X17-2, UFL-X17CP-6, NA], A374: [petunia, Petunia-CHS, NA, NA], A375: [plum, C-5, ARS-PLMC5-6, NA], A376: [polish canola, HCR-1, NA, NA], A377: [polish canola, ZSR500, NA, Hysyn101RRRoundup-Ready (trademark)], A378: [polish canola, ZSR502, NA, Hysyn101RRRoundup-Ready (trademark)], A379: [polish canola, ZSR503, NA, Hysyn101RRRoundup-Ready (trademark)], A380: [poplar, Btpoplar, poplar12 (Populusnigra), NA, NA], A381: [poplar, Hybridpoplarclone741, NA, NA], A382: [potato, 1210amk, NA, Lugovskoiplus], A383: [potato, 2904/1kgs, NA, Elizavetaplus], A384: [potato, AM04-1020, BPS-A1020-5, StarchPotato], A385: [potato, ATBT04-27, NMK-89367-8, AtlanticNewLeaf (trademark) potato], A386: [potato, ATBT04-30, NMK-89613-2, AtlanticNewLeaf (trademark) potato], A387: [potato, ATBT04-31, NMK-89170-9, AtlanticNewLeaf (trademark) potato], A388: [potato, ATBT04-36, NMK-89279-1, AtlanticNewLeaf (trademark) potato], A389: [potato, ATBT04-6, NMK-89761-6, AtlanticNewLeaf (trademark) potato], A390: [potato, BT06, NMK-89812-3, NewLeaf (trademark) RussetBurbank potato], A391: [potato, BT10, NMK-89175-5, NewLeaf (trademark) RussetBurbank potato], A392: [potato, BT12, NMK-89601-8, NewLeaf (trademark) RussetBurbank potato], A393: [potato, BT16, NMK-89167-6, NewLeaf (trademark) RussetBurbank potato], A394: [potato, BT17, NMK-89593-9, NewLeaf (trademark) RussetBurbank potato], A395: [potato, BT18, NMK-89906-7, NewLeaf (trademark) RussetBurbank potato], A396: [potato, BT23, NMK-89675-1, NewLeaf (trademark) RussetBurbank potato], A397: [potato, E12, SPS-00E12-8, Innate (registered trademark) Cultivate], A398: [potato, E24, SPS-00E24-2, NA], A399: [potato, EH92-527-1, BPS-25271EH92-527-1-9, Amflora (trademark)], A400: [potato, F10, SPS-0 0F10-7, Innate (registered trademark) Generate], A401: [potato, F37, SPS-00F37-7, NA], A402: [potato, G11, SPS-00G11-9, NA], A403: [potato, H37, SPS-00H37-9, NA], A404: [potato, H50, SPS-00H50-4, NA], A405: [potato, HLMT15-15, NA, Hi-LiteNewLeaf (trademark) Ypotato], A406: [potato, HLMT15-3, NA, Hi-LiteNewLeaf (trademark) Ypotato], A407: [potato, HLMT15-46, NA, Hi-LiteNewLeaf (trademark) Ypotato], A408: [potato, J3, SPS-000J3-4, Innate (registered trademark) Accelerate], A409: [potato, J55, SPS-00J55-2, NA], A410: [potato, J78, SPS-00J78-7, NA], A411: [potato, RBMT15-101, NMK-89653-6, NewLeaf (trademark) YRussetBurbank potato], A412: [potato, RBMT21-129, NMK-89684-1, NewLeaf (trademark) PlusRussetBurbank potato], A413: [potato, RBMT21-152, NA, NewLeaf (trademark) PlusRussetBurbank potato], A414: [potato, RBMT21-350, NMK-89185-6, NewLeaf (trademark) PlusRussetBurbank potato], A415: [potato, RBMT22-082, NMK-89896-6, NewLeaf (trademark) PlusRussetBurbank potato], A416: [potato, RBMT22-186, NA, NewLeaf (trademark) PlusRussetBurbank potato], A417: [potato, RBMT22-238, NA, NewLeaf (trademark) PlusRussetBurbank potato], A418: [potato, RBMT22-262, NA, NewLeaf (trademark) PlusRussetBurbank potato], A419: [potato, SEMT15-02, NMK-89935-9, ShepodyNewLeaf (trademark) Ypotato], A420: [potato, SEMT15-07, NA, ShepodyNewLeaf (trademark) Ypotato], A421: [potato, SEMT15-15, NMK-89930-4, ShepodyNewLeaf (trademark) Ypotato], A422: [potato, SPBT02-5, NMK-89576-1, SuperiorNewLeaf (trademark) potato], A423: [potato, SPBT02-7, NMK-89724-5, SuperiorNewLeaf (trademark) potato], A424: [potato, TIC-AR233-5, TIC-AR233-5, NA], A425: [potato, V11, SPS-00V11-6, Innate (registered trademark) Invigorate], A426: [potato, W8, SPS-000W8-4, Innate (registered trademark) Glaciate], A427: [potato, X 17, SPS-00 X 17-5, Innate (registered trademark) Acclimate], A428: [potato, Y9, SPS-000Y9-7, Innate (registered trademark) Hibernate], A429: [rice, 7Crp #10, NA, NA], A430: [rice, GMShanyou63, NA, BTShanyou63], A431: [rice, Huahui-1/TT51-1, NA, Huahui-1], A432: [rice, LLRICE06, ACS-OS001-4, LibertyLink (trademark) rice], A433: [rice, LLRICE601, BCS-OS003-7, LibertyLink (trademark) rice], A434: [rice, LLRICE62, ACS-OS002-5, LibertyLink (trademark) rice], A435: [rice, Tarommolaii+cry1Ab, NA, NA], A436: [rice, CL121×CL141×CF×51, CL121×CL141×CF×51, Clearfield (registered trademark) Rice], A437: [rice, IMINTA-1×IMINTA-4, IMINTA-1×IMINTA-4, Clearfield (registered trademark) Rice], A438: [rice, PWC16, PWC16, NA], A439: [rose, WKS82/130-4-1, IFD-52401-4, NA], A440: [rose, WKS92/130-9-1, IFD-52901-9, NA], A441: [soybean, 260-05(G94-1, G94-19, G168), DD-026005-3, NA], A442: [soybean, A2704-12, ACS-GM005-3, LibertyLink (trademark) soybean], A443: [soybean, A2704-21, ACS-GM004-2, LibertyLink (trademark) soybean], A444: [soybean, A5547-127, ACS-GM006-4, LibertyLink (trademark) soybean], A445: [soybean, A5547-35, ACS-GM008-6, LibertyLink (trademark) soybean], A446: [soybean, CV127, BPS-CV127-9, Cultivance], A447: [soybean, DAS44406-6, DAS-44406-6, NA], A448: [soybean, DAS68416-4, DAS-68416-4, Enlist (trademark) Soybean], A449: [soybean, DAS68416-4×MON89788, DAS-68416-4×MON-89788-1, NA], A450: [soybean, DAS81419, DAS-81419-2, NA], A451: [soybean, DAS81419×DAS44406-6, DAS-81419-2×DAS-44406-6, NA], A452: [soybean, DP305423, DP-305423-1, Treus (trademark) or Plenish (trademark)], A453: [soybean, DP305423×GTS40-3-2, DP-305423-1×MON-04032-6, NA], A454: [soybean, DP356043, DP-356043-5, OptimumGAT (trademark)], A455: [soybean, FG72 (FG072-2, FG072-3), MST-FG072-3, NA], A456: [soybean, FG72×A5547-127, MST-FG072-3×ACS-GM006-4, Liberty Link (registered trademark) GT27 (trademark)], A457: [soybean, GTS40-3-2(40-3-2), MON-04032-6, Roundup Ready (trademark) soybean], A458: [soybean, GU262, ACS-GM003-1, LibertyLink (trademark) soybean], A459: [soybean, IND-00410-5, IND-00410-5, VerdecaHB4Soybean], A460: [soybean, MON87701, MON-87701-2, NA], A461: [soybean, MON87701×MON89788, MON-87701-2×MON-89788-1, Intacta (trademark) Roundup Ready (trademark) 2Pro], A462: [soybean, MON87705, MON-87705-6, VistiveGold (trademark)], A463: [soybean, MON87705×MON87708, MON-87705-6×MON-87708-9, NA], A464: [soybean, MON87705×MON87708×MON89788, MON-87705-6×MON-87708-9×MON-89788-1, NA], A465: [soybean, MON87705×MON89788, MON-87705-6×MON-89788-1, NA], A466: [soybean, MON87708, MON-87708-9, Genuity (registered trademark) Roundup Ready (trademark) 2 X tend (trademark)], A467: [soybean, MON87708×MON89788, MON-87708-9×MON-89788-1, Roundup Ready 2 X tend (registered trademark)], A468: [soybean, MON87712, MON-87712-4, NA], A469: [soybean, MON87751, MON-87751-7, NA], A470: [soybean, MON87751×MON87701×MON87708×MON89788, MON-87751-7×MON-87701-2×MON87708×MON89788, NA], A471: [soybean, MON87769, MON87769-7, NA], A472: [soybean, MON87769×MON89788, MON-87769-7×MON-89788-1, NA], A473: [soybean, MON89788, MON-89788-1, Genuity (registered trademark) Roundup Ready 2 Yield (trademark)], A474: [soybean, SYHT0H2, SYN-000H2-5, Herbicide-tolerantSoybeanline], A475: [soybean, W62, ACS-GM002-9, LibertyLink (trademark) soybean], A476: [soybean, W98, ACS-GM001-8, LibertyLink (trademark) soybean], A477: [soybean, OT96-15, OT96-15, NA], A478: [summer squash (Cucurbitapepo), CZW3, SEM-0CZW3-2, NA], A479: [summer squash (Cucurbita pepo), ZW20, SEM-0ZW20-7, NA], A480: [sugar beet, GTSB77(T9100152), SY-GTSB77-8, InVigor (trademark) sugarbeet], A481: [sugar beet, H7-1, KM-000H71-4, Roundup Ready (trademark) sugarbeet], A482: [sugar beet, T120-7, ACS-BV001-3, LibertyLink (trademark) sugarbeet], A483: [sugar cane, CTB141175/01-A, CTB141175/01-A, NA], A484: [sugar cane, NXI-1T, NXI-1T, NA], A485: [sugar cane, NXI-4T, NXI-4T, NA], A486: [sugar cane, NXI-6T, NXI-6T, NA], A487: [sunflower, X81359, X81359, Clearfield (registered trademark) Sunflower], A488: [sweet pepper, PK-SP01, X81359, NA], A489: [tobacco, C/F/93/08-02, NA, NA], A490: [tobacco, Vector21-41, NA, NA], A491: [tomato, 1345-4, NA, NA], A492: [tomato, 35-1-N, NA, NA], A493: [tomato, 5345, NA, NA], A494: [tomato, 8338, CGN-89322-3, NA], A495: [tomato, B, SYN-0000B-6, NA], A496: [tomato, Da, SYN-000DA-9, NA], A497: [tomato, DaDongNo9, NA, NA], A498: [tomato, F(1401F,h38F,11013F,7913F), SYN-0000F-1, FLAVRSAVR (trademark)], A499: [tomato, FLAVRSAVR, CGN-89564-2, FLAVRSAVR (trademark)], A500: [tomato, Huafan No1, NA, NA], A501: [tomato, PK-TM8805R(8805R), NA, NA], A502: [wheat, MON71800, MON-71800-3, Roundup Ready (trademark) wheat], A503: [wheat, AP205CL, AP205CL, Clearfield (registered trademark) Wheat], A504: [wheat, AP602CL, AP602CL, Clearfield (registered trademark) Wheat], A505: [wheat, BW255-2×BW238-3, BW255-2×BW238-3, Clearfield (registered trademark) Wheat], A506: [wheat, BW7, BW7, Clearfield (registered trademark) Wheat], A507: [wheat, Teal11A, Teal11A, Clearfield (registered trademark) Wheat], A508: [wheat, SWP965001, SWP965001, NA], A509: [corn, NA, NA, Agrisure Artesian (trademark)], A510: [corn, NA, NA, Optimum (registered trademark) AQUAmax (registered trademark)], A511: [canola, NA, NA, SU canola (registered trademark)], A512: [canola, NA, NA, Nexera (registered trademark) Canola], A513: [soybean, NA, NA, STS soybean”, A514: “corn, NA, NA, SR corn”, A514: “sunflower, NA, NA, ExpressSun (registered trademark)”, A515: [rice, NA, NA, Golden rice], A516: [corn, NA, NA, Poast Protected (registered trademark) corn], A517: [sunflower, NA, NA, ExpressSun (registered trademark)], A518: [rice, NA, NA, Provisia (trademark) Rice”, A519: [canola, NA, NA, Triazinon Tolerant Canola], A520: [corn, NA, NA, SmartStax (registered trademark) Pro], A521: [soybean, NA, NA, Credenz (registered trademark) soybean], A522: [corn, TC1507×59122, DAS-01507-1×DAS-59122-7, Optimum (registered trademark) AcreMax (registered trademark) 1], A523: [corn, 4114×MON810×MIR604, DP-004114-3×MON-00810-6×SYN-IR604-5, Qrome (trademark)], A524: [cotton, NA, NA, Stoneville (registered trademark) Cotton ST5517GLTP], A525: [cotton, NA, NA, Stoneville (registered trademark) Cotton ST4848GLT], A526: [cotton, NA, NA, Stoneville (registered trademark) Cotton ST4949GLT], A527: [cotton, NA, NA, Stoneville (registered trademark) Cotton ST5020GLT], A528: [cotton, NA, NA, Stoneville (registered trademark) Cotton ST5115GLT], A529: [cotton, NA, NA, Stoneville (registered trademark) Cotton ST6182GLT], A530: [cotton, NA, NA, Stoneville (registered trademark) Cotton ST4747GLB2], A531: [cotton, NA, NA, Stoneville (registered trademark) Cotton ST4946GLB2], A532: [cotton, NA, NA, Stoneville (registered trademark) Cotton ST6448GLB2], A533: [soybean, NA, NA, Enlist E3 (trademark)], A534: [soybean, NA, NA, Enlist (trademark) Roundup Ready 2 Yield (registered trademark)], A535: [corn, NA, NA, Enlist (trademark) Roundup Ready (registered trademark) Corn 2], A536: [corn, NA, NA, Smartstax (registered trademark) Enlist (trademark)], A537: [corn, NA, NA, Powercore (registered trademark) Enlist (trademark)], A538: [cotton, NA, NA, Enlist (trademark) Cotton], A539: [cotton, NA, NA, Bollgard (registered trademark) 3 XtendFlex (registered trademark)], A540: [corn, NA, NA, SmartStax (registered trademark) RIB Complete (registered trademark) Corn], A541: [corn, NA, NA, VT Double PRO (registered trademark) RIB Complete (registered trademark) Corn], A542: [corn, NA, NA, VT Double PRO (registered trademark) Corn], A543: [corn, NA, NA, Genuity (registered trademark) VT Triple PRO (registered trademark) RIB Complete Corn], A544: [corn, NA, NA, Trecepta (trademark) Corn], A545: [soybean, NA, NA, FUKUMINORI], A546: [soybean, NA, NA, YUMEMINORI], A547: [corn, NA, NA, ZFN-12 maize], A548: [rice, NA, NA, YUMEPIRIKA], A549: [rice, NA, NA, KANTO BPH1], A550: [cotton, NA, MON88702, NA], A551: [soybean, DP305423×MON87708, DP-305423-1×MON-87708-9, NA], A552: [soybean, DP305423×MON87708×MON89788, DP-305423-1×MON-87708-9×MON-89788-1, NA], A553: [soybean, DP305423×MON89788, DP-305423-1×MON-89788-1, NA], A554: [cotton, 3006-210-23×281-24-236×MON88913×COT102×81910, DAS-21023-5×DAS-24236-5×MON-88913-8×SYN-IR102-7], A555: [cotton, GHB811, BCS-GH811-4, NA], A556: [sorghum, NA, NA, Igrowth (trademark)].

In the present composition or the present method, one or more insecticidally active compounds can be used in combination. Here, combination use includes using together, mixing and sequential treatment. In the case of the sequential treatment, the order is not particularly limited.

Examples of the above-mentioned insecticidally active compounds include the following. The number in parentheses indicates CAS registry No.

abamectin, acephate, acequinocyl, acetamiprid, acetoprole, acrinathrin, acynonapyr, afidopyropen, afoxolaner, alanycarb, aldicarb, allethrin, alpha-cypermethrin, alpha-endosulfan, aluminium phosphide, amitraz, azadirachtin, azamethiphos, azinphos-ethyl, azinphos-methyl, azocyclotin, Bark of Celastrus angulatus, bendiocarb, benfluthrin, benfuracarb, bensultap, benzoximate, benzpyrimoxan, beta-cyfluthrin, beta-cypermethrin, bifenazate, bifenthrin, bilobalide, bioallethrin, bioresmethrin, bistrifluron, borax, boric acid, broflanilide, bromopropylate, buprofezin, butocarboxim, butoxycarboxim, cadusafos, calcium cyanide, calcium phosphide, carbaryl, carbofuran, carbosulfan, cartap hydrochloride, cartap, cevadine, chinomethionat, chlorantraniliprole, chlordane, chlorethoxyfos, chlorfenapyr, chlorfenvinphos, chlorfluazuron, chlormephos, chloropicrin, chlorpyrifos, chlorpyrifos-methyl, chromafenozide, clofentezine, clothianidin, concanamycin A, coumaphos, cryolite, cyanophos, cyantraniliprole, cyclaniliprole, cyclobutrifluram, cycloprothrin, cycloxaprid, cyenopyrafen, cyetpyrafen, cyflumetofen, cyfluthrin, cyhalodiamide, cyhalothrin, cyhexatin, cypermethrin, cyphenothrin, cyproflanilide, cyromazine, dazomet, deltamethrin, demeton-S-methyl, diafenthiuron, diazinon, dichlorvos, dicloromezotiaz, dicofol, dicrotophos, diflovidazin, diflubenzuron, dimefluthrin, dimethoate, dimethylvinphos, dimpropyridaz, dinotefuran, disodium octaborate, disulfoton, DNOC (2-methyl-4,6-dinitrophenol), doramectin, dried leaves of Dryopteris filix-mas, emamectin-benzoate, empenthrin, endosulfan, EPN (O-ethyl O-(4-nitrophenyl) phenylphosphonothioate), epsilon-metofluthrin, epsilon-momfluorothrin, esfenvalerate, ethiofencarb, ethion, ethiprole, ethoprophos, etofenprox, etoxazole, extract of Artemisia absinthium, Extract of Cassia nigricans, extract of Clitoria ternatea, extract of Symphytum officinale, extracts or simulated blend of Chenopodium ambrosioides, extract of Tanacetum vulgare, extract of Urtica dioica, extract of Viscum album, famphur, fenamiphos, fenazaquin, fenbutatin oxide, fenitrothion, fenobucarb, fenoxycarb, fenpropathrin, fenpyroximate, fenthion, fenvalerate, fipronil, flometoquin, flonicamid, fluacrypyrim, fluazaindolizine, fluazuron, flubendiamide, flucycloxuron, flucythrinate, fluensulfone, flufenoprox, flufenoxuron, flufiprole, flumethrin, flupentiofenox, fluopyram, flupyradifurone, flupyrimin, fluralaner, fluvalinate, fluxametamide, formetanate, fosthiazate, furamethrin, furathiocarb, gamma-cyhalothrin, ginkgolide A, ginkgolide B, ginkgolide C, ginkgolide J, ginkgolide M, GS-omega/kappa HXTX-Hvla peptide, halfenprox, halofenozide, heptafiuthrin, heptenophos, hexaflumuron, hexythiazox, potassium salt of hop beta acid, hydramethylnon, hydroprene, imicyafos, imidacloprid, imidaclothiz, imiprothrin, indoxacarb, isocycloseram, isofenphos, isoprocarb, isopropyl-O-(methoxyaminothiophosphoryl)salicylate, isoxathion, ivermectin, kadethrin, kappa-tefluthrin, kappa-bifenthrin, kinoprene, lambda-cyhalothrin, lenoremycin, lepimectin, lime sulfur, lotilaner, lufenuron, machine oil, malathion, mecarbam, meperfluthrin, metaflumizone, metam, methamidophos, methidathion, methiocarb, methomyl, methoprene, methoxychlor, methoxyfenozide, methyl bromide, metofluthrin, metolcarb, metoxadiazone, mevinphos, milbemectin, milbemycin oxime, momfluorothrin, monocrotophos, moxidectin, naled, neem oil, nicofluprole, nicotine, nicotine-sulfate, nitenpyram, novaluron, noviflumuron, oil of the seeds of Chenopodium anthelminticum, omethoate, oxamyl, oxazosulfyl, oxydemeton-methyl, parathion, parathion-methyl, permethrin, phenothrin, phenthoate, phorate, phosalone, phosmet, phosphamidon, phosphine, phoxim, pirimicarb, pirimiphos-methyl, potassium cyanide, prallethrin, profenofos, profluthrin, propargite, propetamphos, propoxur, propylene glycol alginate, prothiofos, pyflubumide, pymetrozine, pyraclofos, pyrethrins, pyridaben, pyridalyl, pyridaphenthion, pyrifluquinazone, pyrimidifen, pyriminostrobin, pyriprole, pyriproxyfen, quinalphos, resmethrin, rotenone, ryanodine, sarolaner, seed extract of Schoenocaulon spp., selamectin, sigma-cypermethrin, silafluofen, sodium borate, sodium cyanide, sodium metaborate, spinetoram, spinosad, spirodiclofen, spiromesifen, spiropidion, spirotetramat, sulfluramid, sulfotep, sulfoxaflor, sulfur, sulfuryl fluoride, tartar emetic, tau-fluvalinate, tebufenozide, tebufenpyrad, tebupirimfos, teflubenzuron, tefluthrin, temephos, terbufos, terpene constituents of the extract of Chenopodium ambrosioides near ambrosioides, Brand name: Terpenoid blend QRD 460, tetrachlorantraniliprole, tetrachlorvinphos, tetradifon, tetramethrin, tetramethylfluthrin, tetraniliprole, theta-cypermethrin, thiacloprid, thiamethoxam, thiocyclam, thiodicarb, thiofanox, thiometon, thiosultap-disodium, thiosultap-monosodium, tioxazafen, tolfenpyrad, tralomethrin, transfluthrin, triazamate, triazophos, trichlorfon, triflumezopyrim, triflumuron, trimethacarb, tyclopyrazoflor, vamidothion, veratridine, wood extract of Quassia amara, XMC (3,5-dimethylphenyl N-methylcarbamate), xylylcarb, zeta-cypermethrin, zinc phosphide, N-[3-chloro-1-(pyridin-3-yl)-1H-pyrazol-4-yl]-N-ethyl-3-(3,3,3-trifluoropropanesulfinyl)propaneamide (1477923-37-7), 4-[5-(3,5-dichlorophenyl)-5-(trifluoromethyl)-4,5-dihydro-1,2-oxazol-3-yl]-2-methyl-N-(1-oxothietan-3-yl)benzamide (1241050-20-3), 3-methoxy-N-(5-{5-(trifluoromethyl)-5-[3-(trifluoromethyl)phenyl]-4,5-dihydro-1,2-oxazol-3-yl}indan-1-yl)propaneamide (1118626-57-5), 2-({2-fluoro-4-methyl-5-[(2,2,2-trifluoroethyl)sulfinyl]phenyl}imino)-3-(2,2,2-trifluoroethyl)-1,3-thiazolidin-4-one (1445683-71-5), N-[(1S,2S)-2-(2,4-dichlorophenyl)cyclobutyl]-2-(trifluoromethyl)pyridine-3-carboxamide, (3R)-3-(2-chlorothiazol-5-yl)-8-methyl-7-oxo-6-phenyl-2,3-dihydrothiazolo[3,2-a]pyrimidin-4-ium-5-olate (2249718-27-0), N-{4-chloro-3-[(1-cyanocyclopropyl)carbamoyl]phenyl}-1-methyl-4-(methanesulfonyl)-3-(1,1,2,2,2-pentafluoroethyl)-1H-pyrazole-3-carboxamide (1400768-21-9), 11-(4-chloro-2,6-dimethylphenyl)-12-hydroxy-1,4-dioxa-9-azadispiro[4.2.4.2]tetradec-11-en-10-one (907187-07-9), 3-(4′-fluoro-2,4-dimethyl[1,1′-biphenyl]-3-yl)-4-hydroxy-8-oxa-1-azaspiro[4.5]dec-3-en-2-one (1031385-91-7), N-[3-chloro-1-(pyridin-3-yl)-1H-pyrazol-4-yl]-2-(methanesulfonyl)propanamide (2396747-83-2), 1,4-dimethyl-2-[2-(3-pyridinyl)-2H-indazol-5-yl]-1,2,4-triazolidine-3,5-dione (2171099-09-3), 2-isopropyl-5-[(3,4,4-trifluoro-3-buten-1-yl)sulfonyl]-1,3,4-thiadiazole (2058052-95-0), BT crop protein Cry1Ab, BT crop protein Cry1Ac, BT crop protein Cry1Fa, BT crop protein Cry1A.105, BT crop protein Cry2Ab, BT crop protein Vip3A, BT crop protein Cry3A, BT crop protein Cry3Ab, BT crop protein Cry3Bb, BT crop protein Cry34Ab1/Cry35Ab1, Arthrobotrys dactyloides, Bacillus firmus, (trade name: BioSafe, BioNem), strain: GB-126, starain: I-1582 (trade name: VOTIVO), etc.), Bacillus megaterium, strain: YFM3.25 (trade name: Bioarc), etc.), Bacillus sp. (strain: AQ175, AQ177, AQ178, etc.), Bacillus sphaericus (strain: 2362, ABTS1743 (trade name: VectoMax), Serotype H5a5b), Bacillus thuringiensis (strain: AQ52, BD #32, CR-371), Bacillus thuringiensis subsp. aizawai (strain: ABTS-1857 (trade name: XenTari), AM65-52, GC-91 (trade name: Agree/Turex/Able), Serotype H-7 (trade name: Florbac WG), etc.), Bacillus thuringiensis subsp. Kurstaki ((trade name: Asututo, Turilav WP), strain: ABTS351, BMP123 (trade name: Baritone Bio-Insecticide), EG234, EG7841 (trade name: Crymax), EVB113-19 (trade name: Bioprotec-CAF), F810, HD-1 (trade name: Dipel ES), PB54, SA-11 (trade name: Javelin), SA-12 (trade name: Deliver/CoStar, Thuricide), etc.), Bacillus thuringiensis subsp. morrisoni, Bacillus thuringiensis subsp. tenebriosis (strain: NB 176 (trade name: Novodor), etc.), Bacillus thuringiensis subsp. Thuringiensis (strain: MPPL002), Bacillus thuringiensis subsp. var. colmeri (trade name: TianBaoBtc), Bacillus thuringiensis subsp. var. darmstadiensis (strain: 24-91, etc.), Bacillus thuringiensis subsp. var. dendrolimus, Bacillus thuringiensis subsp. var. galleriae, Bacillus thuringiensis subsp. var. israelensis ((trade name: BMP123, Aquabac, VectoBac), strain: BMP144, serotypeH-14, etc.), Bacillus thuringiensis subsp. var. japonensis buibui, Bacillus thuringiensis subsp. var. aegypti, Bacillus thuringiensis var. 7216, Bacillus thuringiensis var. sandiego, strain: M-7 (trade name: M-Ome), etc.), Bacillus thuringiensis var. T36, Beauveria bassiana (trade name: Beaugenic, Brocaril), strain: ANT-03, ATCC74040 (trade name: Naturalis), GHA (trade name: Mycotrol ES, Mycotrol O, BotaniGuard), etc.), Beauveria brongniartii ((trade name: Engerlingspilz, Schweizer Beauveria, Melocont)), Burkholderia rinojensis (strain: A396, etc.), Chromobacterium subtsugae (strain: PRAA4-1T (trade name: Grandevo), etc.), Dactyllela ellipsospora, Dectylaria thaumasia, Hirsutella minnesotensis, Hirsutella rhossiliensis, Hirsutella thompsonii, Lagenidium giganteum (trade name: Laginex, etc.), Lecanicillium lecanii (strain: KV01, conidia of strain DAOM198499, conidia of strain DAOM216596, etc.), Metarhizium anisopliae (strain: F52 (trade name: Met52), etc.), Metarhizium flavoviride, Metarhizium anisopliae var. acridum, Monacrosporium phymatopagum, Paecilomyces fumosoroseus (strain: Apopka 97 (trade name: PFR-97, PreFeral), etc.), Paecilomyces lilacinus (strain: 251, etc.), Paecilomyces tenuipes (strain: T1, etc.), Paenibacillus popilliae, Pasteuria nishizawae (trade name: oyacyst LF/ST, strain; Pn1, etc.), Pasteuria penetrans (trade name: Pasteuria, etc.), Pasteuria thoynei, Pasteuria usage (trade name: Econem, etc.), Serratia entomophila (trade name: Invade, etc.), Verticillium chlamydosporium, Verticillium lecani (strain: NCIM1312 (trade name: MEALIKIL), etc.), Adoxophyes orana granulosis virus, Anticarsia gemmatalis mNPV, Autographa californica mNPV FV #11, Cydia pomonella GV V15, Cydia pomonella GV V22, Cryptophlebia leucotreta GV, Dendrolimus punctatus cypovirus, Helicoverpa armigera NPV BV-0003, Helicoverpa zea NPV, Lymantria dispar NPV, Mamestra configurata NPV, Mamestra brassicae NPV, Neodiprion abietis NPV, Neodiprion lecontei NPV, Neodiprion sertifer NPV, Nosema locustae, Orgyia pseudotsugata NPV, Pieris rapae GV, Plodia interpunctella GV, Spodoptera exigua mNPV, Spodoptera littoralis mNPV, Spodoptera litura NPV.

In the present composition or the present method, one or more synergists can be used in combination. Here, combination use includes using together, mixing and sequential treatment. In the case of the sequential treatment, the order is not particularly limited. Specific examples of the synergist include the following. 1-dodecyl-1H-imidazole, N-(2-ethylhexyl)-8,9,10-trinorborn-5-ene-2,3-dicarboximide, N,N-dibutyl-4-chlorobenzenesulfonamide, bucarpolate, dietholate, diethylmaleate, iprobenfos, piperonyl butoxide, piperonyl cyclonene, piprotal, propyl isome, safroxan, sesamex, sesamolin, sulfoxide, tribufos, verbutin, DMC (1,1-bis(4-chiorophenyl)ethanol), FDMC (1,1-bis(4-chlorophenyl)-2,2,2-trifluoroethanol), ETN (1,2-epoxy-1,2,3,4-tetrahydronaphthalene), ETP (1,1,1-trichloro-2,3-expoxypropane), PSCP (phenylsaligenin cyclic phosphate), TBPT (S,S,S-tributyl phosphorotrithioate), TPP (triphenyl phosphate).

In the present composition or the present method, one or more bactericidally active compounds can be used in combination. Here, combination use includes using together, mixing and sequential treatment. In the case of the sequential treatment, the order is not particularly limited.

Examples of the bactericidally active compound include nucleic acid synthesis inhibitors (e.g., phenylamide-based fungicide, acylamino acid-based fungicides), cell division and cytoskeleton inhibitors (e.g., MBC fungicide), respiratory inhibitors (e.g., QoI fungicides, QiI fungicides, SDHI fungicides), amino acid synthesis and protein synthesis inhibitors (e.g., anilinopyridine-based fungicides), signal transduction inhibitor, lipid synthesis and membrane synthesis inhibitors, sterol biosynthesis inhibitors (e.g., triazole-based DMI fungicides), ectoblast synthesis inhibitors, melanin synthesis inhibitors, plant defense inducers, multisite fungicides, microbial fungicides and other fungicides (group consisting of bactericidally active components). These bactericidally active compounds are mentioned in classification based on mechanism of action of FRAC.

Specific compounds are listed below. These compounds are common compounds and can be found, for example, in The Pesticide Manual, 17th edition, published by BCPC. The number in parentheses indicates CAS RN (registered trademark).

acibenzolar-S-methyl, aldimorph, ametoctradin, aminopyrifen, amisulbrom, ammonium salts of phosphorous acid, anilazine, azaconazole, azoxystrobin, basic copper sulfate, benalaxyl, benalaxyl-M, benodanil, benomyl, benthiavalicarb, benthiavalicarb-isopropyl, benzovindiflupyr, binapacryl, biphenyl, bitertanol, bixafen, blasticidin-S, Bordeaux mixture, boscalid, bromothalonil, bromuconazole, bupirimate, calcium salts of phosphorous acid, captafol, captan, carbendazim, carboxin, carpropamid, chinomethionat, chitin, chloroneb, chlorothalonil, chlozolinate, colletochlorin B, copper(II) acetate, copper(II) hydroxide, copper oxychloride, copper(II) sulfate, coumoxystrobin, cyazofamid, cyflufenamid, cymoxanil, cyproconazole, cyprodinil, dichlobentiazox, dichlofluanid, diclocymet, diclomezine, dicloran, diethofencarb, difenoconazole, diflumetorim, dimethachlone, dimethirimol, dimethomorph, dimoxystrobin, diniconazole, diniconazole-M, dinocap, dipotassium hydrogenphosphite, dipymetitrone, dithianon, dodecylbenzenesulphonic acid bisethylenediamine copper(II) salt, dodemorph, dodine, edifenphos, enoxastrobin, epoxiconazole, etaconazole, ethaboxam, ethirimol, etridiazole, extract from Melaleuca alternifolia, extract from Reynoutria sachalinensis, extract from the cotyledons of lupine plantlets (“BLAD”), extract of Allium sativum, extract of Equisetum arvense, extract of Tropaeolum majus, famoxadone, fenamidone, fenaminstrobin, fenarimol, fenbuconazole, fenfuram, fenhexamid, fenoxanil, fenpiclonil, fenpicoxamid, fenpropidin, fenpropimorph, fenpyrazamine, fentin acetate, fentin chloride, fentin hydroxide, ferbam, ferimzone, florylpicoxamid, fluazinam, flubeneteram, fludioxonil, flufenoxystrobin, fluindapyr, flumorph, fluopicolide, fluopimomide, fluoxapiprolin, fluoxastrobin, fluquinconazole, flusilazole, flusulfamide, flutianil, flutolanil, flutriafol, fluxapyroxad, folpet, fosetyl, fosetyl-aluminium, fuberidazole, furalaxyl, furametpyr, guazatine, hexaconazole, hymexazole, imazalil, imibenconazole, iminoctadine, iminoctadine triacetate, inpyrfluxam, iodocarb, ipconazole, ipfentrifluconazole, ipflufenoquin, iprobenfos, iprodione, iprovalicarb, isofetamid, isoflucypram, isoprothiolane, isopyrazam, isotianil, kasugamycin, kresoxim-methyl, laminarin, leaves and bark of Quercus, mancozeb, mandestrobin, mandipropamid, maneb, mefentrifluconazole, mepanipyrim, mepronil, meptyldinocap, metalaxyl, metalaxyl-M, metconazole, methasulfocarb, metiram, metominostrobin, metrafenone, metyltetraprole, mineral oils, myclobutanil, naftifine, neem oil, nuarimol, octhilinone, ofurace, orysastrobin, oxadixyl, oxathiapiprolin, oxine-copper, oxolinic acid, oxpoconazole, oxpoconazole fumarate, oxycarboxin, oxytetracycline, pefurazoate, penconazole, pencycuron, penflufen, penthiopyrad, phenamacril, phosphorous acid, phthalide, picarbutrazox, picoxystrobin, piperalin, polyoxins, potassium hydrogencarbonate, potassium dihydrogenphosphite, probenazole, prochloraz, procymidone, propamidine, propamocarb, propiconazole, propineb, proquinazid, prothiocarb, prothioconazole, pydiflumetofen, pyraclostrobin, pyrametostrobin, pyraoxystrobin, pyrapropoyne, pyraziflumid, pyrazophos, pyribencarb, pyributicarb, pyridachlometyl, pyrifenox, pyrimethanil, pyrimorph, pyriofenone, pyrisoxazole, pyroquilon, Quillaja extract, quinconazole, quinofumelin, quinoxyfen, quintozene, Saponins of Chenopodium quinoa, sodium hydrogencarbonate, sedaxane, silthiofam, simeconazole, sodium salts of phosphorous acid, spiroxamine, streptomycin, sulfur, tebuconazole, tebufloquin, teclofthalam, tecnazene, terbinafine, tetraconazole, thiabendazole, thifluzamide, thiophanate, thiophanate-methyl, thiram, thymol, tiadinil, tolclofos-methyl, tolfenpyrad, tolprocarb, tolylfluanid, triadimefon, triadimenol, triazoxide, triclopyricarb, tricyclazole, tridemorph, trifloxystrobin, triflumizole, triforine, triticonazole, validamycin, valifenalate, vinclozolin, yellow mustard powder, zineb, zinc thiazole, ziram, zoxamide, 3-(difluoromethyl)-N-methoxy-1-methyl-N-[(1R)-1-methyl-2-(2,4,6-trichlorophenyl)ethyl]pyrazole-4-carboxamide (1639015-48-7), 3-(difluoromethyl)-N-methoxy-1-methyl-N-[(1S)-1-methyl-2-(2,4,6-trichlorophenyl)ethyl]pyrazole-4-carboxamide (1639015-49-8), 3-(difluoromethyl)-1-methyl-N-(1,1,3-trimethylindan-4-yl)pyrazole-4-carboxamide (141573-94-6), 3-(difluoromethyl)-N-[(3R)-7-fluoro-1,1,3-trimethylindan-4-yl]-1-methylpyrazole-4-carboxamide (1513466-73-3), N′-[4-({3-[(4-chlorophenyl)methyl]-1,2,4-thiadiazol-5-yl}oxy)-2,5-dimethylphenyl]-N-ethyl-N-methylmethaneimideamide (1202781-91-6), N′-{4-[(4,5-dichlorothiazol-2-yl)oxy]-2,5-dimethylphenyl}-N-ethyl-N-methylmethane imidamide (929908-57-6), N′-(2,5-dimethyl-4-phenoxyphenyl)-N-ethyl-N-methylmethane imidamide (1052688-31-9), N′-[5-chloro-4-(2-fluorophenoxy)-2-methylphenyl]-N-ethyl-N-methylmethane imidamide (2055589-28-9), N′-[2-chloro-4-(2-fluorophenoxy)-5-methylphenyl]-N-ethyl-N-methylmethane imidamide (2055756-21-1), N′-[4-(1-hydroxy-1-phenyl-2,2,2-trifluoroethyl)-2-methyl-5-methoxyphenyl]-N-isopropyl-N-methylmethane imidamide (2101814-55-3), N′-[5-bromo-6-(1-methyl-2-propoxyethoxy)-2-methylpyridin-3-yl]-N-ethyl-N-methylmethane imidamide (1817828-69-5), 4-(2-bromo-4-fluorophenyl)-N-(2-chloro-6-fluorophenyl)-1,3-dimethyl-1H-pyrazol-5-amine (1362477-26-6), 2-[6-(3-fluoro-4-methoxyphenyl)-5-methylpyridin-2-yl]quinazoline (1257056-97-5), 5-fluoro-4-imino-3-methyl-1-tosyl-3,4-dihydroaminopyrimidin-2(1H)-one (1616664-98-2), ethyl (2Z)-3-amino-2-cyano-3-phenylacrylate (39491-78-6), N-[(2-chlorothiazol-5-yl)methyl]-N-ethyl-6-methoxy-3-nitropyridine-2-amine (1446247-98-8), α-[3-(4-chloro-2-fluorophenyl)-5-(2,4-difluorophenyl)-4-isooxazolyl]-3-pyridine methanol (1229605-96-2), (aS)-[3-(4-chloro-2-fluorophenyl)-5-(2,4-difluorophenyl)-4-isooxazolyl]-3-pyridine methanol (1229606-46-5), (aR)-[3-(4-chloro-2-fluorophenyl)-5-(2,4-difluorophenyl)-4-isooxazolyl]-3-pyridine methanol (1229606-02-3), 5-(4-chlorobenzyl)-2-chloromethyl-2-methyl-1-(1H-1,2,4-triazol-1-ylmethyl)cyclopentanol (1394057-11-4), (1R,2S,5S)-5-(4-chlorobenzyl)-2-chloromethyl-2-methyl-1-(1H-1,2,4-triazol-1-ylmethyl)cyclopentanol (1801930-06-2), (1S,2R,5R)-5-(4-chlorobenzyl)-2-chloromethyl-2-methyl-1-(1H-1,2,4-triazol-1-ylmethyl)cyclopentanol (1801930-07-3), (1R,2R,5R)-5-(4-chlorobenzyl)-2-chloromethyl-2-methyl-1-(1H-1,2,4-triazol-1-ylmethyl)cyclopentanol (1801919-53-8), (1S,2S,5S)-5-(4-chlorobenzyl)-2-chloromethyl-2-methyl-1-(1H-1,2,4-triazol-1-ylmethyl)cyclopentanol (1801919-54-9), (1R,2R,5S)-5-(4-chlorobenzyl)-2-chloromethyl-2-methyl-1-(1H-1,2,4-triazol-1-ylmethyl)cyclopentanol (1801919-55-0), (1S,2S,5R)-5-(4-chlorobenzyl)-2-chloromethyl-2-methyl-1-(1H-1,2,4-triazol-1-ylmethyl)cyclopentanol (1801919-56-1), (1R,2S,5R)-5-(4-chlorobenzyl)-2-chloromethyl-2-methyl-1-(1H-1,2,4-triazol-1-ylmethyl)cyclopentanol (1801919-57-2), (1S,2R,5S)-5-(4-chlorobenzyl)-2-chloromethyl-2-methyl-1-(1H-1,2,4-triazol-1-ylmethyl)cyclopentanol (1801919-58-3), 2-chloromethyl-5-(4-fluorobenzyl)-2-methyl-1-(1H-1,2,4-triazol-1-ylmethyl)cyclopentanol (1394057-13-6), (1R,2S,5S)-2-chloromethyl-5-(4-fluorobenzyl)-2-methyl-1-(1H-1,2,4-triazol-1-ylmethyl)cyclopentanol (1801930-08-4), (1S,2R,5R)-2-chloromethyl-5-(4-fluorobenzyl)-2-methyl-1-(1H-1,2,4-triazol-1-ylmethyl)cyclopentanol (1801930-09-5), (1R,2R,5R)-2-chloromethyl-5-(4-fluorobenzyl)-2-methyl-1-(1H-1,2,4-triazol-1-ylmethyl)cyclopentanol (1638898-08-4), (1S,2S,5S)-2-chloromethyl-5-(4-fluorobenzyl)-2-methyl-1-(1H-1,2,4-triazol-1-ylmethyl)cyclopentanol (1638898-10-8), (1R,2R,5S)-2-chloromethyl-5-(4-fluorobenzyl)-2-methyl-1-(1H-1,2,4-triazol-1-ylmethyl)cyclopentanol (1638898-13-1), (1S,2S,5R)-2-chloromethyl-5-(4-fluorobenzyl)-2-methyl-1-(1H-1,2,4-triazol-1-ylmethyl)cyclopentanol (1638898-16-4), (1R,2S,5R)-2-chloromethyl-5-(4-fluorobenzyl)-2-methyl-1-(1H-1,2,4-triazol-1-ylmethyl)cyclopentanol (1638898-20-0), (1S,2R,5S)-2-chloromethyl-5-(4-fluorobenzyl)-2-methyl-1-(1H-1,2,4-triazol-1-ylmethyl)cyclopentanol (1638898-24-4), methyl=3-[(4-chlorophenyl)methyl]-2-hydroxy-1-methyl-2-(1H-1,2,4-triazol-1-ylmethyl)cyclopentane carboxylate (1791398-02-1), methyl=(1R,2S,3S)-3-[(4-chlorophenyl)methyl]-2-hydroxy-1-methyl-2-(1H-1,2,4-triazol-1-ylmethyl)cyclopentane carboxylate (2080743-90-2), methyl=(1S,2R,3R)-3-[(4-chlorophenyl)methyl]-2-hydroxy-1-methyl-2-(1H-1,2,4-triazol-1-ylmethyl)cyclopentane carboxylate (2080743-91-3), methyl=(1R,2R,3R)-3-[(4-chlorophenyl)methyl]-2-hydroxy-1-methyl-2-(1H-1,2,4-triazol-1-ylmethyl)cyclopentane carboxylate (2080743-92-4), methyl=(1S,2S,3S)-3-[(4-chlorophenyl)methyl]-2-hydroxy-1-methyl-2-(1H-1,2,4-triazol-1-ylmethyl)cyclopentane carboxylate (2080743-93-5), methyl=(1R,2R,3S)-3-[(4-chlorophenyl)methyl]-2-hydroxy-1-methyl-2-(1H-1,2,4-triazol-1-ylmethyl)cyclopentane carboxylate (2080743-94-6), methyl=(1S,2S,3R)-3-[(4-chlorophenyl)methyl]-2-hydroxy-1-methyl-2-(1H-1,2,4-triazol-1-ylmethyl)cyclopentane carboxylate (2080743-95-7), methyl=(1R,2S,3R)-3-[(4-chlorophenyl)methyl]-2-hydroxy-1-methyl-2-(1H-1,2,4-triazol-1-ylmethyl)cyclopentane carboxylate (2081061-22-3), methyl=(1S,2R,3S)-3-[(4-chlorophenyl)methyl]-2-hydroxy-1-methyl-2-(1H-1,2,4-triazol-1-ylmethyl)cyclopentane carboxylate (2081061-23-4), 1-(2,4-difluorophenyl)-2-(1H-1,2,4-triazol-1-yl)-1-[1-(4-bromo-2,6-difluorophenoxy)cyclopropyl]ethanol (2019215-86-0), 1-(2,4-difluorophenyl)-2-(1H-1,2,4-triazol-1-yl)-1-[1-(4-chloro-2,6-difluorophenoxy)cyclopropyl]ethanol (2019215-84-8), 1-[2-(l-chlorocyclopropyl)-3-(2-fluorophenyl)-2-hydroxypropyl]-1H-imidazole-5-carbonitrile (2018316-13-5), 1-[2-(1-chlorocyclopropyl)-3-(2,3-difluorophenyl)-2-hydroxypropyl]-1H-imidazole-5-carbonitrile (2018317-25-2), 2-[6-(4-bromophenoxy)-2-(trifluoromethyl)pyridin-3-yl]-1-(1H-1,2,4-triazol-1-yl)propan-2-ol (2082661-43-4), 2-[6-(4-chlorophenoxy)-2-(trifluoromethyl)pyridin-3-yl]-1-(1H-1,2,4-triazol-1-yl)propan-2-ol (2082660-27-1), methyl=({2-methyl-5-[1-(4-methoxy-2-methylphenyl)-1H-pyrazol-3-yl]phenyl}methyl)carbamate (1605879-98-8), 2-(difluoromethyl)-N-[1,1,3-trimethyl-2,3-dihydro-1H-inden-4-yl]pyridine-3-carboxamide (1616239-21-4), 2-(difluoromethyl)-N-[(3R)-1,1,3-trimethyl-2,3-dihydro-1H-inden-4-yl]pyridine-3-carboxamide (1616239-33-8), 2-(difluoromethyl)-N-[3-ethyl-1,1-dimethyl-2,3-dihydro-1H-inden-4-yl]pyridine-3-carboxamide (1847460-02-9), 2-(difluoromethyl)-N-[(3R)-3-ethyl-1,1-dimethyl-2,3-dihydro-1H-inden-4-yl]pyridine-3-carboxamide (1952305-97-3), 2-(difluoromethyl)-N-[3-propyl-1,1-dimethyl-2,3-dihydro-1H-inden-4-yl]pyridine-3-carboxamide (1847460-05-2), 2-(difluoromethyl)-N-[(3R)-3-propyl-1,1-dimethyl-2,3-dihydro-1H-inden-4-yl]pyridine-3-carboxamide (1952306-00-1), (2E,3Z)-5-{[1-(4-chlorophenyl)-1H-pyrazol-3-yl]oxy}-2-(methoxyimino)-N,3-dimethylpent-3-enamide (1445331-27-0), (2E,3Z)-5-{[1-(2,4-dichlorophenyl)-1H-pyrazol-3-yl]oxy}-2-(methoxyimino)-N,3-dimethylpent-3-enamide (1445331-54-3), 5-chloro-4-({2-[6-(4-chlorophenoxy)pyridin-3-yl)ethyl]amino}-6-methylpyrimidine (1605340-92-8), N-[1-benzyl-1,3-dimethylbutyl]-8-fluoroquinoline-3-carboxamide (2132414-04-9), N-[(1S)-1-benzyl-1,3-dimethylbutyl]-8-fluoroquinoline-3-carboxamide, N-[1-benzyl-3,3,3-trifluoro-1-methylpropyl]-8-fluoroquinoline-3-carboxamide (2132414-00-5), N-[(1S)-1-benzyl-3,3,3-trifluoro-1-methylpropyl]-8-fluoroquinoline-3-carboxamide (2132414-01-6), N-[(1R)-1-benzyl-1,3-dimethylbutyl]-8-fluoroquinoline-3-carboxamide (2132414-06-1), 4,4-dimethyl-2-({4-[5-(trifluoromethyl)-1,2,4-oxadiazol-3-yl]phenyl}methyl)isoxazolidin-3-one (2098918-25-1), 5,5-dimethyl-2-({4-[5-(trifluoromethyl)-1,2,4-oxadiazol-3-yl]phenyl}methyl)isoxazolidin-3-one (2098918-26-2), N-acetyl-2-(ethanesulfonyl)-N-[2-(methoxycarbonyl)-4-(trifluoromethoxy)phenyl]-4-(trifluoromethyl)benzamide (2043675-28-9), (2S,3S)-3-(2-methylphenyl)butan-2-yl N-[(3-acetoxy-4-methoxypyridin-2-yl)carbonyl]-L-alaninate (2376210-00-1), (2S,3S)-3-(4-fluoro-2-methylphenyl)butan-2-yl N-[(3-acetoxy-4-methoxypyridin-2-yl)carbonyl]-L-alaninate, (2S,3S)-3-(4-methoxy-2-methylphenyl)butan-2-yl N-[(3-acetoxy-4-methoxypyridin-2-yl)carbonyl]-L-alaninate, (2S,3S)-3-(2,4-dimethylphenyl)butan-2-yl N-[(3-acetoxy-4-methoxypyridin-2-yl)carbonyl]-L-alaninate (2376209-13-9), (2S,3S)-3-(2-methylphenyl)butan-2-yl N-({3-[(2-methylpropanoyl)oxy]-4-methoxypyridin-2-yl)carbonyl]-L-alaninate (2376210-02-3), (2S,3S)-3-(4-fluoro-2-methylphenyl)butan-2-yl N-({3-[(2-methylpropanoyl)oxy]-4-methoxypyridin-2-yl)carbonyl]-L-alaninate, (2S,3S)-3-(4-methoxy-2-methylphenyl)butan-2-yl N-({3-[(2-methylpropanoyl)oxy]-4-methoxypyridin-2-yl)carbonyl]-L-alaninate (2376209-40-2), (2S,3S)-3-(2,4-dimethylphenyl)butan-2-yl N-({3-[(2-methylpropanoyl)oxy]-4-methoxypyridin-2-yl)carbonyl]-L-alaninate (2376209-15-1), Agrobacterium radiobacter, strain: K84 (trade name: Galltrol-A), K1026 (trade name: Nogall), etc.), Bacillus amyloliquefaciens (strain: AT332, B3, D747 (trade name: Bacstar, Double Nickel), DB101 (trade name: Shelter), DB102 (trade name: Artemis), FZB24, FZB42 (trade name: RhizoVital), GB03 (trade name: Kodiak), IN937a, MBI600 (trade name: Subtilex), QST713, isolate B246, F727 (trade name: Stargus), etc.), Bacillus licheniformis (strain: HB-2 (trade name: Biostart, Rhizoboost), SB3086 (trade name: EcoGuard, Green Releaf), etc.), Bacillus pumilus (strain: AQ717, BUF-33 (trade name: Integral F-33), GB34 (trade name: Yield Shield), QST2808 (trade name: Sonata, Ballad Plus), etc.), Bacillus simplex (strain: CGF2856, etc.), Bacillus subtilis (strain: AQ153, AQ743, D747, DB101, FZB24, GB03, HAI0404, IAB/BS03, MBI600, QST30002/AQ30002, QST30004/AQ30004, QST713 (trade name: CEASE, Serenade, Serenade-DPZ, Rhapsody, MAX), QST714 (trade name: JAZZ), Y1336, BU1814, etc.), Bacillus subtilis var. Amyloliquefaciens (strain: FZB24, etc.), Burkholderia cepacia (trade name: Deny, Intercept, Blue Circle), Burkholderia cepacia type Wisconsin (strain: M54, J82, etc.), Candida oleophila (strain: O, etc.), Candida saitoana (trade name: Bio-Coat, Biocure, etc.), Candida spp., Chaetomium cupreum, Clonostachys rosea (trade name: EndoFine, etc.), Coniothyrium minitans (strain: CGMCC8325, CON/M/91-08 (trade name: Cotans), etc.), Cryptococcus albidus (trade name: Yield plus, etc.), Erwinia carotovora sunsp. Cartovora (strain: CGE234M403 (trade name: Biokeeper), etc.), Fusarium oxysporum (strain: Fo47 (trade name: Fusaclean, BiofoxC), etc.), Gliocladium catenulatum (strain: J1446 (trade name: primastop, Prestop), etc.), Paenibacillus polymyxa (strain: AC-1 (trade name: Topseed), BS-0105, etc.), Pantoea agglomerans (strain: E325, etc.), Phlebiopsis gigantea (trade name: Rotstop, strain: VRA1992, etc.), Pseudomonas aureofaciens (strain: TX-1, etc.), Pseudomonas chlororaphis (strain: 63-28 (trade name: ATEze), MA342 (trade name: Cedomon), Pseudomonas fluorescens (strain: 1629RS (trade name: Frostban D), A506 (trade name: BlightBan, Frostban B), CL145A (trade name: Zequanox), G7090, etc.), Pseudomonas sp. CAB-02, Pseudomonas syringae (strain: 742RS (trade name: Frostaban C), MA-4 (trade name: Bio-Save), etc.), Pseudozyma flocculosa (strain: PF-A22UL (trade name: Sporadex L), etc.), Pythium oligandrum (strain: DV74 (trade name: Polyversum), etc.), Streptomyces griseoviridis (strain: K61, etc.), Streptomyces lydicus (strain: WYCD108US, WYEC108 (trade name: Actinovate), etc.), Talaromyces flavus (strain: SAY-Y-94-01 (trade name: Toughblock), V117b (trade name: Protus), etc.), Trichoderma asperellum (strain: ICC012, T34, SKT-1, etc.), Trichoderma atroviride (trade name: Plantmate, strain: CNCM 1-1237, LC52 (trade name: Sentinel), SC1, SKT-1 (trade name: Ecohope), etc.), Trichoderma gamsii (strain: ICC080 (trade name: BioDerma), etc.), Trichoderma harzianum (rain: 21, DB104, DSM 14944, ESALQ-1303, ESALQ-1306, IIHR-Th-2, ITEM908 (trade name: Trianum-P), kd (trade name: Trichoplus, Eco-T), M01, SF, T22, T39, TH35 (trade name: Root-Pro, etc.), Trichoderma harzianum rifai (strain: T39, etc.), Trichoderma polysporum (trade name: Binab T, strain: IMI206039, etc.), Trichoderma stromaticum (trade name: Tricovab, etc.), Trichoderma virens (strain: G-41, GL-21 (formerly Gliocladium virens GL-21, trade name: SoilGgard), etc.), Trichoderma viride, Variovorax paradoxus (strain: GF4526, etc.), Harpin protein.

The present method may include a step of applying one or more compounds selected from the compound group A to crop seeds and/or a step of applying one or more compounds selected from the compound group B to the foliage of crops in the growing season of crops.

In the present method, the compound group A is the group consisting of neonicotinoid-based compounds, diamide-based compounds, carbamate-based compounds, organophosphorus-based compounds, biological nematicide compounds, other insecticide compounds and nematicide compounds, as well as azole-based compounds, strobilurin-based compounds, metalaxyl-based compounds, SDHI compounds, and other fungicide compounds and plant growth regulators.

In the present method, examples of the neonicotinoid-based compound to be applied to crop seeds include the following.

clothianidin, imidacloprid, nitenpyram, acetamiprid, thiamethoxam, flupyradifurone, sulfoxaflor, triflumezopyrim, dicloromezotiaz, thiacloprid and dinotefuran.

In the present method, examples of the diamide-based compound to be applied to crop seeds include the following. flubendiamide, chlorantraniliprole, cyantraniliprole, cyclaniliprole, broflanilide, tetraniliprole and cyhalodiamide.

In the present method, examples of the carbamate-based compound to be applied to crop seeds include the following. aldicarb, oxamyl, thiodicarb, carbofuran, carbosulfan and dimethoate.

In the present method, examples of the organophosphorus-based compound to be applied to crop seeds include the following.

fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan and phosphamidon.

In the present method, examples of the biological nematicide compound to be applied to crop seeds include the following.

Harpin Protein, Pasteuria nishizawae, Pasteuria penetrans, Pasteuria usage, Myrothecium verrucaria, Burholderia cepacia, Bacillus chitonosporus, Paecilomyces lilacinus, Bacillus amyloliquefaciens, Bacillus firmus, Bacillus subtilis, Bacillus pumulus, Trichoderma harzianum, Hirsutella rhossiliensis, Hirsutella minnesotensis, Verticillium chlamydosporum and Arthrobotrys dactyloides.

In the present method, examples of other insecticide compounds and nematicide compounds to be applied to crop seeds include the following.

fipronil, ethiprole, beta-cyfluthrin, tefluthrin, chlorpyrifos, abamectin, spirotetramat, tioxazafen, fluazaindolizine, fluensulfone and fluxametamide.

In the present method, examples of the azole-based compound to be applied to crop seeds include the following. azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, prochloraz, triflumizole, ipfentrifluconazole and mefentrifluconazole.

In the present method, examples of the strobilurin-based compound to be applied to crop seeds include the following.

kresoxim-methyl, azoxystrobin, trifloxystrobin, fluoxastrobin, picoxystrobin, pyraclostrobin, dimoxystrobin, pyribencarb, metominostrobin, orysastrobin and mandestrobin.

In the present method, examples of the metalaxyl-based compound to be applied to crop seeds include the following. metalaxyl and metalaxyl-M or mefenoxam.

In the present method, examples of the SDHI compound to be applied to crop seeds include the following. sedaxane, penflufen, carboxin, boscalid, furametpyr, flutolanil, fluxapyroxad, isopyrazam, fluopyram, isofetamid, pyraziflumid, pydiflumetofen, N-(7-fluoro-1,1,3-trimethylindan-4-yl)-1-methyl-3-difluoromethylpyrazole-4-carboxylic acid amide (hereinafter, a compound including a racemate or an enantiomer, and a mixture of any ratio of R-enantiomer and S-enantiomer, an enantiomer ratio of the compound being 80/20 or more in terms of R-form/S-form (R-form rich) is sometimes referred to as F9990), N-(1,1,3-trimethylindan-4-yl)-1-methyl-3-difluoromethylpyrazole-4-carboxylic acid amide (hereinafter, a compound including a racemate or an enantiomer, and a mixture of any ratio of R-enantiomer and S-enantiomer, an enantiomer ratio of the compound being 80/20 or more in terms of R-form/S-form (R-form rich) is sometimes referred to as compound 1), and thifluzamide.

In the present method, examples of the plant growth regulator to be applied to crop seeds include the following. ethephon, chlormequat-chloride, mepiquat-chloride, 4-oxo-4-(2-phenylethyl)aminobutyric acid (hereinafter sometimes referred to as compound 2).

In the present method, examples of other fungicide compounds to be applied to crop seeds include the following. tolclofos-methyl, thiram, Captan, carbendazim, thiophanate-methyl, mancozeb, thiabendazole, isotianil, triazoxide, picarbutrazox and oxathiapiprolin.

All compounds constituting the compound group A are common compounds and can be synthesized based on known technical documents, and it is also possible to use commercially available formulations and standard purchased.

In the present method, the compound group B is the group consisting of strobilurin-based compounds, azole-based compounds, SDHI compounds, other fungicide compounds, pyrethroid-based compounds, benzoylphenyl urea compounds, organophosphorus-based insecticide compounds, neonicotinoid-based compounds and diamide-based compounds.

In the present method, examples of the strobilurin-based compound to be applied to the foliage of crops include the following.

pyraclostrobin, azoxystrobin, mandestrobin, trifloxystrobin and picoxystrobin.

In the present method, examples of the azole-based compound to be applied to the foliage of crops include the following.

prothioconazole, epoxiconazole, tebuconazole, cyproconazole, propiconazole, metconazole, bromuconazole, tetraconazole, triticonazole, ipfentrifluconazole and mefentrifluconazole.

In the present method, examples of the SDHI compound to be applied to the foliage of crops include the following.

benzovindiflupyr, bixafen, fluxapyroxad, F9990 and compound 1.

In the present method, examples of other fungicide compounds to be applied to the foliage of crops include the following.

tolclofos-methyl and ethaboxam.

In the present method, examples of the pyrethroid-based compound to be applied to the foliage of crops include the following.

bifenthrin, lambda-cyhalothrin, gamma-cyhalothrin, cypermethrin, fenpropathrin, etofenprox, silafluofen and esfenvalerate.

In the present method, examples of the benzoylphenyl urea compound to be applied to the foliage of crops include the following.

teflubenzuron and triflumuron.

In the present method, examples of the organophosphorus-based insecticide compound to be applied to the foliage of crops include the following.

acephate and methomyl.

In the present method, examples of the neonicotinoid-based compound to be applied to the foliage of crops include the following.

imidacloprid, clothianidin, thiamethoxam, sulfoxaflor, flupyradifurone, triflumezopyrim and dicloromezotiaz.

In the present method, examples of the diamide-based compound to be applied to the foliage of crops include the following.

flubendiamide, chlorantraniliprole, cyantraniliprole, broflanilide, tetraniliprole and cyhalodiamide.

All compounds constituting the compound group B are common compounds and can be synthesized based on known patent documents, and it is also possible to use commercially available formulations and standard purchased.

In a step of applying one or more compounds selected from the compound group A (hereinafter referred to as compound A) to crop seeds of the present method, the compound A is usually mixed with a carrier such as a solid carrier or a liquid carrier, followed by the addition of adjuvants for formulation such as surfactant as necessary, and the thus obtained formulation is used. The formulation type is preferably an aqueous liquid suspension concentrate.

Regarding the compound A, a formulation composed of a single component may be used alone, or two or more formulations may be used in combination, or a formulation composed of two or more multiple components may be used.

The application rate of the compound A is usually within a range of 0.2 to 5,000 g, and preferably 0.5 to 1,000 g, per 100 kg of crop seeds. Examples of the method of applying the compound A to crop seeds include a method of dressing crop seeds with a formulation including the compound A, a method of immersing crop seeds in a formulation including the compound A, a method of spraying a formulation including the compound A on crop seeds and a method of coating crop seeds with a mixture of the compound A and a carrier.

In the present method, the compound X and the compound Y are applied to the place where weeds are growing or will grow. The method for applying the compound X and the compound Y include, for example, a method for spraying the present composition on the soil and a method for spraying the present composition to weeds. Spraying is usually performed after diluting the present composition with water, and the sprayed water amount is not particularly limited and is usually within a range of 50 to 1000 L/ha, preferably 100 to 500 L/ha, and more preferably 140 to 300 L/ha.

The application rate of the compound X and the compound Y is usually 1 to 5,000 g per 10,000 m², preferably 2 to 2,000 g per 10,000 m², and more preferably 5 to 1,000 g per 10,000 m².

In the present method, application may be performed after mixing the compound X and the compound Y with an adjuvant. The type of the adjuvant is not particularly limited, and examples of the adjuvant include oil-based adjuvants such as Agri-Dex and MSO, nonionic adjuvants (ester or ether of polyoxyethylene) such as Induce, anionic adjuvants (substituted sulfonate) such as Gramin S, cationic adjuvants (polyoxyethylene amine) such as Genamin T 200BM, and organosilicon-based adjuvants such as Silwet L77.

The pH and hardness of the spray liquid prepared when applying the compound X and the compound Y are not particularly limited, and the pH is usually within a range of 5 to 9 and the hardness is usually within a range of 0 to 500.

The period of time for applying the compound X and the compound Y is not particularly limited, and the period of time is usually within a range of 5 a.m. to 9 p.m. and the photon flux density is usually 10 to 2,500 μmol/m²/second.

The spraying pressure to be employed for the application of the compound X and the compound Y is not particularly limited, and is usually 30 to 120 PSI, and preferably 40 to 80 PSI.

In the present method, the type of the nozzle to be used in the application of the compound X and the compound Y may be a flat fan nozzle or a drift-reducing nozzle. Examples of the flat fan nozzle include products of Teejet 110 series and XR Teejet 110 series manufactured by Teejet. The volume median diameter of liquid droplets ejected through each of the nozzles is usually smaller than 430 microns at an ordinary spraying pressure, usually 30 to 120 PSI. A drift-reducing nozzle is a nozzle reduced in drift compared with a flat fan nozzle and is called as “air induction nozzle” or “pre-orifice nozzle”. The volume median diameter of liquid droplets ejected through the drift-reducing nozzle is usually 430 microns or larger.

An air induction nozzle has an air guide part between an inlet (spray liquid introduction part) of the nozzle and an outlet (spray liquid ejection part) of the nozzle, so that liquid droplets filled with air can be formed upon the mixing the spray liquid with air. Examples of the air induction nozzle include: TDXL11003-D, TDXL11004-D1, TDXL11005-D1 and TDXL11006-D manufactured by Green Leaf Technology; TTI110025, TTI11003, TTI11004, TTI11005, TTI110061 and TTI110081 manufactured by Teejet; and ULD120-041, ULD120-051 and ULD120-061 manufactured by Pentair. A particularly desirable one is TTI11004.

A pre-orifice nozzle is a nozzle in which an inlet (a spray liquid introduction part) of the nozzle serves as a metering orifice, so that large liquid droplets can be formed by controlling the flow amount to be flown into the nozzle so as to decrease the pressure in the nozzle. When the pre-orifice nozzle is used, the pressure during the ejection of the spray liquid can be reduced by half compared with the pressure before the introduction of the spray liquid. Examples of the pre-orifice nozzle include: DR110-10, UR110-05, UR110-06, UR110-08 and UR110-10 manufactured by Wilger; and 1/4TTJ08 Turf Jet and 1/4TTJ04 Turf Jet manufactured by Teejet.

When the present composition is applied to a crop field, the present composition may be applied to the crop field before seeding crop seeds and the present composition may be applied simultaneously with and/or after seeding crop seeds. Namely, the present composition is applied once before, simultaneously with, or after seeding crop seeds; twice except before seeding crop seeds, twice except simultaneously with seeding crop seeds, or twice except after seeding crop seeds; or three times before, simultaneously with, and after seeding crop seeds.

When the present composition is applied before seeding crop seeds, the present composition is applied from 50 days before seeding to immediately before seeding, preferably from 30 days before seeding to immediately before seeding, more preferably from 20 days before seeding to immediately before seeding, and still more preferably from 10 days before seeding to immediately before seeding.

When the present composition is applied after seeding crop seeds, the present composition is applied usually from immediately after seeding to before flowering. The present composition is applied more preferably from immediately after seeding to before sprouting, and/or from 1 to 6 leaf stages of crops.

The case where the present composition is applied simultaneously with seeding the crop seeds is the case where a sowing machine and a spraying machine are integrated with each other.

When the compound X and the compound Y are sequentially applied to a crop field, each of the compounds is applied at least once in a step from before seeding crop seeds to before flowering, and the order of the compounds is pretermitted.

When the compound X and the compound Y are sequentially applied to a crop field, the compound X is applied once before, simultaneously with, or after seeding crop seeds; twice except before seeding crop seeds, twice except simultaneously with seeding crop seeds, or twice except after seeding crop seeds; or three times before, simultaneously with, and after seeding crop seeds.

When the compound X and the compound Y are sequentially applied to a crop field, the compound Y is applied once before, simultaneously with, or after seeding crop seeds; twice except before seeding crop seeds, twice except simultaneously with seeding crop seeds, or twice except after seeding crop seeds; or three times before, simultaneously with, and after seeding crop seeds.

When the compound X and the compound Y are sequentially applied to a crop field, in the case where the compound X is applied before seeding crop seeds, the compound X is applied from 50 days before seeding to immediately before seeding, preferably from 30 days before seeding to immediately before seeding, more preferably from 20 days before seeding to immediately before seeding, and still more preferably from 10 days before seeding to immediately before seeding.

When the compound X and the compound Y are sequentially applied to a crop field, in the case where the compound Y is applied before seeding crop seeds, the compound Y is applied from 50 days before seeding to immediately before seeding, preferably from 30 days before seeding to immediately before seeding, more preferably from 20 days before seeding to immediately before seeding, and still more preferably from 10 days before seeding to immediately before seeding.

When the compound X and the compound Y are sequentially applied to a crop field, in the case where the compound X is applied after seeding crop seeds, the compound X is applied usually from immediately after seeding to before flowering. The compound X is applied more preferably from immediately after seeding to before sprouting, and/or from 1 to 6 leaf stages of crops.

When the compound X and the compound Y are sequentially applied to a crop field, in the case where the compound Y is applied after seeding crop seeds, the compound Y is applied usually from immediately after seeding to before flowering. The compound Y is applied more preferably from immediately after seeding to before sprouting, and/or from 1 to 6 leaf stages of crops.

When the compound X and the compound Y are sequentially applied to a crop field, the case where the compound X is applied simultaneously with seeding the crop seeds is the case where a sowing machine and a spraying machine are integrated with each other.

When the compound X and the compound Y are sequentially applied to a crop field, the case where the compound Y is applied simultaneously with seeding the crop seeds is the case where a sowing machine and a spraying machine are integrated with each other.

In the step of applying the compound X and the compound Y to the place where weeds are growing or will grow, it is possible to use, as an active ingredient, a formulation comprising the compound X and the compound Y after diluting with water. It may also be possible to use, as an active ingredient, a formulation comprising the compound X as an active ingredient in combination with a formulation comprising the compound Y as an active ingredient. It may also be possible to use a formulation comprising the compound X and the compound Y as active ingredients in combination with a formulation further comprising other herbicides as active ingredients.

Examples of the weeds which can be controlled by the present compound include the following weeds, but are not limited thereto.

Urticaceae weeds: small nettle (Urtica urens)

Polygonaceae weeds: black bindweed (Polygonum convolvulus), pale persicaria (Polygonum lapathifolium), Pennsylvania smartweed (Polygonum pensylvanicum), redshank (Polygonum persicaria), bristly lady's-thumb (Polygonum longisetum), knotgrass (Polygonum aviculare), equal-leaved knotgrass (Polygonum arenastrum), Japanese knotweed (Polygonum cuspidatum), Japanese dock (Rumex japonicus), curly dock (Rumex crispus), blunt-leaved dock (Rumex obtusifolius), common sorrel (Rumex acetosa)

Portulacaceae weeds: common purslane (Portulaca oleracea)

Caryophyllaceae weeds: common chickweed (Stellaria media), water chickweed (Stellaria aquatica), common mouse-ear (Cerastium holosteoides), sticky mouse-ear (Cerastium glomeratum), corn spurrey (Spergula arvensis), five-wound catchfly (Silene gallica)

Molluginaceae weeds: carpetweed (Mollugo verticillata)

Chenopodiaceae weeds: common lambsquarters (Chenopodium album), Indian goosefoot (Chenopodium ambrosioides), kochia (Kochia scoparia), spiny saltwort (Salsola kali), Orach (Atriplex spp.)

Amaranthaceae weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), Palmer amaranth (Amaranthus palmeri), green pigweed (Amaranthus patulus), waterhemp (Amaranthus tuberculatus=Amaranthus rudis=Amaranthus tamariscinus), prostrate pigweed (Amaranthus blitoides), large-fruit amaranth (Amaranthus deflexus), mucronate amaranth (Amaranthus quitensis), alligator weed (Alternanthera philoxeroides), sessile alligator weed (Alternanthera sessilis), perrotleaf (Alternanthera tenella)

Papaveraceae weeds: common poppy (Papaver rhoeas), field poppy (Papaver dubium), Mexican prickle poppy (Argemone mexicana)

Brassicaceae weeds: wild radish (Raphanus raphanistrum), radish (Raphanus sativus), wild mustard (Sinapis arvensis), shepherd's purse (Capsella bursa-pastoris), white mustard (Brassica juncea), oilseed rape (Brassica napus), pinnate tansy mustard (Descurainia pinnata), marsh yellowcress (Rorippa islandica), yellow fieldcress (Rorippa sylvestris), field pennycress (Thlaspi arvense), turnip weed (Myagrum rugosum), Virginia pepperweed (Lepidium virginicum), slender wartcress (Coronopus didymus)

Capparaceae weeds: African cabbage (Cleome affinis)

Fabaceae weeds: Indian joint vetch (Aeschynomene indica), zigzag joint vetch (Aeschynomene rudis), hemp sesbania (Sesbania exaltata), sickle pod (Cassia obtusifolia), coffee senna (Cassia occidentalis), Florida beggar weed (Desmodium tortuosum), wild groundnut (Desmodium adscendens), Illinois tick trefoil (Desmodium illinoense), white clover (Trifolium repens), kudzu (Pueraria lobata), narrowleaf vetch (Vicia angustifolia), hairy indigo (Indigofera hirsuta), Indigofera truxillensis, common cowpea (Vigna sinensis)

Oxalidaceae weeds: creeping wood sorrel (Oxalis corniculata), European wood sorrel (Oxalis stricta), purple shamrock (Oxalis oxyptera)

Geraniaceae weeds: Carolina geranium (Geranium carolinense), common storksbill (Erodium cicutarium)

Euphorbiaceae weeds: sun spurge (Euphorbia helioscopia), annual spurge (Euphorbia maculata), prostrate spurge (Euphorbia humistrata), Hungarian spurge (Euphorbia esula), wild poinsettia (Euphorbia heterophylla), hyssop-leaf sandmat (Euphorbia brasiliensis), Asian copperleaf (Acalypha australis), tropic croton (Croton glandulosus), lobed croton (Croton lobatus), long-stalked phyllanthus (Phyllanthus corcovadensis), castor bean (Ricinus communis)

Malvaceae weeds: velvetleaf (Abutilon theophrasti), arrow-leaf sida (Sida rhombifolia), heart-leaf sida (Sida cordifolia), prickly sida (Sida spinosa), Sida glaziovii, Sida santaremnensis, bladder weed (Hibiscus trionum), spurred anoda (Anoda cristata), spine-seeded false-mallow (Malvastrum coromandelianum)

Onagraceae weeds: Ludwigia epilobioides, long-fruited primrose willow (Ludwigia octovalvis), winged water primrose (Ludwigia decurrens), common evening-primrose (Oenothera biennis), cutleaf evening-primrose (Oenothera laciniata) Sterculiaceae weeds: Florida waltheria (Waltheria indica)

Violaceae weeds: field violet; Viola arvensis, wild violet; Viola tricolor

Cucurbitaceae weeds: bur cucumber (Sicyos angulatus), wild cucumber (Echinocystis lobata), bitter balsam apple (Momordica charantia)

Lythraceae weeds: Ammannia multiflora, eared redstem (Ammannia auriculata), scarlet toothcup (Ammannia coccinea), purple loosestrife (Lythrum salicaria), Indian toothcup (Rotala indica)

Elatinaceae weeds: three-stamen waterwort (Elatine triandra), California waterwort (Elatine californica)

Apiaceae weeds: Chinese celery (Oenanthe javanica), wild carrot (Daucus carota), carrot fern (Conium maculatum)

Araliaceae weeds: lawn pennywort (Hydrocotyle sibthorpioides), floating pennywort (Hydrocotyle ranunculoides)

Ceratophyllaceae weeds: common hornwort (Ceratophyllum demersum)

Cabombaceae weeds: Carolina fanwort (Cabomba caroliniana)

Haloragaceae weeds: Brazilian water milfoil (Myriophyllum aquaticum), whorled water milfoil (Myriophyllum verticillatum), water milfoils (Myriophyllum spicatum, Myriophyllum heterophyllum, etc.)

Sapindaceae weeds: heartseed (Cardiospermum halicacabum)

Primulaceae weeds: scarlet pimpernel (Anagallis arvensis)

Asclepiadaceae weeds: common milkweed (Asclepias syriaca), honeyvine milkweed (Ampelamus albidus) Rubiaceae weeds: catchweed bedstraw (Galium aparine), Galium spurium var. echinospermon, broadleaf buttonweed (Spermacoce latifolia), Brazil calla lily (Richardia brasiliensis), broadleaf buttonweed (Borreria alata)

Convolvulaceae weeds: Japanese morning glory (Ipomoea nil), ivy-leaf morning glory (Ipomoea hederacea), tall morning glory (Ipomoea purpurea), entire-leaf morning glory (Ipomoea hederacea var. integriuscula), pitted morning glory (Ipomoea lacunosa), three-lobe morning glory (Ipomoea triloba), blue morning glory (Ipomoea acuminata), scarlet morning glory (Ipomoea hederifolia), red morning glory (Ipomoea coccinea), cypress-vine morning glory (Ipomoea quamoclit), Ipomoea grandifolia, Ipomoea aristolochiaefolia, Cairo morning glory (Ipomoea cairica), field bindweed (Convolvulus arvensis), Japanese false bindweed (Calystegia hederacea), Japanese bindweed (Calystegia japonica), ivy woodrose (Merremia hederacea), hairy woodrose (Merremia aegyptia), roadside woodrose (Merremia cissoides), small-flower morning glory (Jacquemontia tamnifolia)

Boraginaceae weeds: field forget-me-not (Myosotis arvensis)

Lamiaceae weeds: purple deadnettle (Lamium purpureum), common henbit (Lamium amplexicaule), lion's ear (Leonotis nepetaefolia), wild spikenard (Hyptis suaveolens), Hyptis lophanta, Siberian motherwort (Leonurus sibiricus), field-nettle betony (Stachys arvensis)

Solanaceae weeds: jimsonweed (Datura stramonium), black nightshade (Solanum nigrum), American black nightshade (Solanum americanum), eastern black nightshade (Solanum ptycanthum), hairy nightshade (Solanum sarrachoides), buffalo bur (Solanum rostratum), soda-apple nightshade (Solanum aculeatissimum), sticky nightshade (Solanum sisymbriifolium), horse nettle (Solanum carolinense), cutleaf groundcherry (Physalis angulata), smooth groundcherry (Physalis subglabrata), apple of Peru (Nicandra physalodes)

Scrophulariaceae weeds: ivyleaf speedwell (Veronica hederaefolia), common speedwell (Veronica persica), corn speedwell (Veronica arvensis), common false pimpernel (Lindernia procumbens), false pimpernel (Lindernia dubia), Lindernia angustifolia, round-leaf water hyssop (Bacopa rotundifolia), dopatrium (Dopatrium junceum), Gratiola japonica,

Plantaginaceae weeds: Asiatic plantain (Plantago asiatica), narrow-leaved plantain (Plantago lanceolata), broadleaf plantain (Plantago major), marsh water starwort (Callitriche palustris)

Asteraceae weeds: common cocklebur (Xanthium pensylvanicum), large cocklebur (Xanthium occidentale), Canada cocklebur (Xanthium italicum), common sunflower (Helianthus annuus), wild chamomile (Matricaria chamomilla), scentless chamomile (Matricaria perforata), corn marigold (Chrysanthemum segetum), rayless mayweed (Matricaria matricarioides), Japanese mugwort (Artemisia princeps), common mugwort (Artemisia vulgaris), Chinese mugwort (Artemisia verlotorum), tall goldenrod (Solidago altissima), common dandelion (Taraxacum officinale), hairy galinsoga (Galinsoga ciliata), small-flower galinsoga (Galinsoga parviflora), common groundsel (Senecio vulgaris), flower-of-souls (Senecio brasiliensis), Senecio grisebachii, fleabane (Conyza bonariensis), Guernsey fleabane (Conyza sumatrensis) marestail (Conyza canadensis), common ragweed (Ambrosia artemisiifolia), giant ragweed (Ambrosia trifida), three-cleft bur-marigold (Bidens tripartita), hairy beggarticks (Bidens pilosa), common beggarticks (Bidens frondosa), greater beggarticks (Bidens subalternans), Canada thistle (Cirsium arvense), black thistle (Cirsium vulgare), blessed milkthistle (Silybum marianum), musk thistle (Carduus nutans), prickly lettuce (Lactuca serriola), annual sowthistle (Sonchus oleraceus), spiny sowthistle (Sonchus asper), beach creeping oxeye (Wedelia glauca), perfoliate blackfoot (Melampodium perfoliatum), red tasselflower (Emilia sonchifolia), wild marigold (Tagetes minuta), para cress (Blainvillea latifolia), coat buttons (Tridax procumbens), Bolivian coriander (Porophyllum ruderale), Paraguay starbur (Acanthospermum australe), bristly starbur (Acanthospermum hispidum), balloon vine (Cardiospermum halicacabum), tropic ageratum (Ageratum conyzoides), common boneset (Eupatorium perfoliatum), fireweed (Erechtites hieracifolia), American cudweed (Gamochaeta spicata), linear-leaf cudweed (Gnaphalium spicatum), Jaegeria hirta, ragweed parthenium (Parthenium hysterophorus), small yellow crownbeard (Siegesbeckia orientalis), lawn burweed (Soliva sessilis), white eclipta (Eclipta prostrata), American false daisy (Eclipta alba), spreading sneezeweed (Centipeda minima)

Alismataceae weeds: dwarf arrowhead (Sagittaria pygmaea), threeleaf arrowhead (Sagittaria trifolia), arrowhead (Sagittaria sagittifolia), giant arrowhead (Sagittaria montevidensis), Sagittaria aginashi, channelled water plantain (Alisma canaliculatum), common water plantain (Alisma plantago-aquatica)

Limnocharitaceae weeds: Sawah flowering rush (Limnocharis flava)

Hydrocharitaceae weeds: American frogbit (Limnobium spongia), Florida elodea (Hydrilla verticillata), common water nymph (Najas guadalupensis)

Araceae weeds: Nile cabbage (Pistia stratiotes)

Lemnaceae weeds: three-nerved duckweed (Lemna aoukikusa, Lemna paucicostata, Lemna aequinoctialis), common duckmeat (Spirodela polyrhiza), Woiffia spp.

Potamogetonaceae weeds: roundleaf pondweed (Potamogeton distinctus), pondweeds (Potamogeton crispus, Potamogeton illinoensis, Stuckenia pectinata, etc.)

Liliaceae weeds: wild onion (Allium canadense), wild garlic (Allium vineale), Chinese garlic (Allium macrostemon)

Pontederiaceae weeds: common water hyacinth (Eichhornia crassipes), blue mud plantain (Heteranthera limosa), Monochoria korsakowii, heartshape false pickerelweed (Monochoria vaginalis)

Commelinaceae weeds: common dayflower (Commelina communis), tropical spiderwort (Commelina benghalensis), erect dayflower (Commelina erecta), Asian spiderwort (Murdannia keisak)

Poaceae weeds: common barnyardgrass (Echinochloa crus-galli), early barnyardgrass (Echinochloa oryzicola), barnyard grass (Echinochloa crus-gaili var formosensis), late watergrass (Echinochloa oryzoides), jungle rice (Echinochloa colonum), Gulf cockspur (Echinochloa crus-pavonis), green foxtail (Setaria viridis), giant foxtail (Setaria faheri), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), rough-stalked meadowgrass (Poa trivialis), Kentucky bluegrass (Poa pratensis), short-awn foxtail (Alopecurus aequalis), blackgrass (Alopecurus myosuroides), wild oat (Avena fatua), Johnsongrass (Sorghum halepense), shataken (grain sorghum; Sorghum vulgare), quackgrass (Agropyron repens), Italian ryegrass (Lolium multiflorum), perennial ryegrass (Lolium perenne), bomugi (rigid ryegrass; Lolium rigidum), rescue brome (Bromus catharticus), downy brome (Bromus tectorum), Japanese brome grass (Bromus japonicus), cheat (Bromus secalinus), cheatgrass (Bromus tectorum), foxtail barley (Hordeum jubatum), jointed goatgrass (Aegilops cylindrica), reed canarygrass (Phalaris arundinacea), little-seed canary grass (Phalaris minor), silky bentgrass (Apera spica-venti), fall panicum (Panicum dichotomiflorum), Texas panicum (Panicum texanum), guineagrass (Panicum maximum), broadleaf signalgrass (Brachiaria platyphylla), Congo signal grass (Brachiaria ruziziensis), Alexander grass (Brachiaria plantaginea), Surinam grass (Brachiaria decumbens), palisade grass (Brachiaria brizantha), creeping signalgrass (Brachiaria humidicola), southern sandbur (Cenchrus echinatus), field sandbur (Cenchrus pauciflorus), woolly cupgrass (Eriochloa villosa), feathery pennisetum (Pennisetum setosum), Rhodes grass (Chloris gayana), feathertop Rhodes grass (Chloris virgata), India lovegrass (Eragrostis pilosa), Natal grass (Rhynchelytrum repens), crowfoot grass (Dactyloctenium aegyptium), winkle grass (Ischaemum rugosum), swamp millet (Isachne globosa), common rice (Oryza sativa), bahiagrass (Paspalum notatum), coastal sand paspalum (Paspalum maritimum), mercergrass (Paspalum distichum), kikuyugrass (Pennisetum clandestinum), West Indies pennisetum (Pennisetum setosum), itch grass (Rottboellia cochinchinensis), Asian sprangletop (Leptochloa chinensis), salt-meadow grass (Leptochloa fascicularis), Christmas-tree grass (Leptochloa filiformis), Amazon sprangletop (Leptochloa panicoides), Japanese cutgrass (Leersia japonica), Leersia sayanuka, cutgrass (Leersia oryzoides), Glyceria leptorrhiza, sharpscale mannagrass (Glyceria acutiflora), great watergrass (Glyceria maxima), redtop (Agrostis gigantea), carpet bent (Agrostis stolonifera), Bermuda grass (Cynodon dactylon), cocksfoot (Dactylis giomerata), centipede grass (Eremochioa ophiuroides), tall fescue (Festuca arundinacea), red fescue (Festuca rubra), lalang (Imperata cylindrica), Chinese fairy grass (Miscanthus sinensis), switchgrass (Panicum virgatum), Japanese lawngrass (Zoysia japonica)

Cyperaceae weeds: Asian flatsedge (Cyperus microiria), rice flatsedge (Cyperus iria), hedgehog cyperus (Cyperus compressus), small-flowered nutsedge (Cyperus difformis), lax-flat sedge (Cyperus flaccidus), Cyperus globosus, Cyperus nipponicus, fragrant flatsedge (Cyperus odoratus), mountain nutsedge (Cyperus serotinus), purple nutsedge (Cyperus rotundus), yellow nutsedge (Cyperus esculentus), pasture spike sedge (Kyllinga gracillima), green kyllinga (Kyllinga brevifolia), grasslike fimbristylis (Fimbristylis miliacea), annual fringerush (Fimbristylis dichotoma), slender spikerush (Eleocharis acicularis), Eleocharis kuroguwai, Japanese bulrush (Schoenoplectiella hotarui), hardstem bulrush (Schoenoplectiella juncoides), Schoenoplectiella wallichii, rough-seed bulrush (Schoenoplectiella mucronatus), Schoenoplectiella triangulatus, Schoenoplectiella nipponicus, triangular club-rush (Schoenoplectiella triqueter), Bolboschoenus koshevnikovii, river bulrush (Bolboschoenus fluviatilis)

Equisetaceae weeds: field horsetail (Equisetum arvense), marsh horsetail (Equisetum palustre) Salviniaceae weeds: floating fern (Salvinia natans)

Azollaceae weeds: Japanese mosquitofern (Azolla japonica), feathered mosquito fern (Azolla pinnata)

Marsileaceae weeds: clover fern (Marsilea quadrifolia)

Other: Filamentous algae (Pithophora, Cladophora), Bryophyta, Marchantiophyta, Anthocerotophyta, Cyanobacteria, Pteridophyta, sucker of perennial crop (pome fruits, stone fruits, berry fruits, nuts, citrus fruits, hops, grapes, etc.)

In the above weeds, mutations within the species are not particularly limited. Namely, the weeds also include any weeds that have reduced sensitivity (also referred to “have resistance”) to a specific herbicide. The reduced sensitivity may be attributed to a mutation at a target site (target site mutation), or may be attributed to any factors other than target site mutation (non-target site mutation). Target site mutation include those in which the substitution of amino acid residue of a protein as a target site occurred due to mutation of an open reading frame corresponding to amino acid sequence of the protein, and those in which the protein as the target site is overexpressed due to mutation such as deletion of the suppressor sequence in the promoter region, amplification of the enhancer sequence, or increase in the number of copies of gene.

Examples of the factor reducing sensitivity due to non-target site mutation include metabolic enhancement, defective absorption, defective transition, efflux out of the system and the like. Examples of the factor of the metabolic enhancement includes enhanced activity of metabolic enzymes such as cytochrome P450 monooxygenases, aryl acylamidases, esterases and glutathione S-transferase. The efflux out of the system includes the transportation to a vacuole by an ABC transporter.

Examples of herbicide-resistant weeds include followings.

### Resistance to Glyphosate:

Examples of the reduced sensitivity of weeds due to target site mutation include weeds in which the substitution of any one amino acid residue or multiple amino acid residues selected from the below-mentioned amino acid residues occurs in EPSPS gene. Thr102Ile, Pro106Ser, Pro106Ala, Pro106Leu and Pro106Leu. Particularly, those with both of Thr102Ile and Pro106Ser, and those with both of Thr102Ile and Pro106Thr are mentioned. Glyphosate-resistant Indian goosegrass (Eleusine indica), Italian ryegrass (Lolium multiflorum), rigid ryegrass (Lolium rigidum), perennial ryegrass, Bidens subalternans and the like each having the target-site mutation can be controlled effectively. Similarly, examples of the resistance to glyphosate due to target site mutation include those in which the number of copies of EPSPS gene is increased (PNAS, 2018 115 (13) 3332-3337). According to the present invention, Glyphosate-resistant palmer amaranth (Amaranthus palmeri), waterhemp (Amaranthus tuberculatus), summer cypress (Bassia scoparia) and the like in which the number of copies of EPSPS gene is increased can be controlled effectively. Examples of the reduced sensitivity of weeds due to non-target site mutation include Glyphosate-resistant Canadian horseweed (Conyza canadensis), Sumatran fleabane (Conyza sumatrensis), flax-leaf fleabane (Conyza bonariensis) and the like in which an ABC transporter is involved can be controlled effectively according to the present invention. Furthermore, jungle rice (Echinochloa colona) in which sensitivity to glyphosate is reduced by increasing expression of aldo-keto reductase known as non-target site mutation (Plant Physiology 181, 1519-1534) is effectively controlled by the present invention.

Resistance to ALS-inhibition-type herbicides: Examples of the reduced sensitivity of weeds due to target site mutation include weeds each having a mutation capable of causing the substitution of one amino acid residue or multiple amino acid residues selected from the below-mentioned amino acid residues in ALS gene as a target site mutation. Ala122Thr, Ala122Val, Ala122Tyr, Pro197Ser, Pro197His, Pro197Thr, Pro197Arg, Pro197Leu, Pro197Gln, Pro197Ala, Pro197Ile, Ala205Val, Ala205Phe, Asp376Glu, Asp376Gln, Asp376Asn, Arg377His, Trp574Leu, Trp574Gly, Trp574Met, Ser653Thr, Ser653Asn, Ser635Ile, Gly654Glu and Gly645Asp. According to the present invention, ALS inhibitor-resistant redroot amaranth (Amaranthus retroflexus), green amaranth (Amaranthus chlorostachys Wiil), palmer amaranth (Amaranthus palmeri), waterhemp (Amaranthus tuberculatus), summer cypress (Bassia scoparia) and the like each having the target site mutation can be controlled effectively. Examples of the reduced sensitivity of weeds due to non-target site mutation include weeds each having such a non-target site mutation that CYP or GST is involved to make the weed resistant to an ALS inhibitor, and these weeds can also be controlled effectively according to the present invention. There have been known, as examples of the weeds, rigid ryegrass (Lolium rigidum) in which CYP81A10 and CYP81A1v1 are overexpressed, rice barnyardgrass (Echinochloa oryzoides) in which CYP81A12 and CYP81A21 are overexpressed, and blackgrass (Alopecurus myosuroides Huds) in which GSTF1 and GSTU2 are overexpressed.

Resistance to ACCase inhibitors: Examples of the reduced sensitivity of weeds due to target site mutation include weeds each having a mutation capable of causing the substitution of one amino acid residue or multiple amino acid residues in ACCase gene. Ile1781Leu, Ile1781Val, Ile1781Thr, Trp1999Cys, Trp1999Leu, Ala2004Val, Trp2027Cys, Ile2041Asn, Ile2041Val, Asp2078Gly, Asp2078Glu, Cys2088Arg and Gly2096Ala. According to the present invention, ACCase-resistant weeds having these target site mutations are effectively controlled. Examples of the reduced sensitivity of weeds due to non-target site mutation include weeds each of which becomes resistant to an ALS inhibitor as the result of the involvement of CYP or GST. There have been known, as examples of the weeds, rigid ryegrass (Lolium rigidum) in which CYP81A10 and CYP81A1v1 are overexpressed, rice barnyardgrass (Echinochloa oryzoides) in which CYP81A12 and CYP81A21 are overexpressed, and blackgrass (Alopecurus myosuroides Huds) in which GSTF1 and GSTU2 are overexpressed.

### Resistance to PPO Inhibitors:

Examples of the reduced sensitivity of weeds due to target site mutation include weeds each having a mutation capable of causing the substitution of one amino acid residue or multiple amino acid residues in PPO gene. These mutations are known as or predicted to become carfentrazone-ethyl-, fomesafen- and lactofen-resistance mutations. Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deletion, Ala210 deletion, Gly210Thr, Ala210Thr, G211 deletion, Gly114Glu, Ser149Ile, Gly399Ala (all of amino acid numbers are standardized by sequence of PPO2 of palmer amaranth (Amaranthus palmeri)). Usually, PPO genes in a weed includes PPO1 gene and PPO2 gene. The above-mentioned mutation may occur in either one or both of PPO1 gene and PPO2 gene. It is preferred that the mutation occurs in PPO2 gene. For example, Arg128Met means that a mutation occurs in an amino acid residue located at position-128. In PPO2 gene of common ragweed (Ambrosia artemisiaefolia), the mutation corresponds to position-98 (Weed Science 60, 335-344) and is known as Arg128Leu, and this Arg128Leu is the same as Arg128 in the present specification. In PPO gene of weeds to be controlled by the present invention, Arg128Met and Arg128Gly are known in palmer amaranth (Amaranthus palmeri) (Pest Management Science 73, 1559-1563), Arg128Gly is known as PPO2 of waterhemp (Amaranthus tuberculatus) (Pest Management Science, 2019; 75: 3235-3244), Arg128Ile and Arg128Lys are known as PPO2 of waterhemp (Amaranthus tuberculatus) (Pest Management Science, 2019; 75: 3235-3244), Arg128His is known as Arg132His by PPO2 of rigid ryegrass (Lolium rigidum) (WSSA annual meeting, 2018), Gly114Glu, Ser149Ile, and Gly399Ala are known by PPO2 of palmer amaranth (Amaranthus palmeri) (Frontiers in Plant Science 10, Article 568), and Ala210Thr is known as Ala212Thr by PPO1 of Indian goosegrass (Eleusine indica) (Pest Management Science, doi: 10.1002/ps.5703). According to the present invention, PPO inhibitor-resistant weeds each having one of the above-mentioned target site mutations can be controlled effectively. However, the PPO inhibitor-resistant weed to be controlled is not limited to these weeds. Namely, not only palmer amaranth (Amaranthus palmeri) having a mutation of Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deletion, Ala210 deletion, Gly210Thr, Ala210Thr, G211 deletion, Gly114Glu, Ser149Ile or Gly399Ala in PPO1 or PPO2 but also, for example, waterhemp (Amaranthus tuberculatus) having the same mutation, common ragweed (Ambrosia artemisiaefolia) having the same mutation and wild poinsettia (Euphorbia cyathophora) having the same mutation can be controlled effectively. As an example of the reduced sensitivity of weeds due to non-target site mutation, waterhemp (Amaranthus tuberculatus) which becomes resistant to carfentrazone-ethyl is known as waterhemp (Amaranthus tuberculatus) and palmer amaranth (Amaranthus palmeri) which become resistant to a PPO inhibitor as the result of the involvement of CYP or GST (PLOS ONE, doi: 10.1371/journal.pone.0215431), and these weeds are effectively controlled according to the present invention.

### Resistance to Auxin-Type Herbicides:

Examples of the target site mutation include a mutation which causes Gly-Asn in a degron region in AUX/IAA gene. According to the present invention, summer cypress (Bassia scoparia), palmer amaranth (Amaranthus palmeri) and waterhemp (Amaranthus tuberculatus) each having this mutation can be controlled effectively. As the non-target site mutation, dicamba-resistant green amaranth (Amaranthus chlorostachys Wiil) and 2,4-D-resistant waterhemp (Amaranthus tuberculatus) to which the involvement of CYP is suggested are known. These weeds can be controlled effectively according to the present invention. These weeds can also be controlled in the case of the non-target site mutation in which GST is involved.

### Resistance to HPPD Inhibitors:

Examples of the reduced sensitivity of weeds due to non-target site mutation include waterhemp (Amaranthus tuberculatus), palmer amaranth (Amaranthus palmeri) and the like each of which becomes resistant to an HPPD inhibitor as the result of the involvement of CYP or GST, which are effectively controlled according to the present invention. As examples thereof, palmer amaranth (Amaranthus palmeri) in which CYP72A219, CYP81B and CYP81E8 are overexpressed are known.

### Resistance to Photosystem II Inhibitors:

Examples of the reduced sensitivity of weeds due to target site mutation include weeds each having a mutation capable of causing the substitution of one amino acid residue or multiple amino acid residues selected from the below-mentioned amino acid residues in psbA gene. Val219Ile, Ser264Gly, Ser264Ala, Phe274Val. According to the present invention, photosystem II inhibitor-resistant palmer amaranth (Amaranthus palmeri) and waterhemp (Amaranthus tuberculatus) each having this target site mutation can be controlled effectively. Examples of the reduced sensitivity of weeds due to non-target site mutation include palmer amaranth (Amaranthus palmeri), waterhemp (Amaranthus tuberculatus) and the like each of which becomes resistant to a photosystem II inhibitor as the result of the involvement of CYP, GST or AAA. These weeds can be effectively controlled according to the present invention. As an example thereof, rigid ryegrass (Lolium rigidum) in which CYP71R4 are overexpressed is known.

### Resistance to Glutamate Synthase Inhibitors:

Examples of the reduced sensitivity of weeds due to target site mutation include weeds each having a mutation capable of causing the amino acid substitution of Asp171Asn in a glutamate synthase gene. According to the present invention, glutamate synthase inhibitor-resistant palmer amaranth (Amaranthus palmeri), waterhemp (Amaranthus tuberculatus) and the like each having this target site mutation can be controlled effectively. Examples of the reduced sensitivity of weeds due to non-target site mutation include palmer amaranth (Amaranthus palmeri), waterhemp (Amaranthus tuberculatus) and the like each of which becomes resistant to glufosinate as the result of the involvement of CYP or GST. These weeds can be effectively controlled according to the present invention. As an example thereof, palmer amaranth (Amaranthus palmeri) in which CYP72A219, CYP81B and CYP81E8 are overexpressed is known.

Resistant weeds each having a “combination (stack)” of at least two groups selected from the above-mentioned groups (arbitrarily selected two groups, arbitrarily selected three groups, arbitrarily selected four groups, arbitrarily selected five groups, arbitrarily selected six groups, arbitrarily selected seven groups or arbitrarily selected eight groups) can also be controlled effectively. For example, waterhemp (Amaranthus tuberculatus) having resistance to all of a photosystem II inhibitor, a HPPD inhibitor, 2,4-D, a PPO inhibitor, an ALS inhibitor and glyphosate is known. This weed can also be effectively controlled. The stack may be a combination of target site mutations or a combination of non-target site mutations, or a combination of a target site mutation and a non-target site mutation.

Examples of the herbicide which may be included in the present composition, in addition to the compound X and the compound Y, include the following. The herbicides can also be used in combination with the present composition comprising only the compound X and the compound Y as active ingredients.

Herbicides: glyphosate and a salt thereof (isopropylammonium salt, ammonium salt, potassium salt, guanidine salt, dimethylamine salt, monoethanolamine salt, choline salt, BAPMA (N,N-bis-(aminopropyl)methylamine) salt, 2,4-D and a salt or an ester thereof (ammonium salt, butotyl ester, 2-butoxypropyl ester, butyl ester, diethylammonium salt, dimethylammonium salt, diolamine salt, dodecylammonium salt, ethyl ester, 2-ethylhexyl ester, heptylammonium salt, isobutyl ester, isooctyl ester, isopropyl ester, isopropylammonium salt, lithium salt, meptyl ester, methyl ester, octyl ester, pentyl ester, propyl ester, sodium salt, tefuryl ester, tetradecylammonium salt, triethylammonium salt, tris(2-hydroxypropyl)ammonium salt, trolamine salt, choline salt), 2,4-DB and a salt or an ester thereof (dimethylammonium salt, isooctyl ester, choline salt), pyroxasulfone, dicamba and a salt or an ester thereof (diglycolamine salt, dimethylammonium salt, diolamine salt, isopropylammonium salt, methyl ester, auramine salt, potassium salt, sodium salt, trolamine salt, BAPMA (N,N-bis-(aminopropyl)methylamine) salt, choline salt, TBA (tetrabutylammonium) salt, TBP (tetrabutylphosphonium) salt, MCPA and a salt or an ester thereof (dimethylammonium salt, 2-ethylhexyl ester, isooctyl ester, sodium salt, choline salt), MCPB, mecoprop and a salt or an ester thereof (dimethylammonium salt, diolamine salt, ethadyl ester, 2-ethylhexyl ester, isooctyl ester, methyl ester, potassium salt, sodium salt, trolamine salt, choline salt), mecoprop-P and a salt or an ester thereof (dimethylammonium salt, 2-ethylhexyl ester, isobutyl salt, potassium salt, choline salt), dichlorprop and a salt or an ester thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, quinclorac, quinmerac, bromoxynil, bromoxynil-octanoate, dichlobenil, methiozolin, ioxynil, ioxynil-octanoate, di-allate, butylate, tri-allate, phenmedipham, chlorpropham, desmedipham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, terbumeton, terbuthylazine, terbutryn, trietazine, isoxaben, diflufenican, diuron, linuron, metobromuron, metoxuron, monolinuron, siduron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, lenacil, oxaziclomefone, cinmethylin, benfuresate, cafenstrole, flufenacet, pyrithiobac, pyrithiobac-sodium, pyriminobac, pyriminobac-methyl, bispyribac, bispyribac-sodium, pyribenzoxim, pyrimisulfan, pyriftalid, triafamone, fentrazamide, dimethenamid, dimethenamid-P, ACN, dithiopyr, triclopyr and a salt or an ester thereof (butotyl ester, triethylammonium salt), fluroxypyr, fluroxypyr-meptyl, thiazopyr, aminopyralid and a salt thereof (potassium salt, triisopropanolammonium salt, choline salt), clopyralid and a salt thereof (olamine salt, potassium salt, triethylammonium salt, choline salt), picloram and a salt thereof (potassium salt, triisopropanolammonium salt, choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, norflurazon, fluridone, flurochloridone, flurtamone, benzobicyclon, bicyclopyrone, mesotrione, sulcotrione, tefuryltrione, tembotrione, isoxachlortole, isoxaflutole, benzofenap, pyrasulfotole, pyrazolynate, pyrazoxyfen, topramezone, tolpyralate, lancotrione-sodium, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-ammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, fenoxasulfone, glufosinate, glufosinate-ammonium, glufosinate-P, glufosinate-P-sodium, bialafos, anilofos, bensulide, butamifos, paraquat, paraquat-dichloride, diquat, diquat-dibromide, halauxifen, halauxifen-methyl, florpyrauxifen, florpyrauxifen-benzyl, flumioxazin, flumiclorac-pentyl, fomesafen-sodium, lactofen, saflufenacil, tiafenacil, trifludimoxazin, acifluorfen-sodium, aclonifen, bifenox, chlomethoxyfen, chlornitrofen, ethoxyfen-ethyl, fluorodifen, fluoroglycofen-ethyl, fluoronitrofen, halosafen, nitrofen, nitrofluorfen, oxyfluorfen, cinidon-ethyl, profluazol, pyraclonil, oxadiargyl, oxadiazone, pentoxazone, fluazolate, pyraflufen-ethyl, benzfendizone, butafenacil, fluthiacet-methyl, thidiazimin, azafenidin, carfentrazone-ethyl, sulfentrazone, flufenpyr-ethyl, (3S,4S)—N-(2-fluorophenyl)-1-methyl-2-oxo-4-[3-(trifluoromethyl)phenyl]-3-pyrrolidinecarboxamide, 4-amino-3-chloro-5-fluoro-6-(7-fluoro-1H-indol-6-yl)-2-pyridine carboxylic acid and a salt thereof, bixlozone, cyclopyranil, fenquinotrione, cyclopyrimorate, and tetflupyrolimet.

As the herbicide which can be used in combination with the present composition in the present invention, glyphosate potassium salt, glyphosate guanidine salt, glyphosate dimethylamine salt, glyphosate monoethanolamine salt, glufosinate-ammonium, glyphosate isopropylammonium salt, 2,4-D choline salt, pyroxasulfone, dicamba diglycolamine salt, dicamba BAPMA salt, dicamba TBA salt, dicamba TBP salt, flumioxazin, flumiclorac-pentyl, clethodim, lactofen, Smetolachlor, metribuzin, flufenacet, nicosulfuron, rimsulfuron, acetochlor, mesotrione, isoxaflutole, chlorimuron-ethyl, thifensulfuron-methyl, cloransulam-methyl and imazethapyr-ammonium are particularly preferable.

Examples of the herbicide which can be used in combination with the compound X and the compound Y in the present invention (hereinafter sometimes referred to as herbicide Z) are mentioned below, but are not limited thereto. A ratio of the herbicide Z to the compound X is usually within a range of 0.01 to 1,000 times by weight, and preferably 0.1 to 300 times by weight.

Examples of a combination of the compound X, the compound Y and the herbicide Z are shown below.

compound X/compound Y1/glyphosate potassium salt
compound X/compound Y1/glyphosate guanidine salt
compound X/compound Y1/glyphosate dimethylamine salt
compound X/compound Y1/glyphosate monoethanolamine salt
compound X/compound Y1/glyphosate isopropylamine salt
compound X/compound Y1/glufosinate-ammonium
compound X/compound Y1/2,4-D choline salt
compound X/compound Y1/pyroxasulfone
compound X/compound Y1/dicamba diglycolamine salt
compound X/compound Y1/dicamba BAPMA salt
compound X/compound Y1/dicamba TBA salt
compound X/compound Y1/dicamba TBP salt
compound X/compound Y1/flumioxazin
compound X/compound Y1/flumioxazin/pyroxasulfone
compound X/compound Y1/flumioxazin/chlorimuron-ethyl
compound X/compound Y1/flumioxazin/chlorimuron-ethyl/thifensulfuron-methyl
compound X/compound Y1/flumioxazin/cloransulam-methyl
compound X/compound Y1/flumioxazin/metribuzin/chlorimuron-ethyl
compound X/compound Y1/flumioxazin/metribuzin/imazethapyr-ammonium
compound X/compound Y1/flumiclorac-pentyl
compound X/compound Y1/clethodim
compound X/compound Y1/lactofen
compound X/compound Y1/Smetolachlor
compound X/compound Y1/metribuzin
compound X/compound Y1/flufenacet
compound X/compound Y1/nicosulfuron
compound X/compound Y1/rimsulfuron
compound X/compound Y1/acetochlor
compound X/compound Y1/mesotrione
compound X/compound Y1/isoxaflutole
compound X/compound Y1/chlorimuron-ethyl
compound X/compound Y1/thifensulfuron-methyl
compound X/compound Y1/cloransulam-methyl
compound X/compound Y1/imazethapyr-ammonium
compound X/compound Y1/glyphosate potassium salt/2,4-D choline salt
compound X/compound Y1/glyphosate dimethylamine salt/2,4-D choline salt
compound X/compound Y1/glyphosate potassium salt/pyroxasulfone
compound X/compound Y1/glyphosate potassium salt/dicamba diglycolamine salt
compound X/compound Y1/glyphosate monoethanolamine salt/dicamba diglycolamine salt
compound X/compound Y1/glyphosate potassium salt/dicamba BAPMA salt
compound X/compound Y1/glyphosate monoethanolamine salt/dicamba BAPMA salt
compound X/compound Y1/glyphosate potassium salt/dicamba TBA salt
compound X/compound Y1/glyphosate monoethanolamine salt/dicamba TBA salt
compound X/compound Y1/glyphosate potassium salt/dicamba TBP salt
compound X/compound Y1/glyphosate monoethanolamine salt/dicamba TBP salt
compound X/compound Y1/glyphosate potassium salt/flumioxazin
compound X/compound Y1/glyphosate potassium salt/flumioxazin/pyroxasulfone
compound X/compound Y1/glyphosate potassium salt/dicamba diglycolamine salt/flumioxazin
compound X/compound Y1/glyphosate monoethanolamine salt/dicamba diglycolamine salt/flumioxazin
compound X/compound Y1/glyphosate potassium salt/dicamba BAPMA salt/flumioxazin
compound X/compound Y1/glyphosate monoethanolamine salt/dicamba BAPMA salt/flumioxazin
compound X/compound Y1/glyphosate potassium salt/dicamba TBA salt/flumioxazin
compound X/compound Y1/glyphosate monoethanolamine salt/dicamba TBA salt/flumioxazin
compound X/compound Y1/glyphosate potassium salt/dicamba TBP salt/flumioxazin
compound X/compound Y1/glyphosate monoethanolamine salt/dicamba TBP salt/flumioxazin
compound X/compound Y1/glyphosate potassium salt/dicamba diglycolamine salt/flumioxazin/pyroxasulfone
compound X/compound Y1/glyphosate monoethanolamine salt/dicamba diglycolamine salt/flumioxazin/pyroxasulfone
compound X/compound Y1/glyphosate potassium salt/dicamba BAPMA salt/flumioxazin/pyroxasulfone
compound X/compound Y1/glyphosate monoethanolamine salt/dicamba BAPMA salt/flumioxazin/pyroxasulfone
compound X/compound Y1/glyphosate potassium salt/dicamba TBA salt/flumioxazin/pyroxasulfone
compound X/compound Y1/glyphosate monoethanolamine salt/dicamba TBA salt/flumioxazin/pyroxasulfone
compound X/compound Y1/glyphosate potassium salt/dicamba TBP salt/flumioxazin/pyroxasulfone
compound X/compound Y1/glyphosate monoethanolamine salt/dicamba TBP salt/flumioxazin/pyroxasulfone
compound X/compound Y1/glyphosate potassium salt/flumioxazin/chlorimuron-ethyl
compound X/compound Y1/glyphosate potassium salt/flumioxazin/chlorimuron-ethyl/thifensulfuron-methyl
compound X/compound Y1/glyphosate potassium salt/flumioxazin/cloransulam-methyl
compound X/compound Y1/glyphosate potassium salt/flumioxazin/metribuzin/chlorimuron-ethyl
compound X/compound Y1/glyphosate potassium salt/flumioxazin/metribuzin/imazethapyr-ammonium
compound X/compound Y1/glyphosate potassium salt/flumiclorac-pentyl
compound X/compound Y1/glyphosate potassium salt/clethodim
compound X/compound Y1/glyphosate potassium salt/lactofen
compound X/compound Y1/glyphosate potassium salt/Smetolachlor
compound X/compound Y1/glyphosate potassium salt/metribuzin
compound X/compound Y1/glyphosate potassium salt/flufenacet
compound X/compound Y1/glyphosate potassium salt/nicosulfuron
compound X/compound Y1/glyphosate potassium salt/rimsulfuron
compound X/compound Y1/glyphosate potassium salt/rimsulfuron
compound X/compound Y1/glyphosate potassium salt/acetochlor
compound X/compound Y1/glyphosate potassium salt/mesotrione
compound X/compound Y1/glyphosate potassium salt/isoxaflutole
compound X/compound Y1/glyphosate potassium salt/chlorimuron-ethyl
compound X/compound Y1/glyphosate potassium salt/thifensulfuron-methyl
compound X/compound Y1/glyphosate potassium salt/cloransulam-methyl
compound X/compound Y1/glyphosate potassium salt/imazethapyr-ammonium
compound X/compound Y2/glyphosate potassium salt
compound X/compound Y2/glyphosate guanidine salt
compound X/compound Y2/glyphosate dimethylamine salt
compound X/compound Y2/glyphosate monoethanolamine salt
compound X/compound Y2/glyphosate isopropylamine salt
compound X/compound Y2/glufosinate-ammonium
compound X/compound Y2/2,4-D choline salt
compound X/compound Y2/pyroxasulfone
compound X/compound Y2/dicamba diglycolamine salt
compound X/compound Y2/dicamba BAPMA salt
compound X/compound Y2/dicamba TBA salt
compound X/compound Y2/dicamba TBP salt
compound X/compound Y2/flumioxazin
compound X/compound Y2/flumioxazin/pyroxasulfone
compound X/compound Y2/flumioxazin/chlorimuron-ethyl
compound X/compound Y2/flumioxazin/chlorimuron-ethyl/thifensulfuron-methyl
compound X/compound Y2/flumioxazin/cloransulam-methyl
compound X/compound Y2/flumioxazin/metribuzin/chlorimuron-ethyl
compound X/compound Y2/flumioxazin/metribuzin/imazethapyr-ammonium
compound X/compound Y2/flumiclorac-pentyl
compound X/compound Y2/clethodim
compound X/compound Y2/lactofen
compound X/compound Y2/Smetolachlor
compound X/compound Y2/metribuzin
compound X/compound Y2/flufenacet
compound X/compound Y2/nicosulfuron
compound X/compound Y2/rimsulfuron
compound X/compound Y2/acetochlor
compound X/compound Y2/mesotrione
compound X/compound Y2/isoxaflutole
compound X/compound Y2/chlorimuron-ethyl
compound X/compound Y2/thifensulfuron-methyl
compound X/compound Y2/cloransulam-methyl
compound X/compound Y2/imazethapyr-ammonium
compound X/compound Y2/glyphosate potassium salt/2,4-D choline salt
compound X/compound Y2/glyphosate dimethylamine salt/2,4-D choline salt
compound X/compound Y2/glyphosate potassium salt/pyroxasulfone
compound X/compound Y2/glyphosate potassium salt/dicamba diglycolamine salt
compound X/compound Y2/glyphosate monoethanolamine salt/dicamba diglycolamine salt
compound X/compound Y2/glyphosate potassium salt/dicamba BAPMA salt
compound X/compound Y2/glyphosate monoethanolamine salt/dicamba BAPMA salt
compound X/compound Y2/glyphosate potassium salt/dicamba TBA salt
compound X/compound Y2/glyphosate monoethanolamine salt/dicamba TBA salt
compound X/compound Y2/glyphosate potassium salt/dicamba TBP salt
compound X/compound Y2/glyphosate monoethanolamine salt/dicamba TBP salt
compound X/compound Y2/glyphosate potassium salt/flumioxazin
compound X/compound Y2/glyphosate potassium salt/flumioxazin/pyroxasulfone
compound X/compound Y2/glyphosate potassium salt/dicamba diglycolamine salt/flumioxazin
compound X/compound Y2/glyphosate monoethanolamine salt/dicamba diglycolamine salt/flumioxazin
compound X/compound Y2/glyphosate potassium salt/dicamba BAPMA salt/flumioxazin
compound X/compound Y2/glyphosate monoethanolamine salt/dicamba BAPMA salt/flumioxazin
compound X/compound Y2/glyphosate potassium salt/dicamba TBA salt/flumioxazin
compound X/compound Y2/glyphosate monoethanolamine salt/dicamba TBA salt/flumioxazin
compound X/compound Y2/glyphosate potassium salt/dicamba TBP salt/flumioxazin
compound X/compound Y2/glyphosate monoethanolamine salt/dicamba TBP salt/flumioxazin
compound X/compound Y2/glyphosate potassium salt/dicamba diglycolamine salt/flumioxazin/pyroxasulfone
compound X/compound Y2/glyphosate monoethanolamine salt/dicamba diglycolamine salt/flumioxazin/pyroxasulfone
compound X/compound Y2/glyphosate potassium salt/dicamba BAPMA salt/flumioxazin/pyroxasulfone
compound X/compound Y2/glyphosate monoethanolamine salt/dicamba BAPMA salt/flumioxazin/pyroxasulfone
compound X/compound Y2/glyphosate potassium salt/dicamba TBA salt/flumioxazin/pyroxasulfone
compound X/compound Y2/glyphosate monoethanolamine salt/dicamba TBA salt/flumioxazin/pyroxasulfone
compound X/compound Y2/glyphosate potassium salt/dicamba TBP salt/flumioxazin/pyroxasulfone
compound X/compound Y2/glyphosate monoethanolamine salt/dicamba TBP salt/flumioxazin/pyroxasulfone
compound X/compound Y2/glyphosate potassium salt/flumioxazin/chlorimuron-ethyl
compound X/compound Y2/glyphosate potassium salt/flumioxazin/chlorimuron-ethyl/thifensulfuron-methyl
compound X/compound Y2/glyphosate potassium salt/flumioxazin/cloransulam-methyl
compound X/compound Y2/glyphosate potassium salt/flumioxazin/metribuzin/chlorimuron-ethyl
compound X/compound Y2/glyphosate potassium salt/flumioxazin/metribuzin/imazethapyr-ammonium
compound X/compound Y2/glyphosate potassium salt/flumiclorac-pentyl
compound X/compound Y2/glyphosate potassium salt/clethodim
compound X/compound Y2/glyphosate potassium salt/lactofen
compound X/compound Y2/glyphosate potassium salt/Smetolachlor
compound X/compound Y2/glyphosate potassium salt/metribuzin
compound X/compound Y2/glyphosate potassium salt/flufenacet
compound X/compound Y2/glyphosate potassium salt/nicosulfuron
compound X/compound Y2/glyphosate potassium salt/rimsulfuron
compound X/compound Y2/glyphosate potassium salt/rimsulfuron
compound X/compound Y2/glyphosate potassium salt/acetochlor
compound X/compound Y2/glyphosate potassium salt/mesotrione
compound X/compound Y2/glyphosate potassium salt/isoxaflutole
compound X/compound Y2/glyphosate potassium salt/chlorimuron-ethyl
compound X/compound Y2/glyphosate potassium salt/thifensulfuron-methyl
compound X/compound Y2/glyphosate potassium salt/cloransulam-methyl
compound X/compound Y2/glyphosate potassium salt/imazethapyr-ammonium
compound X/compound Y3/glyphosate potassium salt
compound X/compound Y3/glyphosate guanidine salt
compound X/compound Y3/glyphosate dimethylamine salt
compound X/compound Y3/glyphosate monoethanolamine salt
compound X/compound Y3/glyphosate isopropylamine salt
compound X/compound Y3/glufosinate-ammonium
compound X/compound Y3/2,4-D choline salt
compound X/compound Y3/pyroxasulfone
compound X/compound Y3/dicamba diglycolamine salt
compound X/compound Y3/dicamba BAPMA salt
compound X/compound Y3/dicamba TBA salt
compound X/compound Y3/dicamba TBP salt
compound X/compound Y3/flumioxazin
compound X/compound Y3/flumioxazin/pyroxasulfone
compound X/compound Y3/flumioxazin/chlorimuron-ethyl
compound X/compound Y3/flumioxazin/chlorimuron-ethyl/thifensulfuron-methyl
compound X/compound Y3/flumioxazin/cloransulam-methyl
compound X/compound Y3/flumioxazin/metribuzin/chlorimuron-ethyl
compound X/compound Y3/flumioxazin/metribuzin/imazethapyr-ammonium
compound X/compound Y3/flumiclorac-pentyl
compound X/compound Y3/clethodim
compound X/compound Y3/lactofen
compound X/compound Y3/Smetolachlor
compound X/compound Y3/metribuzin
compound X/compound Y3/flufenacet
compound X/compound Y3/nicosulfuron
compound X/compound Y3/rimsulfuron
compound X/compound Y3/acetochlor
compound X/compound Y3/mesotrione
compound X/compound Y3/isoxaflutole
compound X/compound Y3/chlorimuron-ethyl
compound X/compound Y3/thifensulfuron-methyl
compound X/compound Y3/cloransulam-methyl
compound X/compound Y3/imazethapyr-ammonium
compound X/compound Y3/glyphosate potassium salt/2,4-D choline salt
compound X/compound Y3/glyphosate dimethylamine salt/2,4-D choline salt
compound X/compound Y3/glyphosate potassium salt/pyroxasulfone
compound X/compound Y3/glyphosate potassium salt/dicamba diglycolamine salt
compound X/compound Y3/glyphosate monoethanolamine salt/dicamba diglycolamine salt
compound X/compound Y3/glyphosate potassium salt/dicamba BAPMA salt
compound X/compound Y3/glyphosate monoethanolamine salt/dicamba BAPMA salt
compound X/compound Y3/glyphosate potassium salt/dicamba TBA salt
compound X/compound Y3/glyphosate monoethanolamine salt/dicamba TBA salt
compound X/compound Y3/glyphosate potassium salt/dicamba TBP salt
compound X/compound Y3/glyphosate monoethanolamine salt/dicamba TBP salt
compound X/compound Y3/glyphosate potassium salt/flumioxazin
compound X/compound Y3/glyphosate potassium salt/flumioxazin/pyroxasulfone
compound X/compound Y3/glyphosate potassium salt/dicamba diglycolamine salt/flumioxazin
compound X/compound Y3/glyphosate monoethanolamine salt/dicamba diglycolamine salt/flumioxazin
compound X/compound Y3/glyphosate potassium salt/dicamba BAPMA salt/flumioxazin
compound X/compound Y3/glyphosate monoethanolamine salt/dicamba BAPMA salt/flumioxazin
compound X/compound Y3/glyphosate potassium salt/dicamba TBA salt/flumioxazin
compound X/compound Y3/glyphosate monoethanolamine salt/dicamba TBA salt/flumioxazin
compound X/compound Y3/glyphosate potassium salt/dicamba TBP salt/flumioxazin
compound X/compound Y3/glyphosate monoethanolamine salt/dicamba TBP salt/flumioxazin
compound X/compound Y3/glyphosate potassium salt/dicamba diglycolamine salt/flumioxazin/pyroxasulfone
compound X/compound Y3/glyphosate monoethanolamine salt/dicamba diglycolamine salt/flumioxazin/pyroxasulfone
compound X/compound Y3/glyphosate potassium salt/dicamba BAPMA salt/flumioxazin/pyroxasulfone
compound X/compound Y3/glyphosate monoethanolamine salt/dicamba BAPMA salt/flumioxazin/pyroxasulfone
compound X/compound Y3/glyphosate potassium salt/dicamba TBA salt/flumioxazin/pyroxasulfone
compound X/compound Y3/glyphosate monoethanolamine salt/dicamba TBA salt/flumioxazin/pyroxasulfone
compound X/compound Y3/glyphosate potassium salt/dicamba TBP salt/flumioxazin/pyroxasulfone
compound X/compound Y3/glyphosate monoethanolamine salt/dicamba TBP salt/flumioxazin/pyroxasulfone
compound X/compound Y3/glyphosate potassium salt/flumioxazin/chlorimuron-ethyl
compound X/compound Y3/glyphosate potassium salt/flumioxazin/chlorimuron-ethyl/thifensulfuron-methyl
compound X/compound Y3/glyphosate potassium salt/flumioxazin/cloransulam-methyl
compound X/compound Y3/glyphosate potassium salt/flumioxazin/metribuzin/chlorimuron-ethyl
compound X/compound Y3/glyphosate potassium salt/flumioxazin/metribuzin/imazethapyr-ammonium
compound X/compound Y3/glyphosate potassium salt/flumiclorac-pentyl
compound X/compound Y3/glyphosate potassium salt/clethodim
compound X/compound Y3/glyphosate potassium salt/lactofen
compound X/compound Y3/glyphosate potassium salt/Smetolachlor
compound X/compound Y3/glyphosate potassium salt/metribuzin
compound X/compound Y3/glyphosate potassium salt/flufenacet
compound X/compound Y3/glyphosate potassium salt/nicosulfuron
compound X/compound Y3/glyphosate potassium salt/rimsulfuron
compound X/compound Y3/glyphosate potassium salt/rimsulfuron
compound X/compound Y3/glyphosate potassium salt/acetochlor
compound X/compound Y3/glyphosate potassium salt/mesotrione
compound X/compound Y3/glyphosate potassium salt/isoxaflutole
compound X/compound Y3/glyphosate potassium salt/chlorimuron-ethyl
compound X/compound Y3/glyphosate potassium salt/thifensulfuron-methyl
compound X/compound Y3/glyphosate potassium salt/cloransulam-methyl
compound X/compound Y3/glyphosate potassium salt/imazethapyr-ammonium
compound X/compound Y4/glyphosate potassium salt
compound X/compound Y4/glyphosate guanidine salt
compound X/compound Y4/glyphosate dimethylamine salt
compound X/compound Y4/glyphosate monoethanolamine salt
compound X/compound Y4/glyphosate isopropylamine salt
compound X/compound Y4/glufosinate-ammonium
compound X/compound Y4/2,4-D choline salt
compound X/compound Y4/pyroxasulfone
compound X/compound Y4/dicamba diglycolamine salt
compound X/compound Y4/dicamba BAPMA salt
compound X/compound Y4/dicamba TBA salt
compound X/compound Y4/dicamba TBP salt
compound X/compound Y4/flumioxazin
compound X/compound Y4/flumioxazin/pyroxasulfone
compound X/compound Y4/flumioxazin/chlorimuron-ethyl
compound X/compound Y4/flumioxazin/chlorimuron-ethyl/thifensulfuron-methyl
compound X/compound Y4/flumioxazin/cloransulam-methyl
compound X/compound Y4/flumioxazin/metribuzin/chlorimuron-ethyl
compound X/compound Y4/flumioxazin/metribuzin/imazethapyr-ammonium
compound X/compound Y4/flumiclorac-pentyl
compound X/compound Y4/clethodim
compound X/compound Y4/lactofen
compound X/compound Y4/Smetolachlor
compound X/compound Y4/metribuzin
compound X/compound Y4/flufenacet
compound X/compound Y4/nicosulfuron
compound X/compound Y4/rimsulfuron
compound X/compound Y4/acetochlor
compound X/compound Y4/mesotrione
compound X/compound Y4/isoxaflutole
compound X/compound Y4/chlorimuron-ethyl
compound X/compound Y4/thifensulfuron-methyl
compound X/compound Y4/cloransulam-methyl
compound X/compound Y4/imazethapyr-ammonium
compound X/compound Y4/glyphosate potassium salt/2,4-D choline salt
compound X/compound Y4/glyphosate dimethylamine salt/2,4-D choline salt
compound X/compound Y4/glyphosate potassium salt/pyroxasulfone
compound X/compound Y4/glyphosate potassium salt/dicamba diglycolamine salt
compound X/compound Y4/glyphosate monoethanolamine salt/dicamba diglycolamine salt
compound X/compound Y4/glyphosate potassium salt/dicamba BAPMA salt
compound X/compound Y4/glyphosate monoethanolamine salt/dicamba BAPMA salt
compound X/compound Y4/glyphosate potassium salt/dicamba TBA salt
compound X/compound Y4/glyphosate monoethanolamine salt/dicamba TBA salt
compound X/compound Y4/glyphosate potassium salt/dicamba TBP salt
compound X/compound Y4/glyphosate monoethanolamine salt/dicamba TBP salt
compound X/compound Y4/glyphosate potassium salt/flumioxazin
compound X/compound Y4/glyphosate potassium salt/flumioxazin/pyroxasulfone
compound X/compound Y4/glyphosate potassium salt/dicamba diglycolamine salt/flumioxazin
compound X/compound Y4/glyphosate monoethanolamine salt/dicamba diglycolamine salt/flumioxazin
compound X/compound Y4/glyphosate potassium salt/dicamba BAPMA salt/flumioxazin
compound X/compound Y4/glyphosate monoethanolamine salt/dicamba BAPMA salt/flumioxazin
compound X/compound Y4/glyphosate potassium salt/dicamba TBA salt/flumioxazin
compound X/compound Y4/glyphosate monoethanolamine salt/dicamba TBA salt/flumioxazin
compound X/compound Y4/glyphosate potassium salt/dicamba TBP salt/flumioxazin
compound X/compound Y4/glyphosate monoethanolamine salt/dicamba TBP salt/flumioxazin
compound X/compound Y4/glyphosate potassium salt/dicamba diglycolamine salt/flumioxazin/pyroxasulfone
compound X/compound Y4/glyphosate monoethanolamine salt/dicamba diglycolamine salt/flumioxazin/pyroxasulfone
compound X/compound Y4/glyphosate potassium salt/dicamba BAPMA salt/flumioxazin/pyroxasulfone
compound X/compound Y4/glyphosate monoethanolamine salt/dicamba BAPMA salt/flumioxazin/pyroxasulfone
compound X/compound Y4/glyphosate potassium salt/dicamba TBA salt/flumioxazin/pyroxasulfone
compound X/compound Y4/glyphosate monoethanolamine salt/dicamba TBA salt/flumioxazin/pyroxasulfone
compound X/compound Y4/glyphosate potassium salt/dicamba TBP salt/flumioxazin/pyroxasulfone
compound X/compound Y4/glyphosate monoethanolamine salt/dicamba TBP salt/flumioxazin/pyroxasulfone
compound X/compound Y4/glyphosate potassium salt/flumioxazin/chlorimuron-ethyl
compound X/compound Y4/glyphosate potassium salt/flumioxazin/chlorimuron-ethyl/thifensulfuron-methyl
compound X/compound Y4/glyphosate potassium salt/flumioxazin/cloransulam-methyl
compound X/compound Y4/glyphosate potassium salt/flumioxazin/metribuzin/chlorimuron-ethyl
compound X/compound Y4/glyphosate potassium salt/flumioxazin/metribuzin/imazethapyr-ammonium
compound X/compound Y4/glyphosate potassium salt/flumiclorac-pentyl
compound X/compound Y4/glyphosate potassium salt/clethodim
compound X/compound Y4/glyphosate potassium salt/lactofen
compound X/compound Y4/glyphosate potassium salt/Smetolachlor
compound X/compound Y4/glyphosate potassium salt/metribuzin
compound X/compound Y4/glyphosate potassium salt/flufenacet
compound X/compound Y4/glyphosate potassium salt/nicosulfuron
compound X/compound Y4/glyphosate potassium salt/rimsulfuron
compound X/compound Y4/glyphosate potassium salt/rimsulfuron
compound X/compound Y4/glyphosate potassium salt/acetochlor
compound X/compound Y4/glyphosate potassium salt/mesotrione
compound X/compound Y4/glyphosate potassium salt/isoxaflutole
compound X/compound Y4/glyphosate potassium salt/chlorimuron-ethyl
compound X/compound Y4/glyphosate potassium salt/thifensulfuron-methyl
compound X/compound Y4/glyphosate potassium salt/cloransulam-methyl
compound X/compound Y4/glyphosate potassium salt/imazethapyr-ammonium

compound X/compound Y5/glyphosate potassium salt

compound X/compound Y5/glyphosate guanidine salt
compound X/compound Y5/glyphosate dimethylamine salt
compound X/compound Y5/glyphosate monoethanolamine salt
compound X/compound Y5/glyphosate isopropylamine salt
compound X/compound Y5/glufosinate-ammonium
compound X/compound Y5/2,4-D choline salt
compound X/compound Y5/pyroxasulfone
compound X/compound Y5/dicamba diglycolamine salt
compound X/compound Y5/dicamba BAPMA salt
compound X/compound Y5/dicamba TBA salt
compound X/compound Y5/dicamba TBP salt
compound X/compound Y5/flumioxazin
compound X/compound Y5/flumioxazin/pyroxasulfone
compound X/compound Y5/flumioxazin/chlorimuron-ethyl
compound X/compound Y5/flumioxazin/chlorimuron-ethyl/thifensulfuron-methyl
compound X/compound Y5/flumioxazin/cloransulam-methyl
compound X/compound Y5/flumioxazin/metribuzin/chlorimuron-ethyl
compound X/compound Y5/flumioxazin/metribuzin/imazethapyr-ammonium
compound X/compound Y5/flumiclorac-pentyl
compound X/compound Y5/clethodim
compound X/compound Y5/lactofen
compound X/compound Y5/Smetolachlor
compound X/compound Y5/metribuzin
compound X/compound Y5/flufenacet
compound X/compound Y5/nicosulfuron
compound X/compound Y5/rimsulfuron
compound X/compound Y5/acetochlor
compound X/compound Y5/mesotrione
compound X/compound Y5/isoxaflutole
compound X/compound Y5/chlorimuron-ethyl
compound X/compound Y5/thifensulfuron-methyl
compound X/compound Y5/cloransulam-methyl
compound X/compound Y5/imazethapyr-ammonium
compound X/compound Y5/glyphosate potassium salt/2,4-D choline salt
compound X/compound Y5/glyphosate dimethylamine salt/2,4-D choline salt
compound X/compound Y5/glyphosate potassium salt/pyroxasulfone
compound X/compound Y5/glyphosate potassium salt/dicamba diglycolamine salt
compound X/compound Y5/glyphosate monoethanolamine salt/dicamba diglycolamine salt
compound X/compound Y5/glyphosate potassium salt/dicamba BAPMA salt
compound X/compound Y5/glyphosate monoethanolamine salt/dicamba BAPMA salt
compound X/compound Y5/glyphosate potassium salt/dicamba TBA salt
compound X/compound Y5/glyphosate monoethanolamine salt/dicamba TBA salt
compound X/compound Y5/glyphosate potassium salt/dicamba TBP salt
compound X/compound Y5/glyphosate monoethanolamine salt/dicamba TBP salt
compound X/compound Y5/glyphosate potassium salt/flumioxazin
compound X/compound Y5/glyphosate potassium salt/flumioxazin/pyroxasulfone
compound X/compound Y5/glyphosate potassium salt/dicamba diglycolamine salt/flumioxazin
compound X/compound Y5/glyphosate monoethanolamine salt/dicamba diglycolamine salt/flumioxazin
compound X/compound Y5/glyphosate potassium salt/dicamba BAPMA salt/flumioxazin
compound X/compound Y5/glyphosate monoethanolamine salt/dicamba BAPMA salt/flumioxazin
compound X/compound Y5/glyphosate potassium salt/dicamba TBA salt/flumioxazin
compound X/compound Y5/glyphosate monoethanolamine salt/dicamba TBA salt/flumioxazin
compound X/compound Y5/glyphosate potassium salt/dicamba TBP salt/flumioxazin
compound X/compound Y5/glyphosate monoethanolamine salt/dicamba TBP salt/flumioxazin
compound X/compound Y5/glyphosate potassium salt/dicamba diglycolamine salt/flumioxazin/pyroxasulfone
compound X/compound Y5/glyphosate monoethanolamine salt/dicamba diglycolamine salt/flumioxazin/pyroxasulfone
compound X/compound Y5/glyphosate potassium salt/dicamba BAPMA salt/flumioxazin/pyroxasulfone
compound X/compound Y5/glyphosate monoethanolamine salt/dicamba BAPMA salt/flumioxazin/pyroxasulfone
compound X/compound Y5/glyphosate potassium salt/dicamba TBA salt/flumioxazin/pyroxasulfone
compound X/compound Y5/glyphosate monoethanolamine salt/dicamba TBA salt/flumioxazin/pyroxasulfone
compound X/compound Y5/glyphosate potassium salt/dicamba TBP salt/flumioxazin/pyroxasulfone
compound X/compound Y5/glyphosate monoethanolamine salt/dicamba TBP salt/flumioxazin/pyroxasulfone
compound X/compound Y5/glyphosate potassium salt/flumioxazin/chlorimuron-ethyl
compound X/compound Y5/glyphosate potassium salt/flumioxazin/chlorimuron-ethyl/thifensulfuron-methyl
compound X/compound Y5/glyphosate potassium salt/flumioxazin/cloransulam-methyl
compound X/compound Y5/glyphosate potassium salt/flumioxazin/metribuzin/chlorimuron-ethyl
compound X/compound Y5/glyphosate potassium salt/flumioxazin/metribuzin/imazethapyr-ammonium
compound X/compound Y5/glyphosate potassium salt/flumiclorac-pentyl
compound X/compound Y5/glyphosate potassium salt/clethodim
compound X/compound Y5/glyphosate potassium salt/lactofen
compound X/compound Y5/glyphosate potassium salt/Smetolachlor
compound X/compound Y5/glyphosate potassium salt/metribuzin
compound X/compound Y5/glyphosate potassium salt/flufenacet
compound X/compound Y5/glyphosate potassium salt/nicosulfuron
compound X/compound Y5/glyphosate potassium salt/rimsulfuron
compound X/compound Y5/glyphosate potassium salt/rimsulfuron
compound X/compound Y5/glyphosate potassium salt/acetochlor
compound X/compound Y5/glyphosate potassium salt/mesotrione
compound X/compound Y5/glyphosate potassium salt/isoxaflutole
compound X/compound Y5/glyphosate potassium salt/chlorimuron-ethyl
compound X/compound Y5/glyphosate potassium salt/thifensulfuron-methyl
compound X/compound Y5/glyphosate potassium salt/cloransulam-methyl
compound X/compound Y5/glyphosate potassium salt/imazethapyr-ammonium
compound X/compound Y6/glyphosate potassium salt
compound X/compound Y6/glyphosate guanidine salt
compound X/compound Y6/glyphosate dimethylamine salt
compound X/compound Y6/glyphosate monoethanolamine salt
compound X/compound Y6/glyphosate isopropylamine salt
compound X/compound Y6/glufosinate-ammonium
compound X/compound Y6/2,4-D choline salt
compound X/compound Y6/pyroxasulfone
compound X/compound Y6/dicamba diglycolamine salt
compound X/compound Y6/dicamba BAPMA salt
compound X/compound Y6/dicamba TBA salt
compound X/compound Y6/dicamba TBP salt
compound X/compound Y6/flumioxazin
compound X/compound Y6/flumioxazin/pyroxasulfone
compound X/compound Y6/flumioxazin/chlorimuron-ethyl
compound X/compound Y6/flumioxazin/chlorimuron-ethyl/thifensulfuron-methyl
compound X/compound Y6/flumioxazin/cloransulam-methyl
compound X/compound Y6/flumioxazin/metribuzin/chlorimuron-ethyl
compound X/compound Y6/flumioxazin/metribuzin/imazethapyr-ammonium
compound X/compound Y6/flumiclorac-pentyl
compound X/compound Y6/clethodim
compound X/compound Y6/lactofen
compound X/compound Y6/Smetolachlor
compound X/compound Y6/metribuzin
compound X/compound Y6/flufenacet
compound X/compound Y6/nicosulfuron
compound X/compound Y6/rimsulfuron
compound X/compound Y6/acetochlor
compound X/compound Y6/mesotrione
compound X/compound Y6/isoxaflutole
compound X/compound Y6/chlorimuron-ethyl
compound X/compound Y6/thifensulfuron-methyl
compound X/compound Y6/cloransulam-methyl
compound X/compound Y6/imazethapyr-ammonium
compound X/compound Y6/glyphosate potassium salt/2,4-D choline salt
compound X/compound Y6/glyphosate dimethylamine salt/2,4-D choline salt
compound X/compound Y6/glyphosate potassium salt/pyroxasulfone
compound X/compound Y6/glyphosate potassium salt/dicamba diglycolamine salt
compound X/compound Y6/glyphosate monoethanolamine salt/dicamba diglycolamine salt
compound X/compound Y6/glyphosate potassium salt/dicamba BAPMA salt
compound X/compound Y6/glyphosate monoethanolamine salt/dicamba BAPMA salt
compound X/compound Y6/glyphosate potassium salt/dicamba TBA salt
compound X/compound Y6/glyphosate monoethanolamine salt/dicamba TBA salt
compound X/compound Y6/glyphosate potassium salt/dicamba TBP salt
compound X/compound Y6/glyphosate monoethanolamine salt/dicamba TBP salt
compound X/compound Y6/glyphosate potassium salt/flumioxazin
compound X/compound Y6/glyphosate potassium salt/flumioxazin/pyroxasulfone
compound X/compound Y6/glyphosate potassium salt/dicamba diglycolamine salt/flumioxazin
compound X/compound Y6/glyphosate monoethanolamine salt/dicamba diglycolamine salt/flumioxazin
compound X/compound Y6/glyphosate potassium salt/dicamba BAPMA salt/flumioxazin
compound X/compound Y6/glyphosate monoethanolamine salt/dicamba BAPMA salt/flumioxazin
compound X/compound Y6/glyphosate potassium salt/dicamba TBA salt/flumioxazin
compound X/compound Y6/glyphosate monoethanolamine salt/dicamba TBA salt/flumioxazin
compound X/compound Y6/glyphosate potassium salt/dicamba TBP salt/flumioxazin
compound X/compound Y6/glyphosate monoethanolamine salt/dicamba TBP salt/flumioxazin
compound X/compound Y6/glyphosate potassium salt/dicamba diglycolamine salt/flumioxazin/pyroxasulfone
compound X/compound Y6/glyphosate monoethanolamine salt/dicamba diglycolamine salt/flumioxazin/pyroxasulfone
compound X/compound Y6/glyphosate potassium salt/dicamba BAPMA salt/flumioxazin/pyroxasulfone
compound X/compound Y6/glyphosate monoethanolamine salt/dicamba BAPMA salt/flumioxazin/pyroxasulfone
compound X/compound Y6/glyphosate potassium salt/dicamba TBA salt/flumioxazin/pyroxasulfone
compound X/compound Y6/glyphosate monoethanolamine salt/dicamba TBA salt/flumioxazin/pyroxasulfone
compound X/compound Y6/glyphosate potassium salt/dicamba TBP salt/flumioxazin/pyroxasulfone
compound X/compound Y6/glyphosate monoethanolamine salt/dicamba TBP salt/flumioxazin/pyroxasulfone
compound X/compound Y6/glyphosate potassium salt/flumioxazin/chlorimuron-ethyl
compound X/compound Y6/glyphosate potassium salt/flumioxazin/chlorimuron-ethyl/thifensulfuron-methyl
compound X/compound Y6/glyphosate potassium salt/flumioxazin/cloransulam-methyl
compound X/compound Y6/glyphosate potassium salt/flumioxazin/metribuzin/chlorimuron-ethyl
compound X/compound Y6/glyphosate potassium salt/flumioxazin/metribuzin/imazethapyr-ammonium
compound X/compound Y6/glyphosate potassium salt/flumiclorac-pentyl
compound X/compound Y6/glyphosate potassium salt/clethodim
compound X/compound Y6/glyphosate potassium salt/lactofen
compound X/compound Y6/glyphosate potassium salt/Smetolachlor
compound X/compound Y6/glyphosate potassium salt/metribuzin
compound X/compound Y6/glyphosate potassium salt/flufenacet
compound X/compound Y6/glyphosate potassium salt/nicosulfuron
compound X/compound Y6/glyphosate potassium salt/rimsulfuron
compound X/compound Y6/glyphosate potassium salt/rimsulfuron
compound X/compound Y6/glyphosate potassium salt/acetochlor
compound X/compound Y6/glyphosate potassium salt/mesotrione
compound X/compound Y6/glyphosate potassium salt/isoxaflutole
compound X/compound Y6/glyphosate potassium salt/chlorimuron-ethyl
compound X/compound Y6/glyphosate potassium salt/thifensulfuron-methyl
compound X/compound Y6/glyphosate potassium salt/cloransulam-methyl
compound X/compound Y6/glyphosate potassium salt/imazethapyr-ammonium

Examples of more preferable specific combination when using the present composition in combination with one or more herbicides include the present composition+glyphosate potassium salt, and the present composition+glyphosate monoethanolamine salt.

Examples of more preferable specific combination when using the present composition in combination with one or more herbicides include the present composition+dicamba diglycolamine salt, the present composition+dicamba BAPMA salt, the present composition+dicamba TBA salt, and the present composition+dicamba TBP salt.

Examples of more preferable specific combination when using the present composition in combination with one or more herbicides include the present composition+glyphosate potassium salt+dicamba diglycolamine salt, the present composition+glyphosate potassium salt+dicamba BAPMA salt, the present composition+glyphosate potassium salt+dicamba TBA salt, and the present composition+glyphosate potassium salt+dicamba TBP salt.

Examples of more preferable specific combination when using the present composition in combination with one or more herbicides include the present composition+glyphosate monoethanolamine salt+dicamba diglycolamine salt, the present composition+glyphosate monoethanolamine salt+dicamba BAPMA salt, the present composition+glyphosate monoethanolamine salt+dicamba TBA salt, and the present composition+glyphosate monoethanolamine salt+dicamba TBP salt.

In the cultivation of a crop in the present invention, a plant-nutritional management in a common crop cultivation can be made. A fertilization system may be one based on Precision Agriculture, or may be a conventional homogeneous one. Alternatively, a nitrogen-fixing bacterium or a mycorrhizal fungus may be inoculated together with a seed treatment.

### EXAMPLES

Hereinbelow, the present invention will be described in more detail by way of examples. However, the present invention is not limited by these examples.

At first, criteria for the evaluation of the herbicidal effect and the harmful effect on crops shown in the below-mentioned examples will be described.

### [Herbicidal Effect and Harmful Effect on Crops]

The herbicidal effect was rated within a range of 0 to 100, wherein “0” was a rating where the state of emergence or growth of a sample weed during a test had no difference or little difference compared with the state of the test weed that did not subjected to the treatment, and “100” was a rating where the test plant was completely killed or the emergence or growth of the test weed was completely suppressed.

The harmful effect on crops was rated as “harmless” when little harmful effect was observed, “low” when a moderate level of harmful effect was observed, “medium” when a medium level of harmful effect was observed, and “high” when a high level of harmful effect was observed.

### Example 1

The weeds (palmer amaranth (Amaranthus palmeri), common waterhemp (Amaranthus rudis), common ragweed (Ambrosia artemisiaefolia), giant ragweed (Ambrosia trifida), Canadian horseweed (Conyza canadensis), common lambsquarters (Chenopodium album), summer cypress (Bassia scoparia), common barnyardgrass (Echinochloa crus-galli) and giant foxtail (Setaria faberi)) are seeded in a plastic pot filled with soil. On the same day, 20 g/ha of the compound X and 25, 50, 100 or 200 g/ha of the compound Y1 are applied to the surface of soil at the sprayed water amount of 200 L/ha. The plants are then cultivated in a greenhouse, and at 7 days after the application, soybeans are seeded. Fourteen days after seeding the soybeans, the herbicidal effect on the weeds and crop injuries on the soybeans are investigated. The synergistic weed control effect due to using the compound X and the compound Y1 in combination is confirmed.

### Example 2

The weeds (palmer amaranth (Amaranthus palmeri), common waterhemp (Amaranthus rudis), common ragweed (Ambrosia artemisiaefolia), common barnyardgrass (Echinochloa crus-galli), giant foxtail (Setaria faberi)) and soybeans are seeded in a plastic pot filled with soil. On the same day, 80 g/ha of the compound X and 25, 50, 100 or 200 g/ha of the compound Y1 are applied to the surface of soil at the sprayed water amount of 200 L/ha. The plants are then cultivated in a greenhouse, and 21 days after the application, the effect on the weeds and crop injuries on soybeans are investigated. The synergistic weed control effect due to using the compound X and the compound Y1 in combination is confirmed.

### Example 3

The weeds (palmer amaranth (Amaranthus palmeri), common waterhemp (Amaranthus rudis), common ragweed (Ambrosia artemisiaefolia), giant ragweed (Ambrosia trifida), Canadian horseweed (Conyza canadensis), common lambsquarters (Chenopodium album), summer cypress (Bassia scoparia), common barnyardgrass (Echinochloa crus-galli) and giant foxtail (Setaria faberi)) and soybeans are seeded in a plastic pot filled with soil. The plants are then cultivated in a greenhouse, and 21 days after seeding, 20 g/ha of the compound X and 25, 50, 100 or 200 g/ha of the compound Y1 are applied to the foliage at the sprayed water amount of 200 L/ha. The plants are then cultivated in a greenhouse, and 14 days after the application, the effect on the weeds and crop injuries on soybeans are investigated. A synergistic weed control effect due to using the compound X and the compound Y1 in combination is confirmed.

### Examples 4 to 6

In the applications of Examples 1 to 3, Roundup WeatherMAX (660 g/L of glyphosate potassium salt, manufactured by Monsanto Company) is added to the spray liquid containing the compound X and the compound Y1 so that the application rate may be 2.338 L/ha (32 fluid ounce/acre), followed by application in the same manner.

### Examples 7 to 9

In the applications of Examples 4 to 6, XtendiMax (350 g/L of dicamba diglycolamine salt in terms of dicamba acid, manufactured by Monsanto Company) is added to the spray liquid containing the compound X and the compound Y1 so that the application rate may be 1,607 ml/ha (22 fluid ounce/acre), followed by application in the same manner.

### Examples 10 to 12

In the applications of Examples 1 to 3, RoundupExtend (240 g/L of glyphosate monoethanolamine+120 g/L of dicamba diglycolamine, manufactured by Monsanto Company) is added to the spray liquid containing the compound X and the compound Y1 so that the application rate may be 4.677 L/ha (64 fluid ounce/acre), followed by application in the same manner.

### Examples 13 to 24

The application is performed in the same manner, except that soybean of Examples 1 to 12 is replaced by corn or cotton.

### Example 25

NipsIt (600 g/L of clothianidin, manufactured by Valent U.S.A. LLC) is applied to seeds of soybeans (variety: Genuity Roundup Ready2Yield soybean) so that the application rate of NipsIt may be 206 mL/kg seeds (1.28 fluid ounce/100 pond seeds). The formulation containing the compound X (the emulsifiable concentrate prepared by well-mixing 5 parts by weight of the compound X, 2 parts by weight of Geronol FF/4-E (manufactured by Rhodia), 8 parts by weight of Geronol FF/6-E (manufactured by Rhodia) and 85 parts by weight of Solvesso 200 (manufactured by Exxon Mobile Corporation) (hereinafter referred to as formulation X) and the formulation containing the compound Y1 (hereinafter referred to as formulation Y1) are mixed with water, followed by application to the agricultural field before seeding the soybeans so that the application rate of the compound X may be 5, 20 or 80 g/ha and the application rate of the compound Y1 may be 25, 50, 100 or 200 g/ha. Seven days after the application, the soybeans are seeded at the agricultural field. At three true leaf stage of the soybeans, Roundup WeatherMAX (660 g/L of glyphosate potassium salt, manufactured by Monsanto Company) is applied to the agricultural field so that the application rate may be 2.338 L/ha (32 fluid ounce/acre).

### Example 26

NipsIt is applied to the seeds of soybean in the same manner as in Example 25. The formulation X, the formulation Y1 and Roundup WeatherMAX are applied to the agricultural field before seeding the soybeans so that the application rate of the compound X may be 5, 20 or 80 g/ha, the application rate of the compound Y1 may be 25, 50, 100 or 200 g/ha, and the application rate of Roundup WeatherMAX (660 g/L of glyphosate potassium salt, manufactured by Monsanto Company) may be 2.338 L/ha (32 fluid ounce/acre). Seven days after the application, the soybeans are seeded to the agricultural field. At three true leaf stage of the soybeans, Roundup WeatherMAX (660 g/L of glyphosate potassium salt, manufactured by Monsanto Company) is applied to the agricultural field so that the application rate may be 2.338 L/ha (32 fluid ounce/acre).

### Example 27

NipsIt is applied to the seeds of soybean in the same manner as in Example 25, followed by seeding to the agricultural field. On the next day of the seeding, the formulation X and the formulation Y1 are applied to the agricultural field so that the application rate of the compound X may be 5, 20 or 80 g/ha and the application rate of the compound Y1 may be 25, 50, 100 or 200 g/ha. At three true leaf stage of the soybeans, Roundup WeatherMAX (660 g/L of glyphosate potassium salt, manufactured by Monsanto Company) is applied to the agricultural field so that the application rate may be 2.338 L/ha (32 fluid ounce/acre).

### Example 28

NipsIt is applied to the seeds of soybean in the same manner as in Example 25, followed by seeding to the agricultural field. On the next day of the seeding, the formulation X, the formulation Y1 and Roundup WeatherMAX are applied to the agricultural field so that the application rate of the compound X may be 5, 20 or 80 g/ha, the application rate of the compound Y may be 25, 50, 100 or 200 g/ha, and the application rate of Roundup WeatherMAX (glyphosate potassium salt 660 g/L, manufactured by Monsanto Company) may be 2.338 L/ha (32 fluid ounce/acre). At three true leaf stage of the soybeans, Roundup WeatherMAX (660 g/L of glyphosate potassium salt, manufactured by Monsanto Company) is applied to the agricultural field so that the application rate may be 2.338 L/ha (32 fluid ounce/acre).

### Examples 29 to 32

In each of Examples 25 to 28, when applying Roundup WeatherMAX on the next day of the seeding or at three true leaf stage of the soybeans, XtendiMax is added to Roundup WeatherMAX so that the application rate of XtendiMax (350 g/L of dicamba diglycolamine salt in terms of dicamba acid, manufactured by Monsanto Company) may be 1,607 ml/ha (22 fluid ounce/acre), followed by application.

### Examples 33 to 36

In each of Examples 25 to 28, in place of applying on the next day of the seeding or at three true leaf stage of the soybeans Roundup WeatherMAX, RoundupExtend (240 g/L of glyphosate monoethanolamine+120 g/L of dicamba diglycolamine, manufactured by Monsanto Company) is used in place of Roundup WeatherMAX and is applied so that the application rate of RoundupExtend may be 4.677 L/ha (64 fluid ounce/acre).

### Examples 37 to 48

In each of Examples 25 to 36, INOVATE (160 g/L of clothianidin+13 g/L of metalaxyl+8 g/L of ipconazole, manufactured by Valent U.S.A.) is used in place of NipsIt, and is applied so that the application rate of INOVATE may be 309 mL/100 kg seeds (4.74 fluid ounce/100 pond seeds).

### Examples 49 to 60

In each of Examples 25 to 36, CruiserMAXX Vibrance (240 g/L of thiamethoxam+36 g/L of metalaxyl M+12 g/L of fludioxonil+12 g/L of sedaxane, manufactured by Syngenta Ltd.) is used in place of NipsIt and is applied so that the application rate of CruiserMAXX Vibrance may be 235 mL/100 kg seeds (3.22 fluid ounce/100 pond seeds).

### Examples 61 to 72

In each of Examples 25 to 36, Acceleron system (DX-612 (326 g/L of fluxapyroxad, manufactured by Monsanto Company) 31 ml/100 kg seeds+DX-309 (313 g/L of metalaxyl, manufactured by Monsanto Company) 242 ml/100 kg seeds (1.5 fluid ounce/100 pond seeds)+DX-109 (200 g/L of pyraclostrobin, manufactured by Monsanto Company) 242 ml/100 kg seeds (1.5 fluid ounce/100 pond seeds)+IX-104 (600 g/L of imidacloprid, manufactured by Monsanto Company) 515 ml/100 kg seeds (3.2 fluid ounce/100 pond seeds)) is applied in place of applying NipsIt to the seeds of soybean.

### Examples 73 to 120

In each of Examples 25 to 72, seeds of corn or cotton are used in place of seeds of soybean.

### Examples 121 to 216

In Examples 25 to 120, the application is performed in the same manner, except that this crop is replaced by crops with Roundup Ready 2 Xtend trait.

### Examples 217 to 312

In Examples 25 to 120, the application is performed in the same manner, except that this crop is replaced by crops with Roundup Ready 2 Xtend trait and trait having tolerance to a PPO inhibitor.

### Examples 313 to 408

In Examples 25 to 120, the application is performed in the same manner, except that this crop is replaced by crops with Roundup Ready 2 Xtend trait, trait having tolerance to a PPO inhibitor and trait having tolerance to an HPPD inhibitor.

### Examples 409 to 816

In Examples 1 to 408, the application is performed by replacing the compound Y1 by a compound Y2.

### Examples 817 to 1224

In Examples 1 to 408, the application is performed by replacing the compound Y1 by the compound Y3.

### Examples 1225 to 1632

In Examples 1 to 408, the application is performed by replacing the compound Y1 by the compound Y4.

### Examples 1633 to 2040

In Examples 1 to 408, the application is performed by replacing the compound Y1 by the compound Y5.

### Examples 2041 to 2448

In Examples 1 to 408, the application is performed by replacing the compound Y1 by the compound Y6.

In above Examples 1 to 2448, excellent herbicidal effect is confirmed by the effects of using the compound X and the compound Y1, the compound Y2, the compound Y3, the compound Y4, the compound Y5 or the compound Y6 in combination, and crop injuries are confirmed to pose little problem.

### INDUSTRIAL APPLICABILITY

The present invention can effectively control weeds.

1. A herbicidal composition comprising epyrifenacil and one or more compounds selected from the following compound group Y:
Compound group Y: group consisting of 4-amino-3-chloro-5-fluoro-6-(7-fluoro-1H-indol-6-yl)pyridine-2-carboxylic acid cyanomethyl ester, phenylisoxazoline compound represented by the following formula (1): 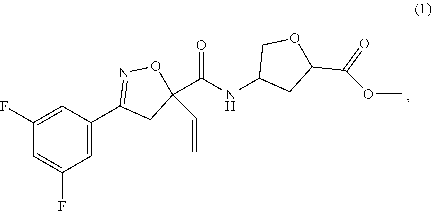 [SMILES: C=CC1(C(=O)NC2COC(C(=O)OC)C2)CC(c2cc(F)cc(F)c2)=NO1]
(1 S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester, rimisoxafen and 2,4-D DMAPA salt.

2. The herbicidal composition according to claim 1, wherein one or more compounds selected from the compound group Y are 4-amino-3-chloro-5-fluoro-6-(7-fluoro-1H-indol-6-yl)pyridine-2-carboxylic acid cyanomethyl ester.

3. The herbicidal composition according to claim 1, wherein one or more compounds selected from the compound group Y are (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester.

4. The herbicidal composition according to claim 1, wherein one or more compounds selected from the compound group Y are (2S,4S)-4-({[(5R)-3-(3,5-difluorophenyl)-5-vinyl-4,5-dihydroisoxazol-5-yl]carbonyl}amino)tetrahydrofuran-2-carboxylic acid methyl ester.

5. The herbicidal composition according to claim 1, wherein one or more compounds selected from the compound group Y are (1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester.

6. The herbicidal composition according to claim 1, wherein one or more compounds selected from the compound group Y are rimisoxafen.

7. The herbicidal composition according to claim 1, wherein one or more compounds selected from the compound group Y are 2,4-D DMAPA salt.

8. The herbicidal composition according to claim 1, wherein a weight ratio of epyrifenacil to one or more compounds selected from the compound group Y is 1:0.5 to 1:20.

9. The herbicidal composition according to claim 1, comprising a glyphosate salt.

10. The herbicidal composition according to claim 1, comprising a dicamba salt.

11. A method for controlling weeds, comprising a step of simultaneously or sequentially applying epyrifenacil and one or more compounds selected from the following compound group Y to the place where weeds are growing or will grow:
Compound group Y: group consisting of 4-amino-3-chloro-5-fluoro-6-(7-fluoro-1H-indol-6-yl)pyridine-2-carboxylic acid cyanomethyl ester, phenylisoxazoline compound represented by the following formula (1): 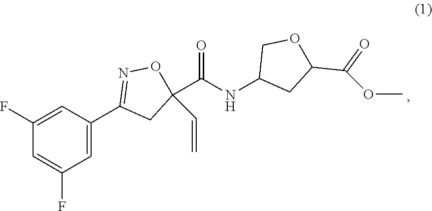 [SMILES: C=CC1(C(=O)NC2COC(C(=O)OC)C2)CC(c2cc(F)cc(F)c2)=NO1]
(1 S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester, rimisoxafen and 2,4-D DMAPA salt.

12. The method according to claim 11, wherein one or more compounds selected from the compound group Y are 4-amino-3-chloro-5-fluoro-6-(7-fluoro-1H-indol-6-yl)pyridine-2-carboxylic acid cyanomethyl ester.

13. The method according to claim 11, wherein one or more compounds selected from the compound group Y are (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester.

14. The method according to claim 11, wherein one or more compounds selected from the compound group Y are (2S,4S)-4-({[(5R)-3-(3,5-difluorophenyl)-5-vinyl-4,5-dihydroisoxazol-5-yl]carbonyl}amino)tetrahydrofuran-2-carboxylic acid methyl ester.

15. The method according to claim 11, wherein one or more compounds selected from the compound group Y are (1S,4R)-4-[[[(5S)-3-(3,5-difluorophenyl)-5-vinyl-4H-1,2-oxazol-5-yl]carbonyl]amino]-cyclopent-2-ene-1-carboxylic acid methyl ester.

16. The method according to claim 11, wherein one or more compounds selected from the compound group Y are rimisoxafen.

17. The method according to claim 11, wherein one or more compounds selected from the compound group Y are 2,4-D DMAPA salt.

18. The method according to claim 11, wherein a weight ratio of epyrifenacil to one or more compounds selected from the compound group Y is 1:0.5 to 1:20.

19. The method according to claim 11, wherein the place where weeds are growing or will grow is a crop field.

20. The method according to claim 19, wherein the crop field is a field of soybeans, corn or cotton.

21. The herbicidal composition according to claim 1, wherein one or more compounds selected from the compound group Y are a mixture of equal parts of the compounds (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester and (2S,4S)-4-({[(5S)-3-(3,5-difluorophenyl)-5-vinyl-4,5-dihydroisoxazol-5-yl]carbonyl}amino)tetrahydrofuran-2-carboxylic acid methyl ester.

22. The method according to claim 11, wherein one or more compounds selected from the compound group Y are a mixture of equal parts of the compounds (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester and (2S,4S)-4-({[(5S)-3-(3,5-difluorophenyl)-5-vinyl-4,5-dihydroisoxazol-5-yl]carbonyl}amino)tetrahydrofuran-2-carboxylic acid methyl ester.
